(19) United States
(12) Patent Application Publication
(10) Pub. No.: US 2015/0062712 A1
(43) Pub. Date: Mar. 5, 2015

(54) OPTICAL ELEMENT AND MANUFACTURING METHOD THEREFOR, OPTICAL SYSTEM, IMAGING APPARATUS, OPTICAL INSTRUMENT, AND MASTER

(71) Applicant: Sony Corporation, Tokyo (JP)

(72) Inventors: Hiroshi Tazawa, Kanagawa (JP); Kazuya Hayashibe, Kanagawa (JP)

(73) Assignee: Sony Corporation, Tokyo (JP)

(21) Appl. No.: 14/387,004

(22) PCT Filed: Mar. 8, 2013
(86) PCT No.: PCT/JP2013/057321

§ 371 Date: Sep. 22, 2014

(30) Foreign Application Priority Data
Mar. 28, 2012 (JP) 2012-075246

(51) Int. Cl. G02B 5/02; G02B 1/12; G02B 1/11

(52) U.S. Cl. CPC G02B 5/0257; G02B 5/0268; G02B 1/118; G02B 1/12
USPC 359/599; 427/510; 118/620

(57) ABSTRACT

An optical element includes an element main body and a plurality of sub-wavelength structures that is provided on a surface of the element main body. The sub-wavelength structures include an energy-ray-curable resin composition, and the element main body is opaque to energy rays for curing the energy-ray-curable resin composition. The surface, on which the plurality of sub-wavelength structures is provided, has a section in which scattered light is generated by scattering incident light, and intensity distribution of the scattered light is anisotropic.

### TECHNICAL FIELD

The present technology relates to an optical element and a manufacturing method therefor, an optical system, an imaging apparatus, an optical instrument, and a master. Specifically, the present technology relates to an optical element having a surface on which sub-wavelength structures are provided.

### BACKGROUND ART

In the past, in the technical field of the optical elements, various techniques for suppressing surface reflection of light have been used. As one of the techniques, there is a technique in which sub-wavelength structures are formed on an optical element surface (for example, refer to NPL 1).

Generally, the optical element surface may have a periodic concave-convex shape. In this case, when light is transmitted therethrough, diffraction occurs, and a rectilinear component of the transmitted light is significantly reduced. However, when the pitch of the concave-convex shape is shorter than the wavelength of the transmitted light, no diffraction occurs, and it is possible to obtain an effective anti-reflection effect.

It has been proposed that the above-mentioned anti-reflection technique is applied to various optical element surfaces in order to obtain an excellent anti-reflection property. For example, a technique in which the sub-wavelength structures are formed on a lens surface has been proposed (for example, refer to PTL 1).

### CITATION LIST

### Patent Literature

PTL 1: Japanese Unexamined Patent Application Publication No. 2011-002853

### DISCLOSURE OF INVENTION

### Technical Problem

In recent years, digital cameras (digital still cameras), digital video cameras, and the like have come into widespread use. Thus, a technique capable of providing an excellent optical adjustment function on the optical element surface is preferable.

Further, optical elements, such as a lens, a mirror, and a filter having a surface on which the sub-wavelength structures are formed, may be used in an optical system of an imaging apparatus. In this case, when a bright spot or the like is photographed using the imaging apparatus, striped bright line noise or scattering noise may occur in a photographed image.

Consequently, a first object of the present technology is to provide an optical element having an excellent optical adjustment function, a manufacturing method therefor, an optical system, an imaging apparatus, an optical instrument, and a master.

Further, a second object of the present technology is to provide an optical element capable of suppressing occurrence of striped bright line noise or scattering noise even when a bright spot is photographed, a manufacturing method therefor, an optical system, an imaging apparatus, an optical instrument, and a master.

### Solution to Problem

In order to solve the above-mentioned problem, according to a first technique, there is provided an optical element including:

an element main body; and

a plurality of sub-wavelength structures that is provided on a surface of the element main body,

in which the sub-wavelength structures include an energy-ray-curable resin composition,

in which the element main body is opaque to energy rays for curing the energy-ray-curable resin composition,

in which the surface, on which the plurality of sub-wavelength structures is provided, has a section in which scattered light is generated by scattering incident light, and

in which intensity distribution of the scattered light is anisotropic.

According to a second technique, there is provided a manufacturing method of an optical element including:

coating a surface of an element main body with an energy-ray-curable resin composition; and

forming a plurality of sub-wavelength structures on the surface of the element main body by irradiating the energy-ray-curable resin composition, which is coated on the surface of the element main body, with energy rays radiated from an energy ray source, which is provided in a rotational master, through a rotation surface of the rotational master while rotating the rotation surface of the rotational master in tight contact therewith, so as to cure the energy-ray-curable resin composition,

in which the surface, on which the plurality of sub-wavelength structures is provided, has a section in which scattered light is generated by scattering incident light, and

in which intensity distribution of the scattered light is anisotropic.

According to a third technique, there is provided an optical system including:

an optical element; and

an imaging device that has an imaging region which receives light through the optical element,

in which the optical element includes
an element main body, and
a plurality of sub-wavelength structures that is provided on a surface of the element main body,

in which the sub-wavelength structures include an energy-ray-curable resin composition,

in which the element main body is opaque to energy rays for curing the energy-ray-curable resin composition,

in which the surface, on which the plurality of sub-wavelength structures is provided, has a section in which scattered light is generated by scattering incident light, and

in which intensity distribution of the scattered light is anisotropic.

According to a fourth technique, there is provided an imaging apparatus including an optical system that includes an optical element and an imaging device having an imaging region which receives light through the optical element,

in which the optical element includes
an element main body, and
a plurality of sub-wavelength structures that is provided on a surface of the element main body,

in which the sub-wavelength structures include an energy-ray-curable resin composition,

in which the element main body is opaque to energy rays for curing the energy-ray-curable resin composition,

in which the surface, on which the plurality of sub-wavelength structures is provided, has a section in which scattered light is generated by scattering incident light, and

in which intensity distribution of the scattered light is anisotropic.

According to a fifth technique, there is provided an optical apparatus including an optical system that includes an optical element and an imaging device having an imaging region which receives light through the optical element,

in which the optical element includes
an element main body, and
a plurality of sub-wavelength structures that is provided on a surface of the element main body,

in which the sub-wavelength structures include an energy-ray-curable resin composition,

in which the element main body is opaque to energy rays for curing the energy-ray-curable resin composition,

in which the surface, on which the plurality of sub-wavelength structures is provided, has a section in which scattered light is generated by scattering incident light, and

in which intensity distribution of the scattered light is anisotropic.

According to a sixth technique, there is provided a master having a rotation surface on which a plurality of sub-wavelength structures are provided,

in which the rotation surface is configured to be capable of transmitting energy rays,

in which the rotation surface, on which the plurality of sub-wavelength structures is provided, has a section in which scattered light is generated by scattering incident light, and

in which intensity distribution of the scattered light is anisotropic.

In the present technology, the energy-ray-curable resin composition means a composition including an energy-ray-curable resin composition as a main component. As compounded components other than the energy-ray-curable resin composition, it is possible to use various materials such as a thermoset resin, a silicone resin, organic microparticles, inorganic microparticles, a conductive polymer, a metallic powder, and a pigment. However, the components are not limited thereto, and it is possible to use various materials according to characteristics of a desired laminate.

Further, the opacity to the energy rays means opacity to the extent that it is difficult to cure the energy-ray-curable resin composition.

It is preferable that the unit regions be a transferred region which is formed by one rotation of the rotation surface of the rotational master. As the rotational master, it is preferable to use a roll master or a belt master, but anything may be used as long as it has a rotation surface having a concave-convex shape, and the rotational master is not limited thereto.

It is preferable that an array of the structures be regular array, irregular array, and combinations of these. It is preferable that the array of the structures be one-dimensional array or two-dimensional array. As the shape of the element main body, it is preferable to use a film or plate shape having two principal surfaces, a polyhedral shape having three or more principal surfaces, a curved surface shape having curved surfaces such as a spherical surface and a free-form curved surface, and a polyhedral shape having planar and spherical surfaces. It is preferable that a shaped layer be formed on at least one surface of the plurality of principal surfaces of the element main body. It is preferable that the element main body have at least one planar or curved surface and the shaped layer be formed on the planar or curved surface.

In the present technology, the concave-convex shapes of the shaped layer are connected without causing inconsistency between the unit regions. Therefore, there is no deterioration in characteristics of the laminate, disarray in shape, and the like caused by the inconsistency between the unit regions. Consequently, it is possible to obtain a laminate having excellent characteristics and an excellent appearance. When the concave-convex shape corresponds to lenses, patterns of the sub-wavelength structures, or the like, it is possible to obtain excellent optical characteristics even between the unit regions. When the concave-convex shape is designed by repetition of a predetermined shape, it is possible to design a shape without an inconsistent part or the like. Further, in the element main body, a material opaque to the energy rays can be used, and various materials may be used in the element main body.

In the present technology, the optical element has an incident surface, onto which light from a subject is incident, and an emission surface from which the light incident from the incident surface is emitted. It is preferable that the sub-wavelength structures be formed on at least one of the incident surface and the emission surface.

The present technology is quite appropriate for application to the optical apparatus. More specifically, the present technology is quite appropriate for application to an optical element having a surface on which the sub-wavelength structures are formed, an optical system having the optical element, an imaging apparatus and an optical instrument having the optical element or the optical system, and the like. Examples of the optical element include a lens, a filter (for example, an ND filter, or the like), a semitransparent mirror, a light modulation element, a prism, a polarization element, and the like, but are not limited thereto. Examples of the imaging apparatus include a digital camera, a digital video camera, and the like, but are not limited thereto. Examples of the optical instrument include a telescope, a microscope, an exposure device, a measurement apparatus, an inspection apparatus, an analytical instrument, and the like, but are not limited thereto.

In the present technology, the plurality of sub-wavelength structures is provided on the surface of the element main body. Therefore, it is possible to provide an excellent optical adjustment function with low wavelength dependence on the surface of the optical element which is opaque.

In the present technology, the intensity distribution of the scattered light is anisotropic. Therefore, by selecting a direction for use of an optical element, it is possible to suppress occurrence of the scattered light.

### Advantageous Effects of Invention

As described above, according to the present technology, it is possible to implement an optical element which has an excellent optical adjustment function and in which scattering is less likely to occur.

### BRIEF DESCRIPTION OF DRAWINGS

FIG. 1A is a top plan view illustrating an example of a configuration of a laminate according to a first embodiment of the present technology. FIG. 1B is a perspective view illustrating a part of the laminate shown in FIG. 1A in an enlarged manner. FIG. 1C is a top plan view illustrating a part of the laminate shown in FIG. 1A in an enlarged manner. FIG. 1D is a cross-sectional view of the laminate shown in FIG. 1C in a direction in which tracks extend.

FIGS. 2A to 2E are cross-sectional views respectively illustrating first to fifth examples of a substrate provided with the laminate according to the first embodiment of the present technology.

FIG. 3 is a schematic view illustrating an example of a configuration of a transfer device according to the first embodiment of the present technology.

FIG. 4 is a perspective view illustrating an example of a configuration of a roll master. FIG. 4B is a top plan view illustrating a part of the roll master shown in FIG. 4A in an enlarged manner.

FIG. 5 is a schematic view illustrating an example of a configuration of a roll master exposure device.

FIGS. 6A to 6D are process diagrams illustrating an example of a method of manufacturing the laminate according to the first embodiment of the present technology.

FIGS. 7A to 7E are process diagrams illustrating an example of a method of manufacturing the laminate according to the first embodiment of the present technology.

FIG. 8 is a schematic view illustrating an example of a configuration of a transfer device according to a second embodiment of the present technology.

FIG. 9 is a schematic view illustrating an example of a configuration of a transfer device according to a third embodiment of the present technology.

FIG. 10A is a top plan view illustrating an example of a configuration of a laminate according to a fourth embodiment of the present technology. FIG. 10B is a top plan view illustrating a part of the laminate shown in FIG. 10A in an enlarged manner.

FIG. 11A is a cross-sectional view illustrating an example of a configuration of a laminate according to a fifth embodiment of the present technology. FIG. 11B is a top plan view illustrating a part of the laminate shown in FIG. 11A in an enlarged manner. FIG. 11C is a cross-sectional view of the laminate shown in FIG. 11B.

FIG. 12 is a perspective view illustrating an example of a configuration of a laminate according to a sixth embodiment of the present technology.

FIGS. 13A to 13E are cross-sectional views respectively illustrating first to fifth examples of a substrate provided with a laminate according to a seventh embodiment of the present technology.

FIGS. 14A and 14B are cross-sectional views respectively illustrating first and second examples of a substrate provided with a laminate according to an eighth embodiment of the present technology.

FIGS. 15A and 15B are schematic views illustrating the cause of occurrence of bright line noise.

FIG. 16 is a schematic view illustrating an example of a configuration of an imaging apparatus according to a ninth embodiment of the present technology.

FIG. 17A is a top plan view illustrating an example of a configuration of an anti-reflection optical element according to the ninth embodiment of the present technology. FIG. 17B is a top plan view illustrating a part of the anti-reflection optical element shown in FIG. 17A in an enlarged manner. FIG. 17C is a cross-sectional view of the track T of FIG. 17B.

FIGS. 18A to 18D are perspective views illustrating an example of a shape of structures of the anti-reflection optical element.

FIG. 19A is a schematic view illustrating a part of the imaging optical system shown in FIG. 16 in an enlarged manner. FIG. 19B is a schematic view illustrating the definition of a numerical aperture NA of the imaging optical system shown in FIG. 19A.

FIG. 20A is a schematic view of the imaging optical system shown in FIG. 19A as viewed from a side on which the ray L₀ is incident. FIG. 20B is an enlarged view illustrating a part of the anti-reflection optical element provided in the imaging optical system shown in FIG. 20A in an enlarged manner.

FIG. 21A is a perspective view illustrating an example of a configuration of the roll master. FIG. 21B is a top plan view illustrating a part of the roll master shown in FIG. 21A in an enlarged manner. FIG. 21C is a cross-sectional view of the track T of FIG. 21B.

FIG. 22A is a top plan view illustrating an example of a configuration of an anti-reflection optical element according to a tenth embodiment of the present technology. FIG. 22B is a top plan view illustrating a part of the anti-reflection optical element shown in FIG. 22A in an enlarged manner. FIG. 22C is a cross-sectional view of the track T of FIG. 22B.

FIG. 23A is a top plan view illustrating an example of a configuration of an anti-reflection optical element according to an eleventh embodiment of the present technology. FIG. 23B is a top plan view illustrating a part of the anti-reflection optical element shown in FIG. 23A in an enlarged manner. FIG. 23C is a cross-sectional view of the track T of FIG. 23B.

FIG. 24A is a top plan view illustrating a part of a surface of an anti-reflection optical element according to a twelfth embodiment of the present technology. FIG. 24B is a schematic view illustrating definition of a virtual track Ti.

FIG. 25A is a schematic view illustrating a range of variation of center positions of structures. FIG. 25B is a schematic view illustrating a rate of variation of the structures.

FIGS. 26A and 26B are schematic diagrams illustrating a first example of a form of arrangement of the structures. FIG. 26C is a schematic diagram illustrating a second example of the form of arrangement of the structures.

FIG. 27A is a top plan view illustrating a part of a surface of an anti-reflection optical element according to a thirteenth embodiment of the present technology. FIG. 27B is a schematic view illustrating a range of variation in the arrangement pitch between the structures.

FIG. 28 is a schematic view illustrating an example of a configuration of an imaging apparatus according to a fourteenth embodiment of the present technology.

FIG. 29 is a schematic view illustrating an example of a configuration of an imaging apparatus according to a fifteenth embodiment of the present technology.

FIGS. 30A to 30D are cross-sectional views illustrating an example of a configuration of an ND filter.

FIG. 31A is a diagram illustrating transmission spectrums of the ND filters of Example 1 and Comparative Example 1. FIG. 31B is a diagram illustrating reflection spectrums of the ND filters of Example 1 and Comparative Example 1.

FIG. 32A is a diagram illustrating a simulation result of Test Example 1-1. FIG. 32B is a diagram illustrating a simulation result of Test Example 1-2.

FIG. 33A is a diagram illustrating a simulation result of Test Example 2-1. FIG. 33B is a graph illustrating intensity distribution which is the simulation result of Test Example 2-1.

FIG. 34A is a diagram illustrating a simulation result of Test Example 2-2. FIG. 34B is a graph illustrating intensity distribution which is the simulation result of Test Example 2-2.

FIG. 35A is a diagram illustrating a simulation result of Test Example 2-3. FIG. 35B is a graph illustrating intensity distribution which is the simulation result of Test Example 2-3.

### BEST MODES FOR CARRYING OUT THE INVENTION

Embodiments of the present technology will be described with reference to drawings in the following order.

1. First Embodiment (an example of a laminate on which a plurality of structures is two-dimensionally arranged on one principal surface of a substrate)

2. Second Embodiment (an example of a transfer device that conveys the laminate with a stage)

3. Third Embodiment (an example of a transfer device that is provided with a belt master having an annular shape)

4. Fourth Embodiment (an example of a laminate on which a plurality of structures is arranged in an S-shape on one principal surface of a substrate)

5. Fifth Embodiment (an example of a laminate on which a plurality of structures is randomly arranged on one principal surface of a substrate)

6. Sixth Embodiment (an example of a laminate on which a plurality of structures is one-dimensionally arranged on one principal surface of a substrate)

7. Seventh Embodiment (an example of a laminate on which a plurality of structures is two-dimensionally arranged on both principal surfaces of a substrate)

8. Eighth Embodiment (an example of a laminate on which a plurality of opaque structures is two-dimensionally arranged)

9. Ninth Embodiment (an example of an optical system, in which scattered light reaching an imaging region is reduced, and an imaging apparatus having the same)

10. Tenth Embodiment (an example in which structures are arranged in a tetragonal lattice shape or a quasi-tetragonal lattice shape)

11. Eleventh Embodiment (an example in which structures are formed in concave shapes)

12. Twelfth Embodiment (an example in which structures change in an line array direction)

13. Thirteenth Embodiment (an example in which structures change in a line direction)

14. Fourteenth Embodiment (an example in which structures are applied to an optical system of a digital video camera)

15. Fifteenth Embodiment (an example of an optical system, in which scattered light reaching an imaging region is reduced, and an imaging apparatus having the same)

### 1. First Embodiment

### Configuration of Laminate

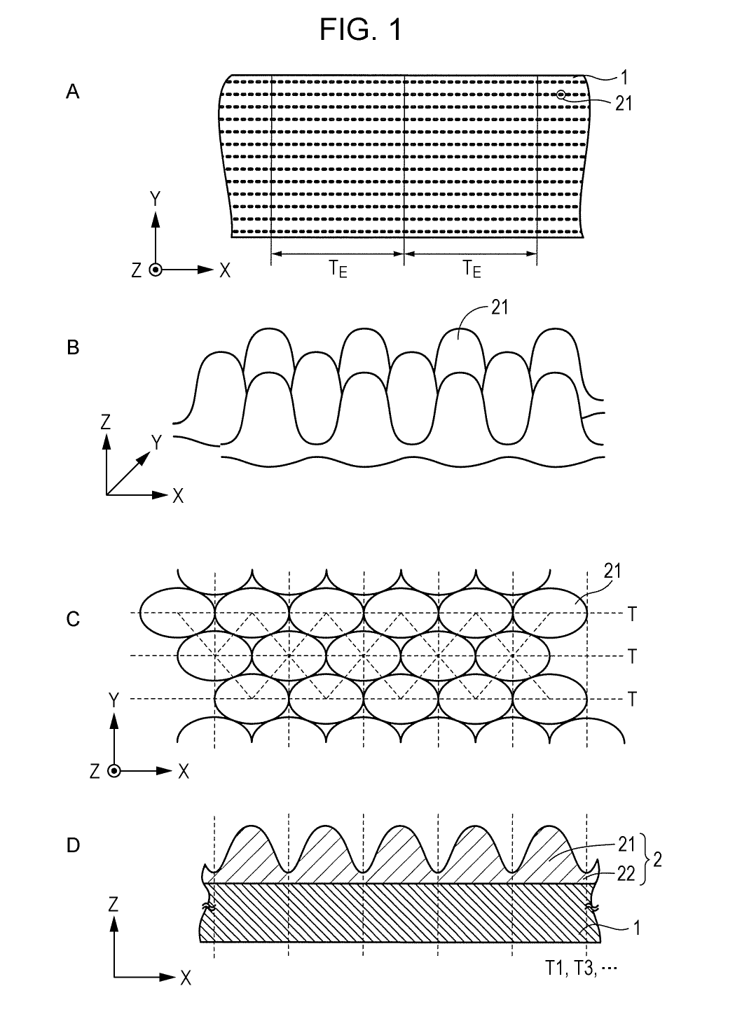

FIG. 1A is a top plan view illustrating an example of a configuration of a laminate according to a first embodiment of the present technology. FIG. 1B is a perspective view illustrating a part of the laminate shown in FIG. 1A in an enlarged manner. FIG. 1C is a top plan view illustrating a part of the laminate shown in FIG. 1A in an enlarged manner. FIG. 1D is a cross-sectional view of the laminate shown in FIG. 1C in a direction in which tracks extend. The laminate includes: a substrate 1 that has a first principal surface and a second principal surface; and a shaped layer 2 that is formed on one of the principal surfaces and has a concave-convex shape. Hereinafter, a first surface on which the shaped layer 2 is formed is appropriately referred to as a front surface, and a second surface opposite thereto is appropriately referred to as a rear surface.

The laminate is quite appropriate for application to an embossed surface body, a designed body, molded elements such as a mechanical element and a medical element, and optical elements such as an anti-reflection element, a polarization element, a period-optic element, a diffraction element, an image formation element, and a waveguide element. Specifically, the laminate is quite appropriate for application to various light amount adjustment filters such as a neutral density (ND) filter, a sharp-cut filter, and an interference filter, a polarization plate, front surfaces of instrument panels of a mobile phone and a vehicle, embossing processes for a mobile phone and the like, a resin molding product, and a glass molding product.

The laminate has, for example, a band shape, is wound into a roll, and is formed as a so-called master. It is preferable that the laminate be flexible. Thereby, the band-like laminate can be wound into a roll so as to be formed as a master, and thus its transport ability, handling ability, and the like are improved.

As shown in FIG. 1A, the laminate has, for example, transferred regions (unit regions) T_{E} with at least one period. Here, the transferred region T_{E} with one period is a region which is transferred by one rotation of the roll master to be described later. That is, a length of the transferred region T_{E} with one period corresponds to a length of a principal surface of the roll master. It is preferable that, at the boundary portion between two adjacent transferred regions T_{E}, there be no inconsistency in the concave-convex shape of the shaped layer 2, and two transferred regions T_{E} be connected seamlessly. The reason is that, in such a manner, it is possible to obtain the laminate that has excellent characteristics and an excellent appearance. Here, the inconsistency means that physical structures such as concave-convex shapes formed of structures 21 are discontinuous. Specific examples of the inconsistency include, for example, disarray in periodicity of a predetermined concave-convex pattern of the transferred region T_{E}, overlap or a gap between the adjacent unit regions, a non-transferred portion, and the like.

### (Substrate)

A material of the substrate 1 is not particularly limited, and is appropriately selectable in accordance with an intended purpose. For example, it is possible to use plastic materials, glass materials, metallic materials, metallic compound materials (for example, ceramics, a magnetic substance, a semiconductor, and the like). Examples of the plastic materials include triacetyl cellulose, polyvinyl alcohol, cyclic olefin polymer, cyclic olefin copolymer, polycarbonate, polyethylene, polyproplene, polyvinyl chloride, polystyrene, polyethylene terephthalate, polyethylene naphthalate, methacryl resin, nylon, polyacetal, fluorine resin, phenol resin, polyurethane, epoxy resin, polyimide resin, polyamide resin, melamine resin, polyether ether ketone, polysulfone, polyether sulfone, polyphenylene sulfide, polyarylate, polyetherimide, polyamideimide, methyl methacrylate (co)polymer, and the like. Examples of the glass materials include a soda-lime glass, a lead glass, a hard glass, a quartz glass, and a liquid crystal compound glass. Examples of the metallic materials and metallic compound materials include silicon, silicon oxide, sapphire, calcium fluoride, magnesium fluoride, barium fluoride, lithium fluoride, zinc selenide, potassium bromide, and the like.

Examples of the shape of the substrate 1 include a sheet shape, a plate shape, and a block shape, but are not particularly limited to these shapes. Here, the sheet is defined to include a film. It is preferable that the substrate 1 have a band shape as a whole, and face the length direction of the substrate 1, and the transferred regions T_{E} as the unit regions be consecutively formed thereon. As the shape of the front surface and the rear surface of the substrate 1, for example, it may be possible to use either the planar surface or the curved surface. Either the front surface or the rear surface may be formed as a planar surface or a curved surface. One of the front surface and the rear surface may be formed as a planar surface, and the other one thereof may be formed as a curved surface.

The substrate 1 is opaque to energy rays for curing the energy-ray-curable resin composition for forming the shaped layer 2. In the present description, the energy rays mean the energy rays for curing the energy-ray-curable resin composition for forming the shaped layer 2. For example, a decorative layer or a function layer may be formed on the front surface of the substrate 1 through printing, coating, vacuum deposition, or the like.

The substrate 1 has a single layer structure or a laminated layer structure. Here, the laminated layer structure is a laminated layer structure in which two or more layers are laminated. At least one layer in the laminated layer structure is an opaque layer that is opaque to the energy rays. Examples of a method of forming the laminate include a method of directly bonding gaps between the layers through fusion, surface treatment, or the like, and a method of bonding the gaps between the layers through a bonding layer such as an adhesion layer or a sticking layer, but are not particularly limited. The bonding layer may include materials such as a pigment that absorbs the energy rays. Further, when the substrate 1 has a laminated layer structure, an opaque layer, which is opaque to the energy rays, and a transparent layer, which is transparent to the energy rays, may be combined. Further, when the substrate 1 has two or more opaque layers, those may have absorption characteristics different from each other. The substrate 1 may be preferable for an element main body of an optical element or the like.

As a material of the transparent layer, for example, it is possible to use a transparent organic film such as an acryl resin coating material, a transparent metallic film, an inorganic film, a metallic compound film, or a laminate thereof, but the material is not particularly limited. As a material of the opaque layer, for example, it is possible to use an organic film such as an acryl resin coating material including a pigment, a metallic film, a metallic compound film, or a laminate thereof, but the material is not particularly limited. As the pigment, for example, it is possible to use a material, such as carbon black, having light absorptivity.

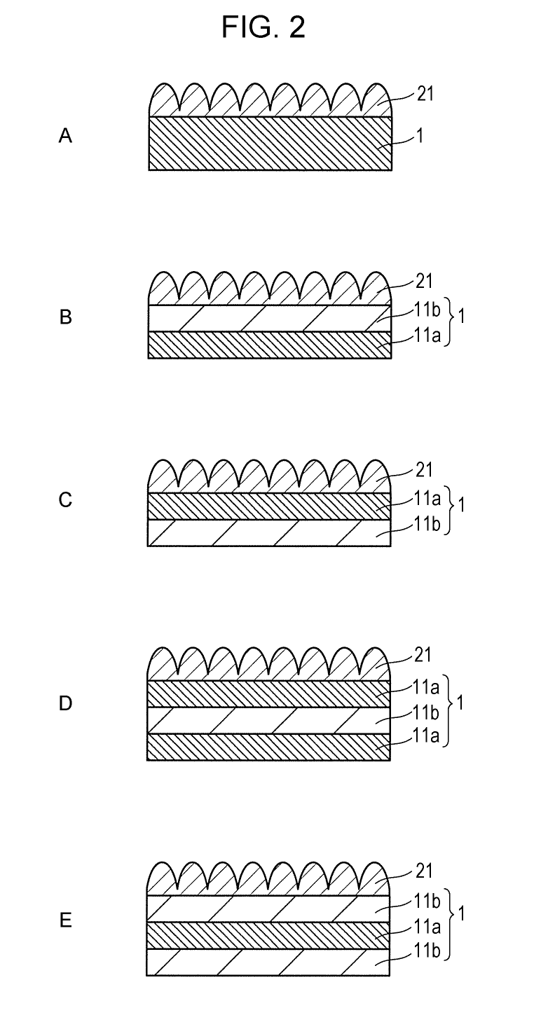

FIGS. 2A to 2E are cross-sectional views respectively illustrating first to fifth examples of a substrate.

### First Example

As shown in FIG. 2A, the substrate 1 has a single layer structure, and the entire substrate is an opaque layer which is opaque to the energy rays.

### Second Example

As shown in FIG. 2B, the substrate 1 has a double layer structure, and includes an opaque layer 11a which is opaque to the energy rays, and a transparent layer 11b which is transparent to the energy rays. The opaque layer 11a is disposed on the rear surface side, and the transparent layer 11b is disposed on the front surface side.

### Third Example

As shown in FIG. 2C, the substrate 1 has a double layer structure, and includes an opaque layer 11a which is opaque to the energy rays, and a transparent layer 11b which is transparent to the energy rays. The opaque layer 11a is disposed on the front surface side, and the transparent layer 11b is disposed on the rear surface side.

### Fourth Example

As shown in FIG. 2D, the substrate 1 has a triple layer structure, and includes a transparent layer 11b which is transparent to the energy rays, and opaque layers 11a and 11a which are formed on both principal surfaces of the transparent layer 11b and are opaque to the energy rays. One opaque layer 11a is disposed on the rear surface side, and the other opaque layer 11a is disposed on the front surface side.

### Fifth Example

As shown in FIG. 2E, the substrate 1 has a triple layer structure, and includes an opaque layer 11a, which is opaque to the energy rays, and transparent layers 11b and 11b which are formed on both principal surfaces of the opaque layer 11a and are transparent to the energy rays. One transparent layer 11b is disposed on the rear surface side, and the other transparent layer 11b is disposed on the front surface side.

### (Shaped Layer)

The shaped layer 2 has a front surface on which the transferred regions T_{E} having predetermined concave-convex patterns are consecutively formed. The shaped layer 2 is, for example, a layer on which a plurality of structures 21 is two-dimensionally arranged, and may have a bottom layer 22 provided between the plurality of structures 21 and the substrate 1 as necessary. The bottom layer 22 is a layer which is formed integrally with the structures 21 on the bottom side of the structures 21, and is formed by curing the energy-ray-curable resin composition in a similar manner to the structures 21. The thickness of the bottom layer 22 is not particularly limited, and is appropriately selectable as necessary. The plurality of structures 21 is, for example, arranged on the front surface of the substrate 1 so as to form a plurality of tracks T. The plurality of structures 21, which is arranged so as to form the plurality of tracks, may be formed, for example, in a predetermined regular arrangement pattern. As the arrangement pattern, for example, it is possible to use a lattice pattern. The lattice pattern is, for example, at least one of a hexagonal lattice pattern, a quasi-hexagonal lattice pattern, a tetragonal lattice pattern, and a quasi-tetragonal lattice pattern. A height of the structure 21 may regularly or irregularly change on the front surface of the substrate 1.

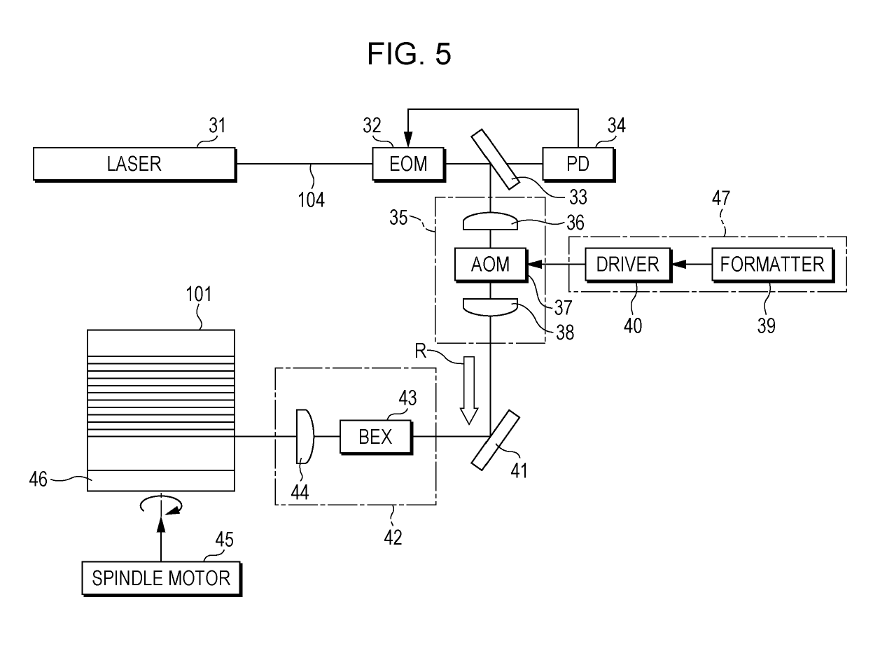

The structures 21 have shapes convex or concave toward the front surface of the substrate 1. The structures 21 may have shapes both convex and concave toward the front surface of the substrate 1. Examples of a specific shape of the structure 21 include a conical shape, a columnar shape, a needle shape, a hemispherical shape, an oval hemisphere shape, a polygonal shape, and the like, but are not limited to those shapes, and may employ other shapes. Examples of the conical shape include a conical shape of which the apex is pointed, a conical shape of which the apex is planar, and a conical shape of which the apex has a curved surface having a convex or concave shape, but are not limited to those shapes. Further, the conical surface of the conical shape may be curved to be concave or convex. The roll master may be manufactured using the roll master exposure device (refer to FIG. 5) to be described later. In this case, it is preferable that an elliptical cone shape, of which the apex has a curved surface having a convex shape, or an elliptical frustum shape, of which the apex is planar, be employed as the shape of the structure 21, and a direction of the major axis of the ellipse forming the bottom thereof be set to coincide with the extending direction of the track.

The pitch between the structures 21 is appropriately selected depending on the type of the laminate. For example, when the laminate is an optical element such as sub-wavelength structures for preventing light from reflecting, the structures 21 are two-dimensionally arranged on a periodic basis with a narrow arrangement pitch equal to or less than a wavelength band of light as a target of reduction in reflection, for example, an arrangement pitch substantially equal to a wavelength of visible light. The wavelength band of light as a target of reduction in reflection is, for example, a wavelength band of ultraviolet light, a wavelength band of visible light, or a wavelength band of infrared light. Here, the wavelength band of ultraviolet light is defined as a wavelength band of 10 nm to 400 nm, the wavelength band of visible light is defined as a wavelength band of 400 nm to 830 nm, and the wavelength band of infrared light is defined as a wavelength band of 830 nm to 1 mm.

The shaped layer 2 is formed by curing the energy-ray-curable resin composition. It is preferable that the shaped layer 2 be formed by advancing a curing reaction such as polymerization of the energy-ray-curable resin composition, with which the substrate 1 is coated, from a side opposite to the substrate 1. The reason is that, in such a manner, it is possible to use a substrate, which is opaque to the energy rays, as the substrate 1. It is preferable that the transferred regions T_{E} be connected without causing inconsistency at the time of curing the energy-ray-curable resin composition. The inconsistency at the time of curing the energy-ray-curable resin composition is, for example, a difference in a degree of polymerization.

The energy-ray-curable resin composition is a resin composition which is curable by being irradiated with the energy rays. The energy rays are defined as energy rays capable of functioning as a trigger of a radical polymerization reaction, a cationic polymerization reaction, an anionic polymerization reaction, and the like. The energy rays include electron rays, ultraviolet rays, infrared rays, laser beams, visible rays, ionized radiation (X-rays, α-rays, β-rays, γ-rays, and the like), microwaves, high-frequency waves, and the like. The energy-ray-curable resin composition may be used in combination with another resin, as necessary. For example, it may be used in combination with another curable resin such as a thermoset resin. Further, the energy-ray-curable resin composition may be an organic-inorganic-hybrid material. Further, two or more energy-ray-curable resin compositions may be used in combination. As the energy-ray-curable resin composition, it is preferable to use an ultraviolet curable resin that is curable by ultraviolet rays.

The ultraviolet curable resin is formed of, for example, a monofunctional monomer, a bifunctional monomer, a multifunctional monomer, an initiator, and the like. Specifically, the ultraviolet curable resin is formed of one of the following materials or a mixture of the following materials.

Examples of the monofunctional monomer include carboxylic acid base (acrylate), hydroxyl base (2-hydroxy ethyl acrylate, 2-hydroxy propyl acrylate, 4-hydroxy butyl acrylate), alkyl, alicyclic based (isobutyl acrylate, t-butyl acrylate, isooctyl acrylate, lauryl acrylate, stearyl acrylate, isobonylacrylate, cyclo hexyl acrylate), other functional monomers (2-methoxy ethyl acrylate, methoxy ethylene glycol acrylate, 2-ethoxy ethyl acrylate, tetrahydro furfuryl acrylate, benzil acrylate, ethyl carbitol acrylate, phenoxy ethyl acrylate, N,N-dimethyl amino ethyl acrylate, N,N-dimethylaminopropylacrylamide, N,N-dimethyl acryl amide, acryloyl morpholine, N-isopropyl acryl amide, N,N-diethyl acryl amide, N-vinyl pyrrolidone, 2-(perfluoro octyl)ethyl acrylate, 3-perfluoro hexyl-2-hydroxy propyl acrylate, 3-perfluoro octyl-2-hydroxy propyl acrylate, 2-(perfluoro decyl)ethyl acrylate, 2-(perfluoro-3-methyl butyl)ethyl acrylate), 2,4,6-tribromo phenol acrylate, 2,4,6-tribromo phenol methacrylate, 2-(2,4,6-tribromo phenoxy)ethyl acrylate), 2-ethyl hexyl acrylate, and the like.

Examples of the bifunctional monomer include tri (propyleneglycol) diacrylate, trimethylol propane diallyl ether, urethane acrylate, and the like.

Examples of the multifunctional monomer include trimethylol propane triacrylate, dipentaerythritol penta and hexa acrylate, ditrimethylol propane tetraacrylate, and the like.

Examples of the initiator include 2,2-dimethoxy-1,2-diphenyl ethane-1-on, 1-hydroxy-cyclo hexyl phenyl ketone, 2-hydroxy-2-methyl-1-phenyl propane-1-on, and the like.

Further, as the material of the shaped layer 2, it may be possible to use not only the above-mentioned energy-ray-curable resin composition, but also a material from which an inorganic film can be obtained after perhydropolysilazane and the like resistant to heat is burned, a silicon-based resin material, and the like.

Further, the energy-ray-curable resin composition may include a filler, a functional additive, a solvent, an inorganic material, a pigment, an antistatic agent, a sensitizing dye, and the like, as necessary. As the filler, for example, it is possible to use either inorganic microparticles or organic microparticles. Examples of the inorganic microparticles include metallic oxide microparticles of SiO₂, TiO₂, ZrO₂, SnO₂, Al₂O₃, and the like. Examples of the functional additive include a leveling agent, a surface adjustment agent, an absorbent, a defoamer, and the like.

### [Configuration of Transfer Device]

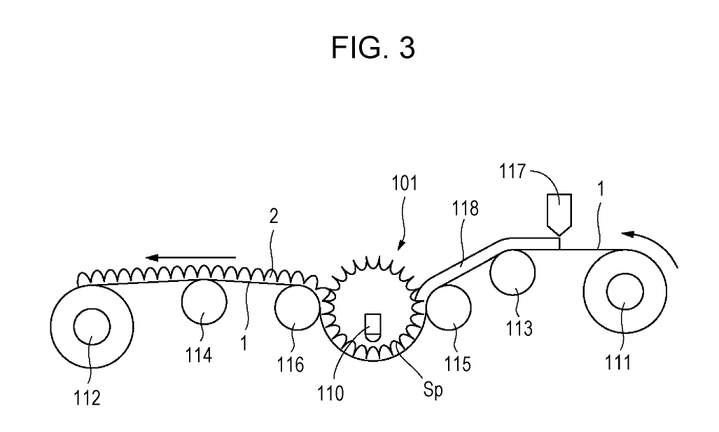

FIG. 3 is a schematic view illustrating an example of a configuration of a transfer device according to the first embodiment of the present technology. The transfer device includes a roll master 101, a substrate supply roller 111, a winding roller 112, guide rollers 113 and 114, a nip roller 115, an exfoliating roller 116, a coating device 117, and an energy ray source 110.

The substrate supply roller 111 winds the substrate 1 having a sheet shape or the like into a roll, and is disposed to continuously deliver the substrate 1 through the guide roller 113. The winding roller 112 is disposed to wind the laminate having the shaped layer 2 onto which a concave-convex shape is transferred by the transfer device. The guide rollers 113 and 114 are disposed in the transport path of the transfer device so as to transport the band-like substrate 1 and a band-like laminate. The nip roller 115 is disposed to nip the substrate 1, which is fed out from the substrate supply roller 111 and is coated with the energy-ray-curable resin composition, by the roll master 101. The roll master 101 has a transfer surface for forming the shaped layer 2, and one or more energy ray sources 110 are provided therein. The roll master 101 will be described later in detail. The exfoliating roller 116 is disposed to exfoliate the shaped layer 2, which is obtained by curing an energy-ray-curable resin composition 118, from the transfer surface of the roll master 101.

Materials of the substrate supply roller 111, the winding roller 112, the guide rollers 113 and 114, the nip roller 115, and the exfoliating roller 116 are not particularly limited, and metal such as stainless steel, rubber, silicone, and the like can be appropriately selected and used depending on desired characteristics of rollers. As the coating device 117, for example, it is possible to use an apparatus having coating means such as a coater. As the coater, for example, in consideration of physical properties of the energy-ray-curable resin composition used in coating, it is possible to appropriately use a coater such as a gravure, a wire bar coating, and a dye.

### [Configuration of Roll Master]

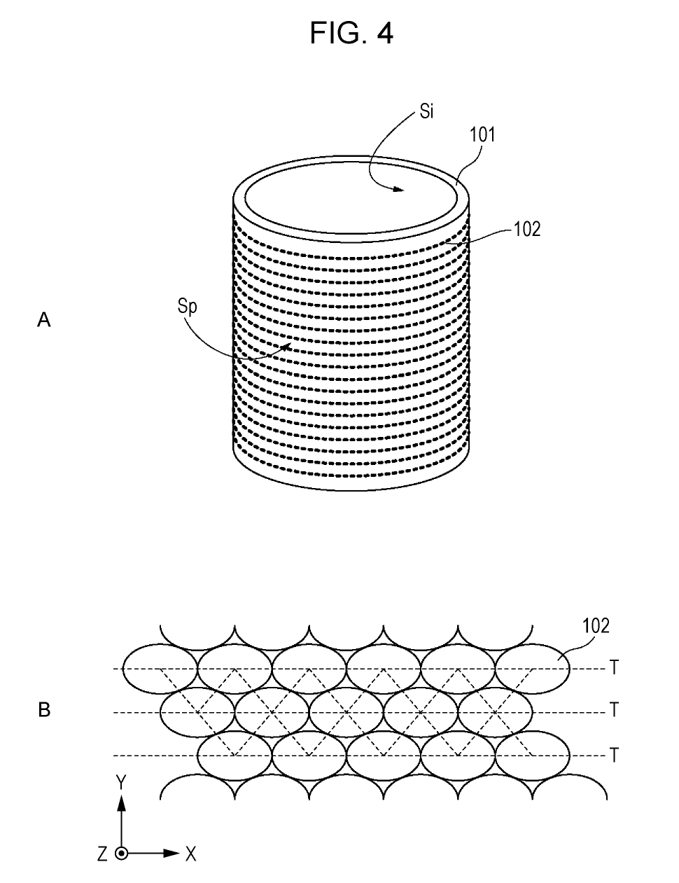

FIG. 4A is a perspective view illustrating an example of a configuration of a roll master. FIG. 4B is a top plan view illustrating a part of the roll master shown in FIG. 4A in an enlarged manner. The roll master 101 is, for example, a master having a cylindrical shape, and has a transfer surface Sp which is formed on the front surface thereof, and a rear surface Si which is an inner peripheral surface formed on the inside opposite to the transfer surface. Inside the roll master 101, for example, a circular columnar cavity section, which is formed by the rear surface Si, is formed. Thus, the one or more energy ray sources 110 can be provided in the cavity section. A plurality of structures 102 having, for example, concave or convex shapes is formed on the transfer surface Sp. The shapes of the structures 102 are transferred onto the energy-ray-curable resin composition with which the substrate 1 is coated, whereby the shaped layer 2 of the laminate is formed. That is, a pattern, which has a reversed shape of the concave-convex shape of the shaped layer 2 of the laminate, is formed on the transfer surface Sp.

The roll master 101 is transparent to the energy rays radiated from the energy ray source 110, and is configured to emit the energy rays, which are radiated from the energy ray source 110 and incident on the rear surface Si, from the transfer surface Sp. Due to the energy rays emitted from the transfer surface Sp, the energy-ray-curable resin composition 118, with which the substrate 1 is coated, is cured. A material of the roll master 101 may be anything as long as it is transparent to the energy rays, and is not particularly limited. As a material transparent to the ultraviolet rays, it is preferable to use glass, quartz, a transparent resin, or an organic-inorganic-hybrid material. Examples of the transparent resin include polymethyl methaacrylate (PMMA), polycarbonate (PC), and the like. Examples of the organic-inorganic-hybrid material include polydimethyl siloxane (PDMS), and the like. A metallic film, a metallic compound film, or an organic film may be formed on at least one of the transfer surface Sp and the rear surface Si of the roll master 101.

The one or more energy ray sources 110 are supported on the inside of the cavity section of the roll master 101 so as to irradiate the energy-ray-curable resin composition 118, with which the substrate 1 is coated, with the energy rays. When the roll master 101 has the plurality of energy ray sources 110, it is preferable that the energy ray sources 110 be arranged in one or more lines. As the energy ray source, anything may be used as long as it is capable of emitting the energy rays such as electron rays, ultraviolet rays, infrared rays, laser beams, visible rays, ionized radiation (X-rays, α-rays, β-rays, γ-rays, or the like), microwaves, high-frequency waves, or the like, but the energy ray source is not particularly limited. As a form of the energy ray source, for example, it may be possible to use a point-like light source and a linear light source, but the form is not particularly limited, and the point-like light source and the linear light source may be used in combination. When the point-like light source is used as the energy ray source, it is preferable that the linear light source be formed by linearly arranging a plurality of the point-like light sources. It is preferable that the linear light source be disposed in parallel with a rotation axis of the roll master 101. Examples of the energy ray source emitting ultraviolet rays include a low pressure mercury lamp, a high pressure mercury lamp, a short-arc-discharge lamp, an ultraviolet light emitting diode, a semiconductor laser, a fluorescent lamp, an organic electroluminescence, an inorganic electroluminescence, a light emitting diode, an optical fiber, and the like, but are not particularly limited thereto. Further, by further providing a slit in the roll master 101, the energy-ray-curable resin composition 118 may be irradiated with the energy rays which are radiated from the energy ray source 110 through the slit. In this case, the energy-ray-curable resin composition 118 may be cured by heat generated by absorbing the energy rays.

### [Configuration of Roll Master Exposure Device]

FIG. 5 is a schematic view illustrating an example of a configuration of a roll master exposure device for manufacturing the roll master. The roll master exposure device is configured as an optical disk recording device.

The laser light source 31 is a light source for exposing a resist formed as a film on the surface of the roll master 101 as a recording medium, and generates laser light 104 having a wavelength λ of, for example, 266 nm for recording. The laser light 104 emitted from the laser light source 31 travels as parallel beams in a straight line, and is incident into an electro-optic element (EOM: Electro Optical Modulator) 32. The laser light 104 transmitted through the electro-optic element 32 is reflected by a mirror 33, and is guided into a modulation optical system 35.

The mirror 33 is configured as a polarization beam splitter, and has a function of reflecting one polarization component and transmitting the other polarization component. The polarization component transmitted through the mirror 33 is received by the photo diode 34. On the basis of the light reception signal, phase modulation of the laser light 104 is performed by controlling the electro-optic element 32.

In the modulation optical system 35, the laser light 104 is condensed on an acousto-optic element (AOM: Acousto-Optic Modulator) 37 made of glass (SiO₂) or the like through a condensing lens 36. The laser light 104 is subjected to intensity modulation by the acousto-optic element 37, is divergent, and is thereafter converted into parallel beams through a lens 38. The laser light 104, which is emitted from the modulation optical system 35, is reflected by the mirror 41, and is guided into a movable optical table 42 horizontally and in parallel.

The movable optical table 42 has a beam expander 43 and an objective lens 44. The laser light 104 guided into the movable optical table 42 is formed in a desired beam shape through a beam expander 43, and is thereafter emitted onto a resist layer on the roll master 101 through the objective lens 44. The roll master 101 is placed on the turntable 46 which is connected to a spindle motor 45. Then, by intermittently irradiating the resist layer with the laser light 104 while rotating the roll master 101 and moving the laser light 104 in the height direction of the roll master 101, an exposure process is performed on the resist layer. The formed latent image has a substantially elliptical shape which has a major axis in a circumferential direction thereof. The laser light 104 is moved by movement of the movable optical table 42 in a direction of an arrow R.

The exposure device includes, for example, a control mechanism 47 for forming latent images, which correspond to two-dimensional patterns such as hexagonal lattices or quasi-hexagonal lattices shown in FIG. 1C, on the resist layer. The control mechanism 47 includes a formatter 39 and a driver 40. The formatter 39 includes a polarity reversing portion. The polarity reversing portion controls the timing of irradiating the resist layer with the laser light 104. The driver 40 receives an output of the polarity reversing portion, and controls the acousto-optic element 37.

In the roll master exposure device, the rotation controller of the recording device is synchronized with a polarity reversion formatter signal for every single track such that the two-dimensional patterns are spatially connected, and generates a signal, whereby the intensity modulation is performed by the acousto-optic element 37. By performing patterning at an appropriate feed pitch, an appropriate modulation frequency, and an appropriate rotation number for a constant angular velocity (CAV), it is possible to record the hexagonal lattice or quasi-hexagonal lattice pattern. For example, in order for a period in a circumferential direction to be set to 315 nm and for a period in a direction of about 60 degrees (about −60 degrees) with respect to the circumferential direction to be set to 300 nm, it is preferable that the feed pitch be set to 251 nm (Pythagorean theorem). A frequency of the polarity reversion formatter signal is changed depending on the rotation number (for example, 1800 rpm, 900 rpm, 450 rpm, or 225 rpm) of the roller. For example, the frequencies of the polarity reversion formatter signal respectively corresponding to the rotation numbers 1800 rpm, 900 rpm, 450 rpm, and 225 rpm of the roller are 37.70 MHz, 18.85 MHz, 9.34 MHz, and 4.71 MHz. The quasi-hexagonal lattice pattern can be obtained by forming a fine latent image in a desired recording region in the following way: the far ultraviolet laser light is enlarged by five times the beam diameter through the beam expander (BEX) 33 on the movable optical table 42, and is emitted onto the resist layer on the roll master 101 through the objective lens 44 with a numerical aperture (NA) of 0.9. The spatial frequency (315 nm period of circumference, 300 nm period in the direction of about 60 degrees (about −60 degrees) with respect to the circumferential direction) of the pattern is uniform.

### [Manufacturing Method of Laminate]

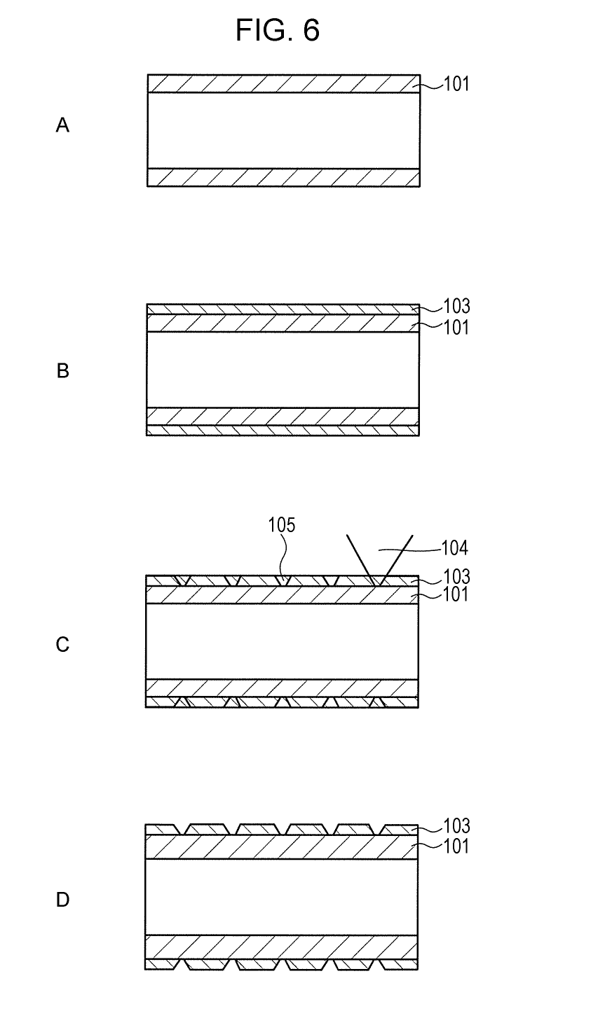

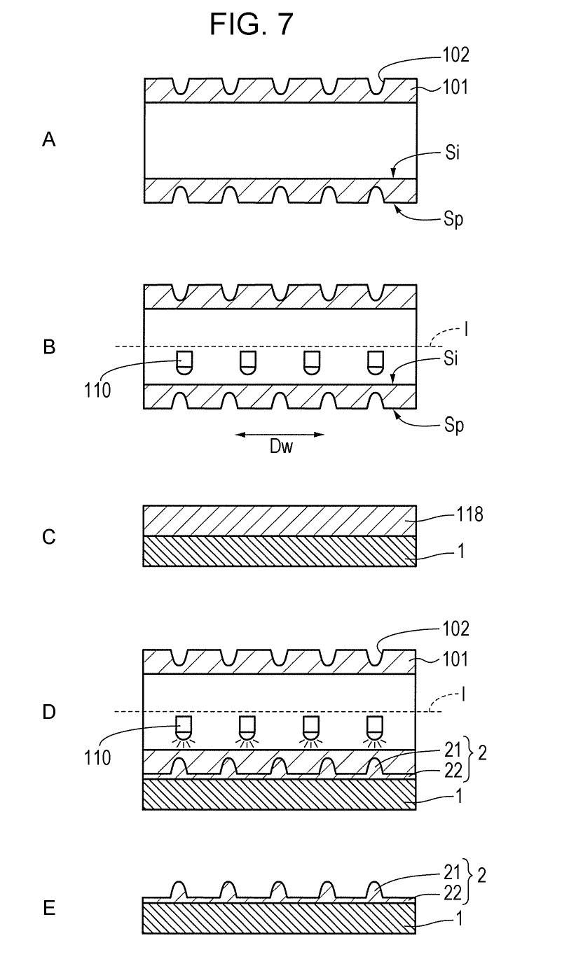

FIGS. 6A to 7E are process diagrams illustrating an example of a method of manufacturing the laminate according to the first embodiment of the present technology.

### (Resist Film Forming Process)

First, as shown in FIG. 6A, the roll master 101 of the cylindrical shape is provided. Next, as shown in FIG. 6B, the resist layer 103 is formed on the surface of the roll master 101. As a material of the resist layer 103, for example, it may be possible to use either the organic resist or the inorganic resist. As a material of the organic resist, for example, it is possible to use a novolac resist, a chemical-amplification-type resist, or the like. Further, as the inorganic resist, for example, it is possible to use a metallic compound made of one or more transition metals.

### (Exposure Process)

Next, as shown in FIG. 6C, the resist layer 103, which is formed on the surface of the roll master 101, is irradiated with the laser light (exposure beam) 104. Specifically, the roll master 101 is rotated in a state where it is placed on the turntable 46 of the roll master exposure device shown in FIG. 5, and the resist layer 103 is irradiated with the laser light (exposure beam) 104. At this time, by intermittently emitting the laser light 104 while moving the laser light 104 in the height direction (a direction in parallel with the central axis of the roll master 101 having a circular columnar shape or a cylindrical shape) of the roll master 101, the entire surface of the resist layer 103 is exposed. Thereby, a latent image 105, which corresponds to the locus of the laser light 104, is formed throughout the entire surface of the resist layer 103 at a pitch substantially equal to the wavelength of visible light.

For example, the latent image 105 is formed so as to form a plurality of tracks on the master surface, and a hexagonal lattice pattern or a quasi-hexagonal lattice pattern is formed thereon. The latent image 105 has, for example, an elliptical shape of which the major axis is directed to the extending direction of the track.

### (Development Process)

Next, a developer is dropped on the resist layer 103 while the roll master 101 is rotated, and the resist layer 103 is subjected to a development process as shown in FIG. 6D. As shown in the drawing, when the resist layer 103 is formed by a positive-type resist, a solution rate of the developer in an exposed portion exposed by the laser light 104 is higher than that in a non-exposed portion. Therefore, a pattern corresponding to the latent image (exposed portion) 105 is formed on the resist layer 103.

### (Etching Process)

Next, the pattern (resist pattern) of the resist layer 103 formed on the roll master 101 is used as a mask, and the surface of the roll master 101 is subjected to an etching process. Thereby, as shown in FIG. 7A, it is possible to obtain concave portions of which the major axes are directed to the extending directions of the tracks and which have elliptical cone shapes or elliptical frustum shapes, that is, it is possible to obtain the structures 102. As the etching, for example, it is possible to use dry etching or wet etching.

### (Ray Source Arrangement Process)

Next, as shown in FIG. 7B, the one or more energy ray sources 110 are disposed in a housing space (cavity section) within the roll master 101. It is preferable that the energy ray source 110 be disposed in parallel with an axial direction of the rotation axis l or a width direction Dw of the roll master 101.

### (Transfer Process)

Next, as necessary, the surface of the substrate 1, which is coated with the energy-ray-curable resin composition 118, is subjected to surface treatment such as corona treatment, plasma treatment, flame treatment, UV treatment, ozone treatment, or blast treatment. Next, as shown in FIG. 7C, coating or printing of the energy-ray-curable resin composition 118 is performed on the roll master 101 or the substrate 1 which is long. Although the coating method is not particularly limited, for example, it is possible to use potting on the substrate or the master, a spin coating method, a gravure coating method, a die coating method, a bar coating method, and the like. As the printing method, for example, it is possible to use an anastatic printing method, an offset printing method, a gravure printing method, an intaglio printing method, a rubber plate printing method, a screen printing method, and the like. Next, as necessary, heat treatment such as solvent removal or pre-baking is performed.

Next, as shown in FIG. 7D, while the roll master 101 is rotated, the transfer surface Sp is brought into tight contact with the energy-ray-curable resin composition 118, and the energy-ray-curable resin composition 118 is irradiated with the energy rays emitted from the energy ray source 110 within the roll master 101 from a side of the transfer surface Sp of the roll master 101. With such a configuration, the energy-ray-curable resin composition 118 is cured, thereby forming the shaped layer 2. Specifically, the curing reaction of the energy-ray-curable resin composition 118 sequentially advances from the side of the transfer surface Sp of the roll master 101 toward the surface side of the substrate 1, and the entire energy-ray-curable resin composition 118 subjected to the coating or printing is cured, thereby forming the shaped layer 2. Presence/absence of the bottom layer 22 or a thickness of the bottom layer 22 is selectable, for example, by adjusting a pressure of the roll master 101 against the surface of the substrate 1. Next, the shaped layer 2 formed on the substrate 1 is exfoliated from the transfer surface Sp of the roll master 101. Thereby, as shown in FIG. 7E, it is possible to obtain a laminate in which the shaped layer 2 is formed on the surface of the substrate 1. In the transfer process, in a similar manner to that in the above description, the concave-convex shape is transferred by setting the length direction of the substrate 1 having a band shape as a forward direction of the rotation of the roll master 101.

Here, the transfer process using the transfer device shown in FIG. 3 will be described in detail.

First, the substrate 1, which is long, is delivered from the substrate supply roller 111, and the delivered substrate 1 passes under the coating device 117. Next, the substrate 1 passing under the coating device 117 is coated with the energy-ray-curable resin composition 118 by the coating device 117. Then, the substrate 1 coated with the energy-ray-curable resin composition 118 is transported toward the roll master 101 through the guide roller 113.

Subsequently, the transported substrate 1 is sandwiched between the roll master 101 and the nip roller 115 without causing air bubbles between the substrate 1 and the energy-ray-curable resin composition 118. Thereafter, while the energy-ray-curable resin composition 118 comes into tight contact with the transfer surface Sp of the roll master 101, the substrate 1 is transported along the transfer surface Sp of the roll master 101, and the energy-ray-curable resin composition 118 is irradiated with the energy rays radiated from the one or more energy ray sources 110, through the transfer surface Sp of the roll master 101. Thereby, the energy-ray-curable resin composition 118 is cured, thereby forming the shaped layer 2. Next, the shaped layer 2 is exfoliated from the transfer surface Sp of the roll master 101 by the exfoliating roller 116, whereby it is possible to obtain the laminate which is long. Subsequently, the obtained laminate is transported toward the winding roller 112 through the guide roller 114, and the laminate, which is long, is wound by the winding roller 112. Thereby, it is possible to obtain a master roll around which the long laminate is wound.

### 2. Second Embodiment

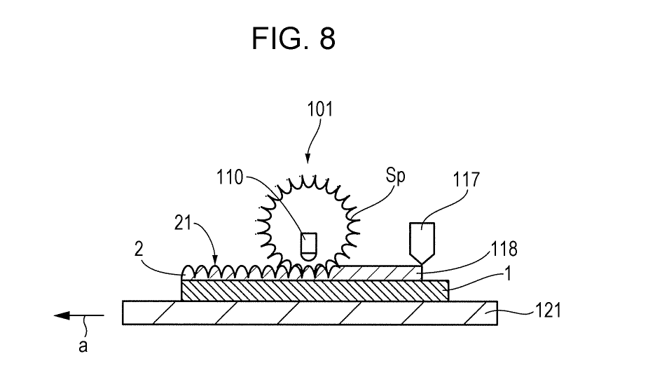

FIG. 8 is a schematic view illustrating an example of a configuration of a transfer device according to a second embodiment of the present technology. The transfer device includes a roll master 101, a coating device 117, and a transport stage 121. In the second embodiment, the same components as in the first embodiment will be referenced by the same reference signs and numerals, and a description thereof will be omitted. The transport stage 121 is configured to transport the substrate 1, which is placed on the transport stage 121, toward the direction of the arrow a.

Next, an example of an operation of the transfer device having the above-mentioned configuration will be described.

First, the substrate 1 passing under the coating device 117 is coated with the energy-ray-curable resin composition 118 by the coating device 117. Next, the substrate 1 coated with the energy-ray-curable resin composition 118 is transported toward the roll master 101. Next, the energy-ray-curable resin composition 118 is transported while coming into tight contact with the transfer surface Sp of the roll master 101, and the energy-ray-curable resin composition 118 is irradiated with the energy rays, which are radiated from the one or more energy ray sources 110 provided in the roll master 101, through the transfer surface Sp of the roll master 101. Thereby, the energy-ray-curable resin composition 118 is cured, thereby forming the shaped layer 2. Next, by transporting the transport stage in the direction of the arrow a, the shaped layer 2 is exfoliated from the transfer surface Sp of the roll master 101. Thereby, it is possible to obtain the laminate which is long. Next, as necessary, the obtained laminate is cut by a predetermined size or shape. In such a manner, it is possible to obtain a desired laminate.

### 3. Third Embodiment

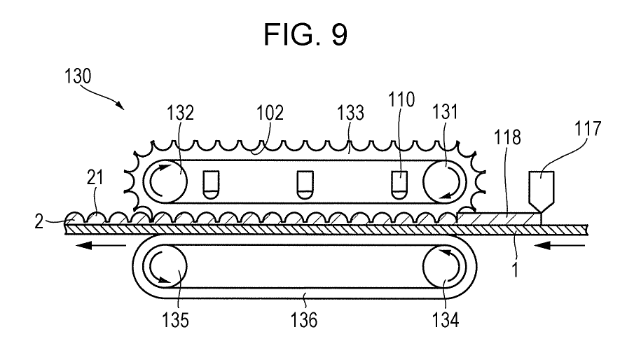

FIG. 9 is a schematic view illustrating an example of a configuration of a transfer device according to a third embodiment of the present technology. The transfer device includes rollers 131, 132, 134, and 135, an embossed belt 133 as a belt master, a planar belt 136, the one or more energy ray sources 110, and the coating device 117. In the third embodiment, the same components as in the first embodiment will be referenced by the same reference signs and numerals, and a description thereof will be omitted.

The embossed belt 133 is an example of the belt master and has an annular shape. The plurality of structures 102 is, for example, two-dimensionally arranged on an outer circumferential surface thereof. The embossed belt 133 is transparent to the energy rays. The planar belt 136 has an annular shape, and an outer circumferential surface thereof is formed as a planar surface. A gap substantially equal to the thickness of the substrate 1 is formed between the embossed belt 133 and the planar belt 136, and the substrate 1 coated with the energy-ray-curable resin composition 118 can travel between the belts.

The roller 131 and the roller 132 are disposed to be separated. The roller 131 and the roller 132 support the embossed belt 133 by an inner circumferential surface thereof, and the embossed belt 133 is held in an elongated elliptical shape or the like. By driving rotation of the roller 131 and the roller 132 provided inside the embossed belt 133, the embossed belt 133 is configured to be rotated.

The roller 134 and the roller 135 are disposed to be opposed to the roller 131 and the roller 132, respectively. The roller 134 and the roller 135 support the planar belt 136 by an inner circumferential surface thereof, and the planar belt 136 is held in an elongated elliptical shape or the like. By driving rotation of the roller 134 and the roller 135 provided inside the planar belt 136, the planar belt 136 is configured to be rotated.

Inside the embossed belt 133, the one or more energy ray sources 110 are disposed. The one or more energy ray sources 110 are held to irradiate the substrate 1, which travels between the embossed belt 133 and the planar belt 136, with the energy rays. It is preferable that the energy ray sources 110 such as linear light sources be disposed in parallel with the width direction of the embossed belt 133. Any arrangement of the energy ray sources 110 may be allowed as long as the arrangement is made in a space formed by the inner circumferential surface of the embossed belt 133, and is not particularly limited. For example, the arrangement may be made inside at least one of the roller 131 and the roller 132. In this case, it is preferable that the roller 131 and the roller 132 be formed of a material transparent to the energy rays.

Next, an example of an operation of the transfer device having the above-mentioned configuration will be described.

First, the substrate 1 passing under the coating device 117 is coated with the energy-ray-curable resin composition 118 by the coating device 117. Next, the substrate 1 coated with the energy-ray-curable resin composition 118 is transported from the side of the rollers 131 and 134 into a gap between the embossed belt 133 and the planar belt 136 which are rotating. Thereby, the transfer surface of the embossed belt 133 comes into tight contact with the energy-ray-curable resin composition 118. Next, while the tight contact condition is maintained, the energy-ray-curable resin composition 118 is irradiated with the energy rays, which are radiated from the energy ray sources 110, through the embossed belt 133. Thereby, the energy-ray-curable resin composition 118 is cured, thereby forming the shaped layer 2 on the substrate 1. Next, the embossed belt 133 is exfoliated from the shaped layer 2. Thereby, it is possible to obtain a desired laminate.

### 4. Fourth Embodiment

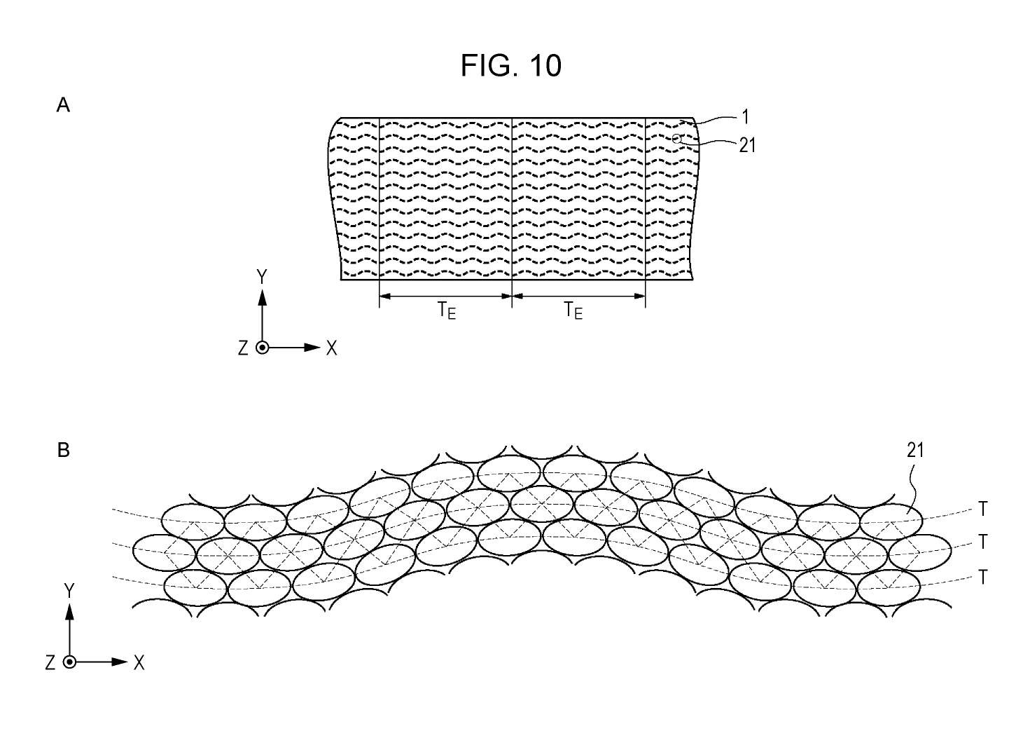

FIG. 10A is a top plan view illustrating an example of a configuration of a laminate according to a fourth embodiment of the present technology. FIG. 10B is a top plan view illustrating a part of the laminate shown in FIG. 10A in an enlarged manner. The laminate according to the fourth embodiment is different from the laminate according to the first embodiment in that the structures 21 are arranged on S-shaped tracks (hereinafter, referred to as meandering tracks). It is preferable that the meanders of the respective tracks on the substrate 1 be synchronized. That is, it is preferable that the meanders be synchronized meanders. As described above, by synchronizing the meanders, a unit lattice shape such as a hexagonal lattice or a quasi-hexagonal lattice is maintained, and thus it is possible to keep a filling rate high. Examples of the waveform of the meandering track include a sinusoidal waveform, a triangular wave, and the like, but are not limited thereto. The waveform of the meandering track is not limited to a periodic waveform, and may be a non-periodic waveform. The fourth embodiment other than the above description is the same as the first embodiment.

### 5. Fifth Embodiment

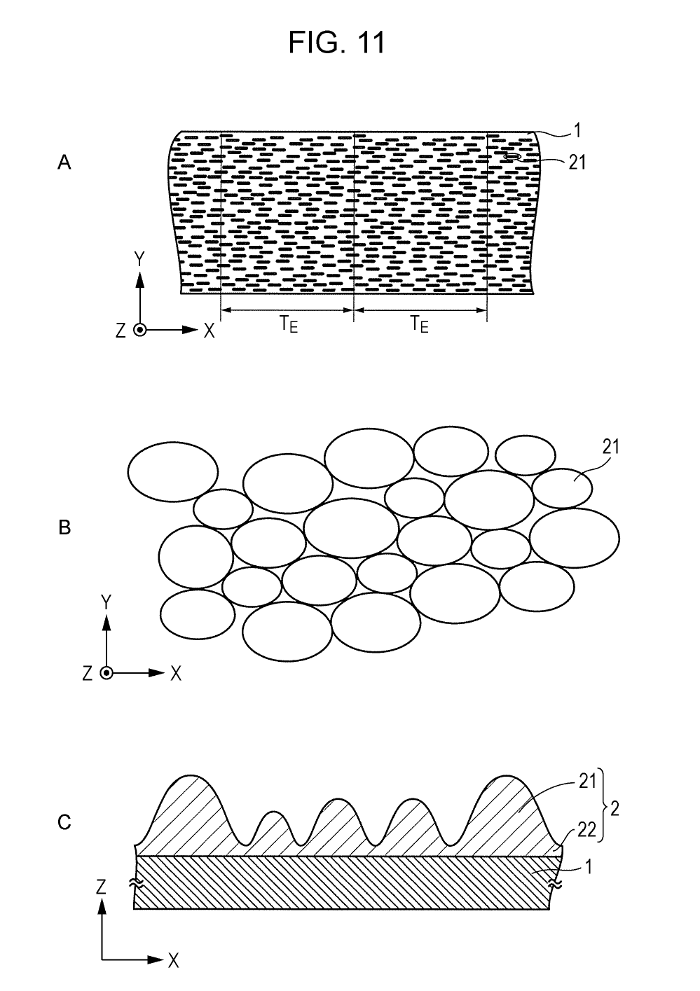

FIG. 11A is a cross-sectional view illustrating an example of a configuration of a laminate according to a fifth embodiment of the present technology. FIG. 11B is a top plan view illustrating a part of the laminate shown in FIG. 11A in an enlarged manner. FIG. 11C is a cross-sectional view of the laminate shown in FIG. 11B. The laminate according to the fourth embodiment is different from the laminate according to the first embodiment in that the plurality of structures 21 is two-dimensionally arranged in a random (irregular) manner. Further, the size and/or the height of the structure 21 may be randomly changed.

The fifth embodiment other than the above description is the same as the first embodiment.

### 6. Sixth Embodiment

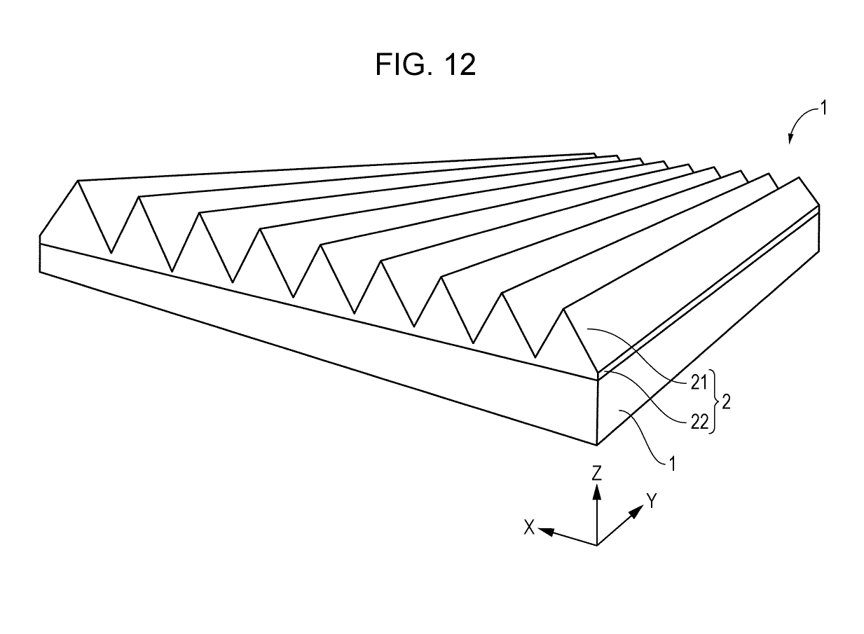

FIG. 12 is a perspective view illustrating an example of a configuration of a laminate according to a sixth embodiment of the present technology. As shown in FIG. 12, the laminate according to the sixth embodiment is different from the laminate according to the first embodiment in that there are provided the structures 21 having columnar shapes that extend in one direction on the substrate surface and the structures 21 are one-dimensionally arranged on the substrate 1.

Examples of a cross-sectional shape of the structure 21 include a triangular shape, a triangular shape of which the apex has a curvature R, a polygonal shape, a semicircular shape, a semi-elliptical shape, a parabolic shape, a toroidal shape, and the like, but are not particularly limited. Further, the structures 21 may extend in one direction in a meandering manner.

The sixth embodiment other than the above description is the same as the first embodiment.

### 7. Seventh Embodiment

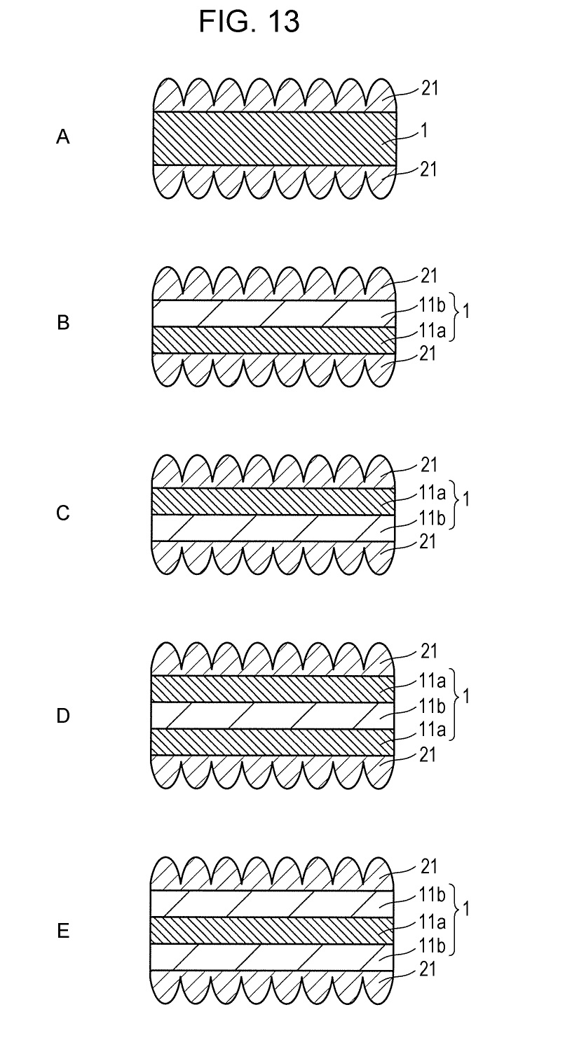

FIGS. 13A to 13E are cross-sectional views illustrating first to fifth examples of a substrate provided with a laminate according to a seventh embodiment of the present technology, respectively. The laminate according to the seventh embodiment is different from the laminate according to the first embodiment in that the plurality of structures 21 is two-dimensionally arranged on both principal surfaces of the substrate 1. Specifically, the laminates of the first to fifth examples are respectively the same as the first to fifth examples of the laminates according to the above-mentioned first embodiment except that the plurality of structures 21 is two-dimensionally arranged on both principal surfaces of the substrate 1 (refer to FIG. 2).

The laminate according to the seventh embodiment can be manufactured, for example, in the following manner. First, while the substrate 1 having a band shape is transported, both surfaces thereof are coated with the energy-ray-curable resin compositions. Next, while transfer surfaces of rotational masters (for example, roll masters or belt masters) disposed to be close to both surfaces of the substrate 1 are brought into tight contact with the energy-ray-curable resin compositions, the energy-ray-curable resin compositions are irradiated with the energy rays from the energy ray sources within the rotational masters. Thereby, the energy-ray-curable resin compositions are cured, thereby forming the structures 21. In addition, the two rotational masters may be disposed to be opposed with the substrate 1 interposed therebetween, and the shapes may be transferred onto the energy-ray-curable resin compositions while the substrate 1 is nipped between both masters.

The seventh embodiment other than the above description is the same as the first embodiment.

### 8. Eighth Embodiment

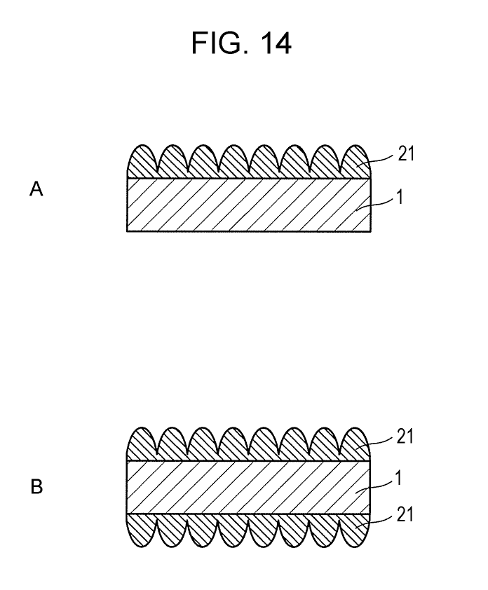

FIG. 14A is a cross-sectional view illustrating a first example of a substrate provided with a laminate according to an eighth embodiment of the present technology. FIG. 14B is a cross-sectional view illustrating a second example of a substrate provided with the laminate according to the eighth embodiment of the present technology. The laminate according to the eighth embodiment is different from the laminate according to the first or seventh embodiment in that the structures 21 are opaque to the energy rays. The opaque structures 21 can be formed, for example, by adding a material such as a pigment absorbing the energy rays to the energy-ray-curable resin composition.

The eighth embodiment other than the above description is the same as the first embodiment.

### 9. Ninth Embodiment

### Brief Overview of Ninth Embodiment

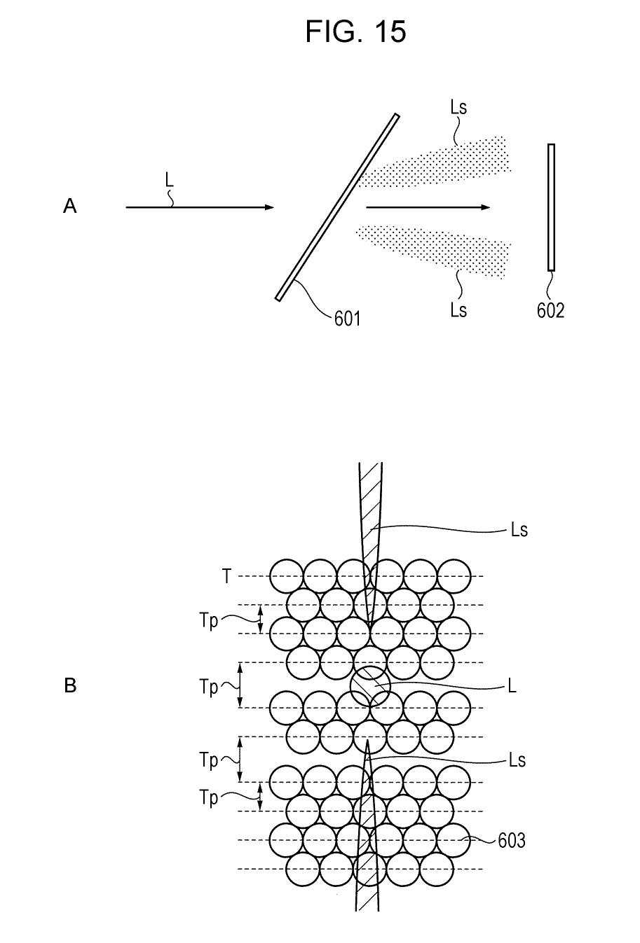

A ninth embodiment is contrived on the basis of a result of the following examination. Technicians of the present technology perform keen examination on an imaging optical system, as shown in FIG. 15A, in order to suppress occurrence of striped bright line noise. The imaging optical system includes: a semitransparent mirror (optical element) 601 of which an incident surface has sub-wavelength structures formed thereon; and an imaging device 602. As a result, the findings are as follows: when light L from a light source such as a bright spot is incident onto the incident surface of the semitransparent mirror 601, scattered light Ls is generated, the generated scattered light Ls reaches an imaging region (light receiving region) of the imaging device 602, and then the scattered light Ls, which is white, appears as bright line noise in an image photographed by the imaging device 602.

Therefore, the technicians of the present technology perform keen examination on the cause of occurrence of the scattered light Ls generated by the semitransparent mirror 601. As a result, finding is as follows: variation in the arrangement pitch Tp between the sub-wavelength structures is the cause of occurrence of the scattered light Ls. That is, when the master is manufactured using a photolithography technique, due to trouble in accuracy of the feed pitch at the exposure, as shown in FIG. 15B, the arrangement pitch Tp between the sub-wavelength structures 603 varies. As described above, when the arrangement pitch Tp varies, there are sections in which the arrangement pitch Tp is larger than an ideal arrangement pitch Tp. When such sections in which the arrangement pitch Tp is large are irradiated with the light L from the light source such as a bright spot, the scattered light Ls is generated.

Thus, in consideration of the cause of the occurrence of the above-mentioned bright line noise, the technicians of the present technology perform keen examination in order to suppress occurrence of the bright line noise. As a result, finding is as follows: by adjusting the shape or the like of the sub-wavelength structures 603 such that the component of the scattered light Ls reaching the imaging region is reduced as compared with the component of the scattered light Ls reaching the outside of the imaging region, it is possible to suppress the occurrence of the bright line noise.

### (Configuration of Imaging Apparatus)

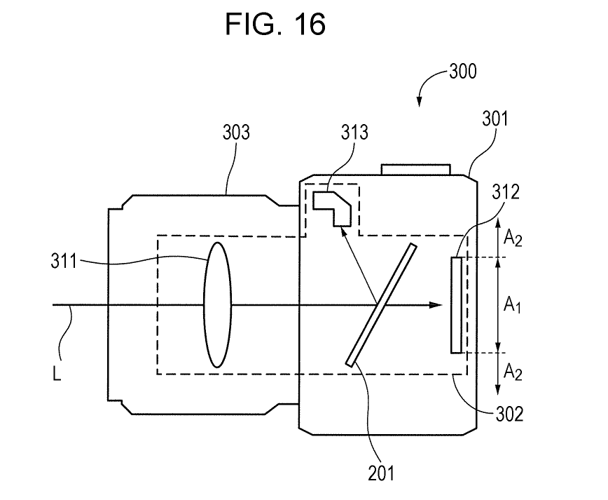

FIG. 16 is a schematic view illustrating an example of a configuration of an imaging apparatus according to a ninth embodiment of the present technology. As shown in FIG. 16, an imaging apparatus 300 according to the ninth embodiment is a so-called digital camera (digital still camera), and includes a casing 301, a lens barrel 303, and an imaging optical system 302 that is provided in the casing 301 and the lens barrel 303. The imaging optical system 302 includes a lens 311, an anti-reflection optical element 201, an imaging device 312, and an auto focus sensor 313. The casing 301 and the lens barrel 303 may be configured to be detachable.

The lens 311 condenses light L from a subject toward the imaging device 312. The anti-reflection optical element 201 reflects a part of the light L condensed by the lens 311 toward the auto focus sensor 313, while transmitting the remaining of the light L toward the imaging device 312. The imaging device 312 has a rectangular imaging region A₁ that receives the light transmitted through the anti-reflection optical element 201, and converts the light, which is received in the imaging region A₁, into an electric signal, and outputs the signal to a signal processing circuit. The auto focus sensor 313 receives the light which is reflected by the anti-reflection optical element 201, converts the received light into an electric signal, and outputs the signal to a control circuit.

### (Anti-Reflection Optical Element)

Hereinafter, a configuration of the anti-reflection optical element 201 according to the ninth embodiment will be described in detail.

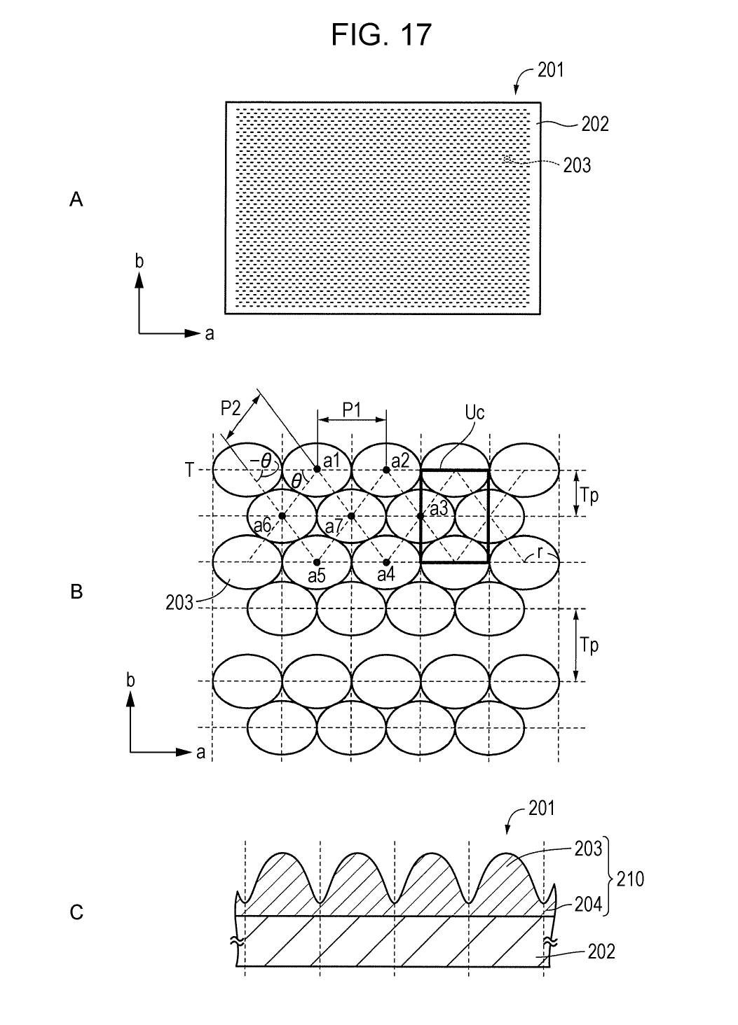

FIG. 17A is a top plan view illustrating an example of a configuration of the anti-reflection optical element according to the ninth embodiment of the present technology. FIG. 17B is a top plan view illustrating a part of the anti-reflection optical element shown in FIG. 17A in an enlarged manner. FIG. 17C is a cross-sectional view of the track T of FIG. 17B.

The anti-reflection optical element 201 includes: a semitransparent mirror (element main body) 202 that has an incident surface and an emission surface; and a plurality of structures 203 that is formed on the incident surface of the semitransparent mirror 202. The structures 203 and the semitransparent mirror 202 are separately or integrally formed. When the structures 203 and the semitransparent mirror 202 are separately formed, a bottom layer 204 is further provided between the structures 203 and the semitransparent mirror 202, as necessary. The bottom layer 204 is a layer that is formed integrally with the structures 203 on the bottom sides of the structures 203, and is formed by curing the energy-ray-curable resin composition in a similar manner to the structures 203. The shaped layer 210 having a concave-convex shape is formed of the structures 203 on the incident surface of the semitransparent mirror 202. The shaped layer 210 may further include the bottom layer 204, as necessary.

Hereinafter, the semitransparent mirror 202 and the structures 203 provided in the anti-reflection optical element 201 will be described in order of precedence.

### (Semitransparent Mirror)

The semitransparent mirror 202 is opaque to, for example, energy rays (for example, ultraviolet rays or the like) for curing the energy-ray-curable resin composition that constitutes the structures 203. The semitransparent mirror 202 is a mirror that transmits a part of the incident light and reflects the remaining thereof. Examples of the shape of the semitransparent mirror 202 include a sheet shape and a plate shape, but are not particularly limited to the shapes. Here, the sheet is defined to include a film.

### (Structure)

The structures 203 are so-called sub-wavelength structures, have, for example, shapes that are convex toward the incident surface of the semitransparent mirror 202, and are two-dimensionally arranged on the incident surface of the semitransparent mirror 202. It is preferable that the structures 203 be two-dimensionally arranged on a periodic basis with a narrow arrangement pitch equal to or less than a wavelength band of light as a target of reduction in reflection.

The plurality of structures 203 has such a form of arrangement as forms the plurality of tracks T on the surface of the semitransparent mirror 202. Due to trouble at exposure in a master creation process, the track pitch Tp between the tracks T varies in accordance with the gap between the tracks, as shown in FIG. 17B. In the present technology, the track is a portion in which the structures 203 are arranged in a line. As the shape of the track T, it may be possible to use a linear shape, a circular arc shape, and the like, and the tracks having such a shape may be arranged in a meandering manner (an S-shape). As described above, by arranging the tracks T in a meandering manner, it is possible to suppress occurrence of unevenness viewed from the outside.

When the tracks T are arranged in a meandering manner, it is preferable that the meanders of the respective tracks T on the semitransparent mirror 202 be synchronized. That is, it is preferable that the meanders be synchronized meanders. As described above, by synchronizing the meanders, a unit lattice shape such as a hexagonal lattice or a quasi-hexagonal lattice is maintained, and thus it is possible to keep a filling rate high. Examples of the waveform of the meandering track T include a sinusoidal waveform, a triangular wave, and the like. The waveform of the meandering track T is not limited to a periodic waveform, and may be a non-periodic waveform. An amplitude of the meander of the meandering track T is selected as, for example, about ±10 μm.

The surface of the semitransparent mirror 202 has one or more sections in which scattered light is generated by scattering the light incident from the light source such as a bright spot. In this section, for example, the track pitch Tp varies to be greater than a reference track pitch Tp. Since such a section occurs due to trouble at the exposure in the master creation process, it is difficult to suppress occurrence of the section to the extent that occurrence of the bright line noise is eliminated or negligible.

For example, the structures 203 are arranged to be shifted by a half pitch between two adjacent tracks T. Specifically, in the two adjacent tracks T, between the center positions (positions which are shifted by a half pitch) of the structures 203 arranged on one track (for example, T1), the structures 203 on the other track (for example, T2) are placed. As a result, as shown in FIG. 17B, in the three adjacent tracks (T1 to T3), the structures 203 are arranged in a hexagonal lattice pattern or a quasi-hexagonal lattice pattern in which the centers of the structures 203 are positioned at the respective points of a1 to a7. Hereinafter, the extending direction of the line of the structures (the extending direction of the track) is referred to as a track direction (line direction) a, and the direction perpendicular to the track direction a in the surface of the semitransparent mirror 202 is referred to as a track array direction (line array direction) b.

Here, the hexagonal lattice means a regular hexagonal lattice. In contrast to the regular hexagonal lattice, the quasi-hexagonal lattice means a distorted regular hexagonal lattice. For example, when the structures 203 are linearly arranged, the quasi-hexagonal lattice means a hexagonal lattice having a shape in which the regular hexagonal lattice is distorted to be stretched in the linear array direction (track direction). When the structures 203 are arranged in an S-shape, the quasi-hexagonal lattice means a hexagonal lattice having a shape in which the regular hexagonal lattice is distorted by the S-shaped array of the structures 203, or a hexagonal lattice having a shape in which the regular hexagonal lattice is distorted to be stretched in the linear array direction (track direction) and is distorted by the S-shaped array of the structures 203.

When the structures 203 are arranged to form a quasi-hexagonal lattice pattern, as shown in FIG. 17B, it is preferable that the arrangement pitch P1 (for example, the distance between a1 and a2) between the structures 203 in the same track be longer than the arrangement pitch between the structures 203 between the two adjacent tracks, that is, the arrangement pitch P2 (for example, the distance between a1 and a7, or the distance between a2 and a7) between the structures 203 in the direction of ±θ with respect to the extending direction of the track. By arranging the structures 203 in such a manner, it is possible to further improve the filling concentration of the structures 203.

Examples of the specific shape of the structure 203 include a conical shape, a columnar shape, a needle shape, a hemispherical shape, a semi-elliptical shape, a polygonal shape, and the like, but are not limited to the shapes, and may employ other shapes. Examples of the conical shape include a conical shape of which the apex is pointed, a conical shape of which the apex is planar, and a conical shape of which the apex has a curved surface having a convex or concave shape, but are not limited to those shapes. Examples of the conical shape, of which the apex has a curved surface having a convex shape, include 2nd-order curved shapes such as a parabolic shape. Further, the conical surface of the conical shape may be curved to be concave or convex. The roll master may be manufactured using the above-mentioned roll master exposure device (refer to FIG. 5). In this case, it is preferable that an elliptical cone shape, of which the apex has a curved surface having a convex shape, or an elliptical frustum shape, of which the apex is planar, be employed as the shape of the structure 203, and a direction of the major axis of the ellipse forming the bottom thereof be set to coincide with the extending direction of the track T.

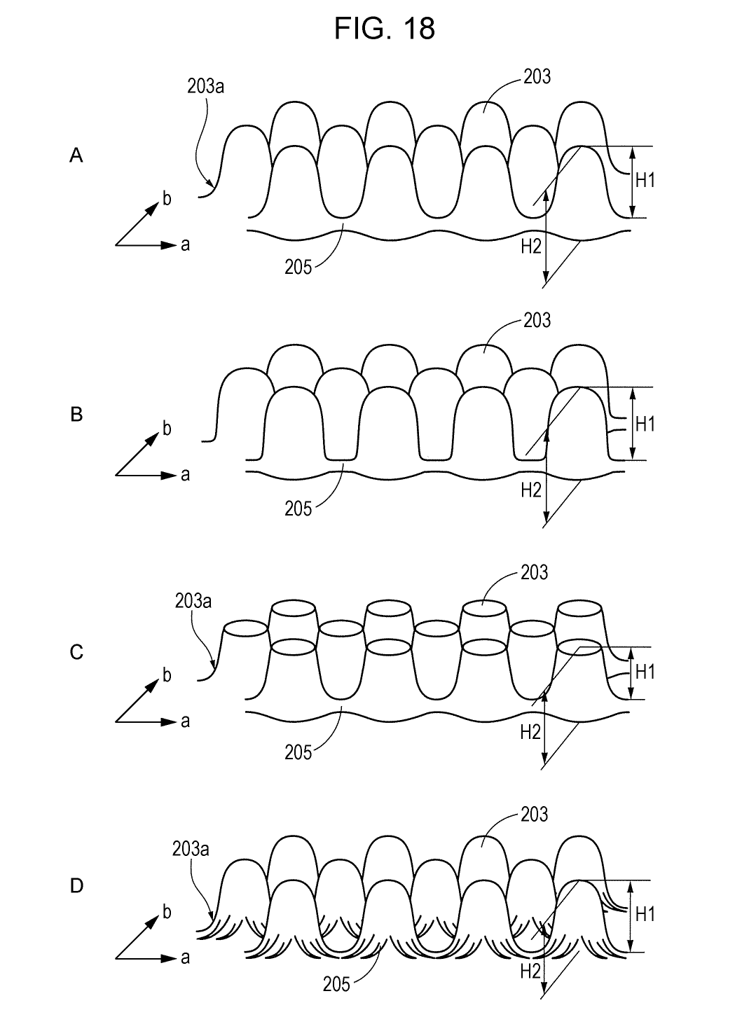

From the perspective of improvement of the reflection property, as shown in FIG. 18A, it is preferable to use a conical shape of which the slope is gentle at the apex and the slope gradually becomes steep from the center to the bottom. Further, from the perspective of improvement of the reflection property and transmission property, it is preferable to use a conical shape of which the slope at the center is steeper than that at the bottom and the apex, as shown in FIG. 18B, or a conical shape of which the apex is planar as shown in FIG. 18C. When the structures 203 have elliptical cone shapes or elliptical frustum shapes, it is preferable that the direction of the major axis of the bottom is set in parallel with the extending direction of the track.

It is preferable that, as shown in FIGS. 18A and 18C, the structure 203 have a curved portion 203a, in which the height smoothly decreases from the apex toward the lower portion, at the peripheral portion of the bottom. The reason is that, in a manufacturing process of the anti-reflection optical element 201, the anti-reflection optical element 201 can be easily exfoliated from the master or the like. It should be noted that the curved portion 203a may be provided on a part of the peripheral portion of the structure 203. However, from the perspective of improvement of the exfoliation property, it is preferable that the curved portion be provided on the entire peripheral portion of the structure 203.

It is preferable that protrusion portions 205 be provided on a part or the entirety of the periphery of the structure 203. The reason is that, in such a manner, it is possible to suppress the reflectance even when the filling rate of the structures 203 is low. From the perspective of convenience of shape forming, it is preferable that the protrusion portions 205 be provided between the structures 203 neighboring each other as shown in FIGS. 18A to 18C. Further, as shown in FIG. 18D, the elongated protrusion portions 205 may be provided on a part or the entirety of the periphery of the structure 203. For example, the elongated protrusion portion 205 can be configured to extend from the apex toward the lower portion of the structure 203, but is not limited to this. Examples of the shape of the protrusion portion 205 include a cross-sectional triangular shape, a cross-sectional rectangular shape, and the like, but are not particularly limited to the shapes, and the shape may be selected in consideration of convenience of shape forming. Further, by roughening a part or the entirety of the surface around the structure 203, a fine concave-convex shape may be formed. Specifically, for example, the surface between the structures 203 neighboring each other may be roughened, and formed in a fine concave-convex shape. Further, a minute hole may be formed on the surface of the structure 203, for example, the apex.

It should be noted that, in FIGS. 17A to 18D, each of the structures 203 has the same size, shape, and height, but the shapes of the structures 203 are not limited thereto, and structures 203 having two or more sizes, shapes, and heights may be formed on the substrate surface.

For example, the structures 203 are two-dimensionally arranged on a regular (periodic) basis with a narrow arrangement pitch equal to or less than a wavelength band of light as a target of reduction in reflection. By two-dimensionally arranging the plurality of structures 203 in such a manner, a two-dimensional wave front may be formed on the surface of the semitransparent mirror 202. Here, the arrangement pitch means the arrangement pitch P1 and the arrangement pitch P2. The wavelength band of light as a target of reduction in reflection is, for example, a wavelength band of ultraviolet light, a wavelength band of visible light, or a wavelength band of infrared light. Here, the wavelength band of ultraviolet light is defined as a wavelength band of 10 nm to 360 nm, the wavelength band of visible light is defined as a wavelength band of 360 nm to 830 nm, and the wavelength band of infrared light is defined as a wavelength band of 830 nm to 1 mm. Specifically, it is preferable that the arrangement pitch be equal to or greater than 175 nm and equal to or less than 350 nm. When the arrangement pitch is less than 175 nm, there is a tendency for it to be difficult to produce the structures 203. In contrast, when the arrangement pitch is greater than 350 nm, there is a tendency for diffraction of the visible light to occur.

It is preferable that the height H1 of the structure 203 in the extending direction of the track be less than the height H2 of the structure 203 in the line direction. That is, it is preferable that the heights H1 and H2 of the structure 203 satisfy a relationship of H1<H2. When the structures 203 are arranged so as to satisfy a relationship of H1≧H2, it is necessary to increase the arrangement pitch P1 in the extending direction of the track. Hence, the filling rate of the structures 203 in the extending direction of the track is lowered. When the filling rate is lowered as described above, this causes deterioration in the reflection property.

The height of the structure 203 is not particularly limited, and may be appropriately set in accordance with the wavelength region of the light to be transmitted. For example, the height is set in a range of 236 nm or more and 450 nm or less, and preferably in a range of 415 nm or more and 421 nm or less.

The aspect ratio (height/arrangement pitch) of the structures 203 is set preferably in a range of 0.81 or more and 1.46 or less, and more preferably in a range of 0.94 or more and 1.28 or less. The reason is that, if less than 0.81, the reflection property and the transmission property tend to deteriorate, and if greater than 1.46, the exfoliation property deteriorates at the time of forming the structures 203, and replication of a replica thereof tends to be not perfect. Further, from the perspective of further improvement of the reflection property, it is preferable that the aspect ratio of the structure 203 be set in a range of 0.94 or more and 1.46 or less. Furthermore, from the perspective of further improvement of the transmission property, it is preferable that the aspect ratio of the structure 203 be set in a range of 0.81 or more and 1.28 or less.

Here, the height distribution means that the structures 203 having two or more heights are provided on the surface of the semitransparent mirror 202. For example, the structures 203 having a reference height and the structures 203 having a height different from the reference height of the structures 203 may be provided on the surface of the semitransparent mirror 202. In this case, for example, the structures 203 having the height different from the reference are provided periodically or non-periodically (randomly) on the surface of the semitransparent mirror 202. Examples of the direction of the periods include the extending direction of the track, the line direction, and the like.

It should be noted that the aspect ratio in the present technology is defined by the following Expression (1).

Aspect Ratio=H/Pm (1)

Here, H is the height of the structures, and Pm is the average arrangement pitch (average period).

Here, the average arrangement pitch Pm is defined by the following Expression (2).

Average arrangement Pitch Pm=(P1+P2+P2)/3 (2)

Here, P1 is the arrangement pitch (track extending direction period) in the extending direction of the track, and P2 is the arrangement pitch (θ direction period) in the direction of ±θ with respect to the extending direction of the track (here, θ=60°−δ, where δ is preferably 0°<δ≦11°, and more preferably 3°≦δ≦6°).

Further, the height H of the structure 203 is set as a height of the structure 203 in the line direction. The height of the structure 203 in the track extending direction (X direction) is less than the height thereof in the line direction (Y direction). Further, the height of the structure 203 in the portion other than the track extending direction is substantially equal to the height thereof in the line direction. Hence, the height of the sub-wavelength structure is typified by the height thereof in the line direction. Here, when the structure 203 is a concave portion, the height H of the structure in the Expression (1) is set as a depth H of the structure.

Assuming that the arrangement pitch between the structures 203 on the same track is P1 and the arrangement pitch between the structures 203 between the two adjacent tracks is P2, it is preferable that a ratio P1/P2 satisfy a relationship of 1.00≦P1/P2≦1.1 or 1.00<P1/P2≦1.1. By setting the ratio in such a numerical value range, it is possible to improve the filling rate of the structures 203 having elliptical cones or elliptical frustum shapes. Therefore, it is possible to improve the anti-reflection property.

The filling rate of the structures 203 on the substrate surface is in a range of 65% or more, preferably in a range of 73% or more, and more preferably in a range of 86% or more, assuming that 100% is the upper limit. By setting the filling rate in such a range, it is possible to improve the anti-reflection property. In order to improve the filling rate, it is preferable that the lower portions of the adjacent structures 203 be bonded to or overlap with one another or the structures 203 be distorted through adjustment or the like of the ellipticities of the bottoms of the structures.

Here, the filling rate of the structures 203 (average filling rate) is a value calculated in the following manner.

First, the surface of the anti-reflection optical element 201 is photographed in top view using a scanning electron microscope (SEM). Next, a unit lattice Uc is randomly picked out from the photographed SEM picture, and the arrangement pitch P1 and the track pitch Tp of the unit lattice Uc are measured (refer to FIG. 17B). Further, an area S of the bottom of the structure 203 positioned at the center of the unit lattice Uc is measured through image processing. Next, the filling rate is calculated from the following Expression (3) using the measured arrangement pitch P1, track pitch Tp, and area S of the bottom.

Filling Rate=(S(hex.)/S(unit))×100 (3)

Unit Lattice Area: S(unit)=P1×2Tp

Area of Bottom of Structures within Unit Lattice: S(hex.)=2S

The process of the above-mentioned filling rate calculation is performed on 10 unit lattices which are randomly picked out from the photographed SEM picture. Then, an average rate of the filling rate is calculated by simply averaging (calculating an arithmetic mean of) the measured values, and the average rate is used as the filling rate of the structures 203 on the substrate surface.

When the structures 203 overlap or the sub-structures such as the protrusion portions 205 are present between the structures 203, the filling rate can be calculated in a method of determining the area ratio by setting a value corresponding to 5% of the height of the structure 203 as a threshold value.

It is preferable that the lower portions of the structures 203 be connected to overlap with one another. Specifically, it is preferable that some or all of the lower portions of the adjacent structures 203 overlap with one another, and it is preferable that the lower portions overlap with one another in the track direction, the θ direction, or both of these directions. By overlapping the lower portions of the structures 203 with one another in such a manner, it is possible to improve the filling rate of the structures 203. It is preferable that the structures overlap with one another at portions corresponding to 1/4 of the maximum value of the wavelength band of the light under a usage environment by an optical path length in which the refractive index is considered. The reason is that, in such a manner, it is possible to obtain an excellent anti-reflection property.

A ratio of a diameter 2r to the arrangement pitch P1 ((2r/P1)×100) is equal to or greater than 85%, preferably equal to or greater than 90%, and more preferably equal to or greater than 95%. By setting the ratio in such a range, it is possible to improve the filling rate of the structures 203, and it is possible to improve the anti-reflection property. As the ratio ((2r/P1)×100) increases, the overlapping portions of the structures 203 excessively increase, and then the anti-reflection property tends to be reduced. Consequently, it is preferable that the upper limit of the ratio ((2r/P1)×100) be set such that the structures are bonded to one another at portions corresponding to ¼ of the maximum value of the wavelength band of the light under a usage environment by an optical path length in which the refractive index is considered. Here, the arrangement pitch P1 is an arrangement pitch between the structures 203 in the track direction as shown in FIG. 17B, and the diameter 2r is a diameter of the structure bottom in the track direction as shown in FIG. 17B. It should be noted that the diameter 2r is a diameter when the structure bottom is circular and the diameter 2r is a long diameter when the structure bottom is elliptical.

### (Imaging Optical System)

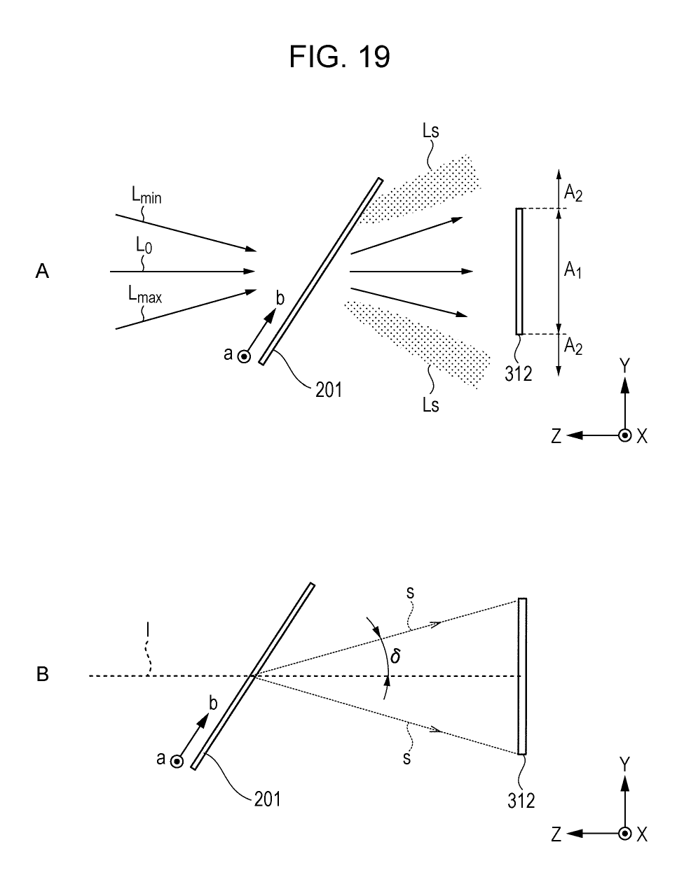

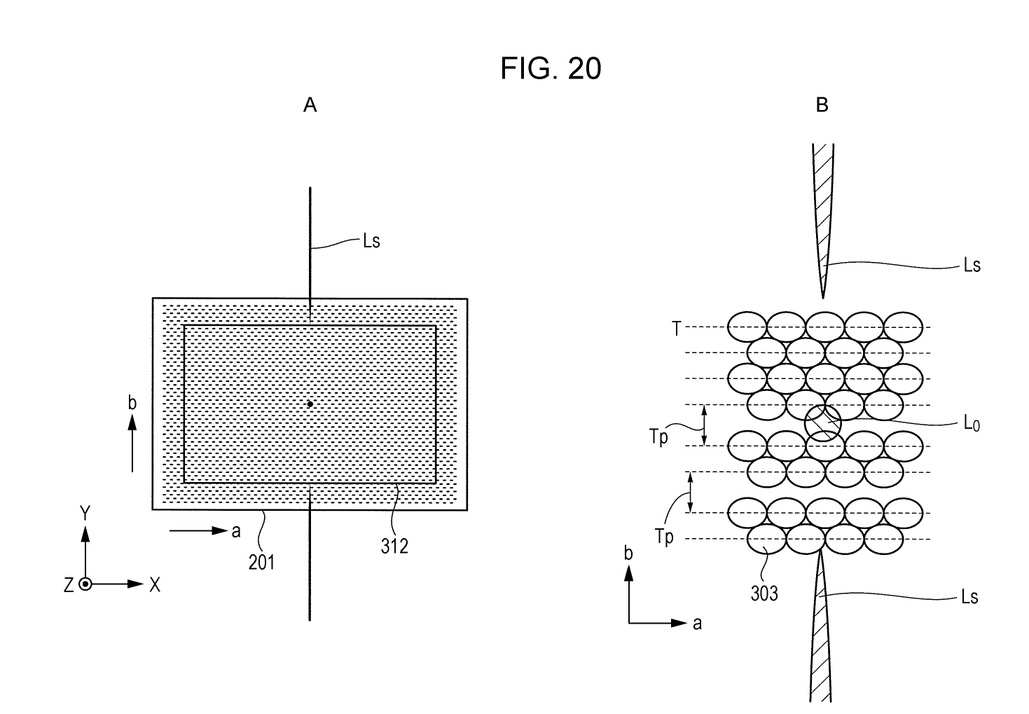

FIG. 19A is a schematic view illustrating a part of the imaging optical system shown in FIG. 16 in an enlarged manner. FIG. 20A is a schematic view of the imaging optical system shown in FIG. 19A as viewed from a side on which the ray L₀ is incident. FIG. 20B is an enlarged view illustrating a part of the anti-reflection optical element provided in the imaging optical system shown in FIG. 20A in an enlarged manner. In FIG. 19A, the ray L₀ indicates a principal ray from a subject, the ray Lₘᵢₙ indicates a ray of which the incident angle to the anti-reflection optical element 201 is at a minimum, and the ray Lₘₐₓ indicates a ray of which the incident angle to the anti-reflection optical element 201 is at a maximum. Further, the direction parallel to the long sides of the imaging region A₁ having a rectangular shape is defined as an X axis direction, and the direction parallel to the short sides is defined as a Y axis direction. Further, a direction vertical to the imaging surface of the imaging device 312 is defined as a Z axis direction.

The incident surface of the anti-reflection optical element 201 has one or more sections in which the scattered light Ls is generated by scattering the incident light. It is preferable that a sum of components of the scattered light Ls reaching the imaging region A₁ be less than a sum of components reaching the region A₂ outside the imaging region. Thereby, it is possible to suppress occurrence of the bright line noise in a captured image.

From the perspective of suppressing occurrence of the bright line noise, it is preferable that a maximum value of intensity distribution of the scattered light Ls in the imaging region A₁ be less than a maximum value of intensity distribution of the scattered light Ls in the region A₂ outside the imaging region A₁.

As shown in FIG. 19A, the scattered light Ls rarely diffuses in the X axis direction, and reaches the planar surface including the imaging surface of the imaging device 312. Consequently, the intensity distribution of the scattered light Ls changes mostly only in the Y axis direction. That is, the intensity distribution of the scattered light Ls is different in the X axis direction and in the Y axis direction, and is anisotropic. In the present description, the intensity distribution means intensity distribution in the Y axis direction.

A ratio (Ib/Ia) of the total intensity Ib of the scattered light Ls, which is scattered by the surface of the anti-reflection optical element 201, to the total intensity Ia of the incident light, which is incident on the surface of the anti-reflection optical element 201, is preferably in a range of less than 1/500, more preferably in a range of 1/5000 or less, and still more preferably in a range of 1/10⁵ or less. By setting the ratio (Ib/Ia) to less than 1/500, it is possible to suppress occurrence of the striped bright line noise.

FIG. 19B is a schematic view illustrating definition of a numerical aperture NA of the imaging optical system shown in FIG. 19A. Here, as shown in FIG. 19B, the optical axis of the anti-reflection optical element 201 and the imaging device 312 is defined as an optical axis l. The direction of the scattered light Ls, which is scattered by the surface of the anti-reflection optical element 201, is defined as a scattering direction s. The angle formed between the direction of the optical axis l and the direction of the scattered light Ls is defined as an angle δ. The numerical aperture NA is defined as an n sin δ (n: a refractive index of a medium (for example, air) between the anti-reflection optical element 201 and the imaging device 312).

The intensity distribution of the scattered light Ls, which is anisotropic, varies depending on the numerical aperture NA. In this case, it is preferable that the intensity per unit solid angle of the intensity distribution of the scattered light in a range of the numerical aperture NA>0.8 be smaller than that in a range of the numerical aperture NA≦0.8. The reason is that it is possible to reduce a light amount of the scattered light Ls reaching the imaging region A₁ of the imaging device 312.

As shown in FIG. 20A, the imaging region A₁ has, for example, a rectangular shape which has two groups of sides facing each other, that is, one group of short sides and one group of long sides. In this case, the track direction a of the structures 203 is in parallel with an extending direction (X axis direction) of the long sides which is one group of sides among the two groups of sides. Thereby, the scattered light Ls can be scattered to be separated from the optical axis l, toward the extending direction (Y axis direction) of the short sides of the imaging region A₁ with narrow widths. Therefore, it is possible to reduce the light amount of the scattered light Ls reaching the imaging region A₁ of the imaging device 312.

As described above, when the track direction a of the structures 203 is in parallel with the extending direction (X axis direction) of the long sides of the imaging region A₁, as shown in FIG. 20B, (a) it is preferable that the structure 203 be formed in a conical shape that has the bottom having an elliptical shape with a major axis and a minor axis, and (b) it is preferable that the direction of the major axis of the bottom coincide with the track direction a. (a) By forming the structure 203 in a conical shape that has the bottom having an elliptical shape with the major axis and the minor axis, it is possible to narrow the track pitch Tp, compared with the case of forming the bottom of the structure 203 in a circular shape or the like. Thereby, compared with the case of forming the bottom of the structure 203 in a circular shape or the like, the ray L₀ from the light source such as a bright spot can be scattered to be further separated from the optical axis l. (b) By making the direction of the major axis of the bottom of the structure 203 coincide with the track direction a, the ray L₀ from the light source such as a bright spot can be scattered toward the extending direction (Y axis direction) of the short sides of the imaging region A₁ with narrow widths. Accordingly, with combination of the above-mentioned configurations (a) and (b), the ray L₀ from the light source such as a bright spot can be scattered to be separated from the optical axis l, toward the Y axis direction, compared with the case of forming the bottom of the structure 203 in a circular shape. Consequently, it is possible to further reduce the light amount of the scattered light Ls reaching the imaging region A₁ of the imaging device 312.

### [Configuration of Roll Master]

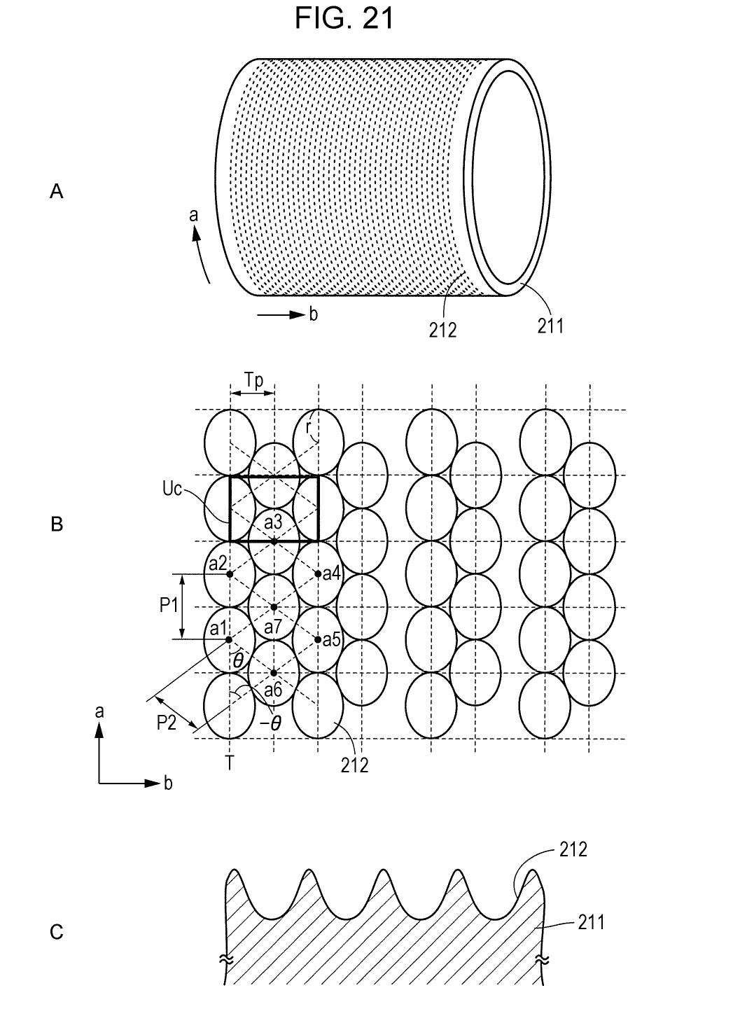

FIG. 21A is a perspective view illustrating an example of a configuration of the roll master. FIG. 21B is a top plan view illustrating a part of the roll master shown in FIG. 21A in an enlarged manner. FIG. 21C is a cross-sectional view of the track T of FIG. 21B. A roll master 211 is a master for forming the plurality of structures 203 on the above-mentioned substrate surface. The roll master 211 has, for example, a circular columnar shape or a cylindrical shape. The circular columnar surface or the cylindrical surface is formed as a shaping surface (rotation surface) for forming the plurality of structures 203 on the substrate surface. A plurality of structures 212 is two-dimensionally arranged on the shaping surface. The structure 212 has, for example, a shape that is concave toward the shaping surface. As a material of the roll master 211, for example, it is possible to use glass, but the material is not particularly limited to this.

The plurality of structures 212 arranged on the shaping surface of the roll master 211 and the plurality of structures 203 arranged on the surface of the above-mentioned semitransparent mirror 202 have a reversed-concave-convex relationship. That is, the shapes, the array, the arrangement pitch, and the like of the structures 212 of the roll master 211 are the same as those of the structures 203 of the semitransparent mirror 202.

While the shaping surface of the roll master 211 is rotated in tight contact with the energy-ray-curable resin composition with which the surface of the semitransparent mirror (element main body) 202 is coated, the energy-ray-curable resin composition is irradiated with energy rays, which are radiated from the energy ray source provided inside the shaping surface, through the shaping surface, thereby curing the energy-ray-curable resin composition. In such a manner, it is possible to obtain the anti-reflection optical element 201 provided on the surface of the plurality of structures 203.

The roll master 211 is configured to transmit the energy rays. The shaping surface, on which the plurality of structures (for example, the sub-wavelength structures) 212 are provided, has a section in which the scattered light is generated by scattering the incident light. It is preferable that the intensity distribution of the scattered light be anisotropic.

### [Configuration of Exposure Device]

A configuration of the roll master exposure device for manufacturing the roll master shown in FIG. 21A is the same as that of the above-mentioned first embodiment.

### [Manufacturing Method of Anti-Reflection Optical Element]

A manufacturing method of the anti-reflection optical element 201 according to the ninth embodiment of the present technology is the same as that of the above-mentioned first embodiment except that the plurality of structures 203 are formed on the surface of the semitransparent mirror 202.

It should be noted that the above-mentioned variation in the track pitch Tp is caused by trouble of irradiation of the laser light in the exposure process. It is difficult to reduce the variation in the track pitch Tp to the extent that occurrence of the bright line noise is eliminated or negligible, through the adjustment of the exposure condition. For this reason, in the embodiment, by adopting the above-mentioned technique, occurrence of the bright line noise is suppressed.

### 10. Tenth Embodiment

### Configuration of Anti-Reflection Optical Element

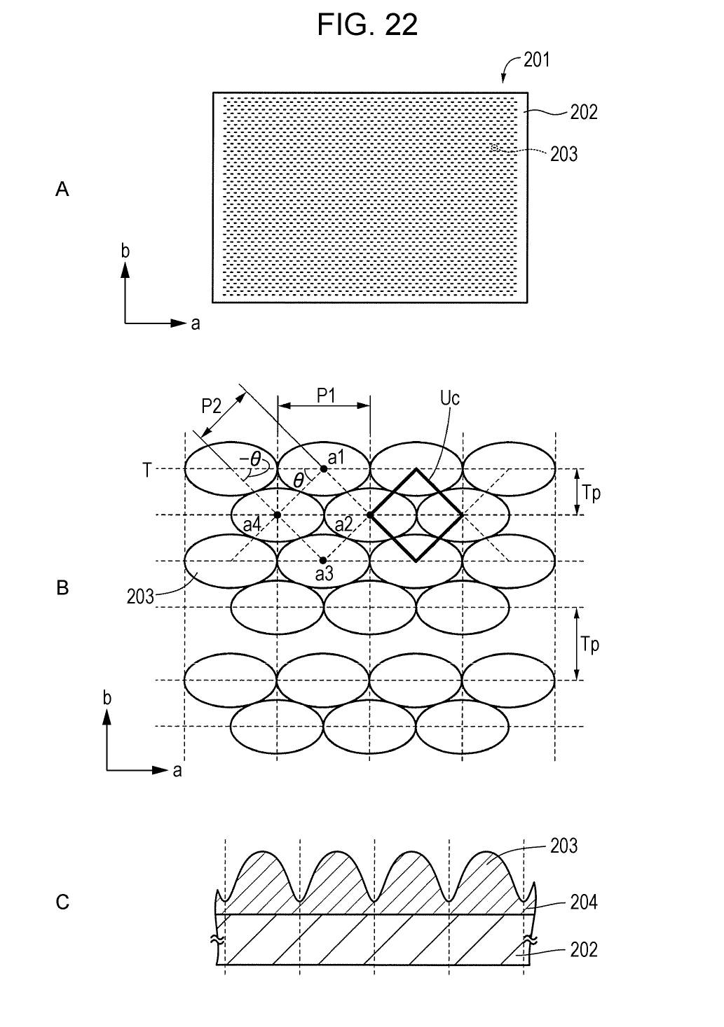

FIG. 22A is a top plan view illustrating an example of a configuration of an anti-reflection optical element according to a tenth embodiment of the present technology. FIG. 22B is a top plan view illustrating a part of the anti-reflection optical element shown in FIG. 22A in an enlarged manner. FIG. 22C is a cross-sectional view of the track T of FIG. 22B.

The anti-reflection optical element 201 according to the tenth embodiment is different from that of the ninth embodiment in that the plurality of structures 203 form a tetragonal lattice pattern or a quasi-tetragonal lattice pattern among the three adjacent tracks T.

Here, the tetragonal lattice means a regular tetragonal lattice. In contrast to the regular tetragonal lattice, the quasi-tetragonal lattice means a distorted regular tetragonal lattice. For example, when the structures 203 are linearly arranged, the quasi-tetragonal lattice means a tetragonal lattice having a shape in which the regular tetragonal lattice is distorted to be stretched in the linear array direction (track direction). When the structures 203 are arranged in an S-shape, the quasi-tetragonal lattice means a tetragonal lattice having a shape in which the regular tetragonal lattice is distorted by the S-shaped array of the structures 203. Alternatively, it means a tetragonal lattice having a shape in which the regular tetragonal lattice is distorted to be stretched in the linear array direction (track direction) and is distorted by the S-shaped array of the structures 203.

It is preferable that the arrangement pitch P1 between the structures 203 on the same track be longer than the arrangement pitch P2 between the structures 203 between the two adjacent tracks. Further, assuming that the arrangement pitch between the structures 203 on the same track is P1 and the arrangement pitch between the structures 203 between the two adjacent tracks is P2, it is preferable that P1/P2 satisfy a relationship of 1.4<P1/P2≦1.5. By setting the ratio in such a numerical value range, it is possible to improve the filling rate of the structures 203 having elliptical cones or elliptical frustum shapes. Therefore, it is possible to improve the anti-reflection property. Further, it is preferable that the height or the depth of the structure 203 in a direction of 45 degrees or a direction of about 45 degrees with respect to the track be less than the height or the depth of the structure 203 in the extending direction of the track.

It is preferable that the height H2 of the structure 203 in the array direction (θ direction) oblique to the extending direction of the track be less than the height H1 of the structure 203 in the extending direction of the track. That is, it is preferable that the heights H1 and H2 of the structure 203 satisfy a relationship of H1>H2.

When the structures 203 form a tetragonal lattice or a quasi-tetragonal lattice pattern, it is preferable that the ellipticity e of the structure bottom be in a range of 140%≦e≦180%. The reason is that, by setting the ellipticity in such a range, it is possible to improve the filling rate of the structures 203, and it is possible to obtain an excellent anti-reflection property.

The filling rate of the structures 203 on the substrate surface is in a range of 65% or more, preferably in a range of 73% or more, and more preferably in a range of 86% or more, assuming that 100% is the upper limit. By setting the filling rate in such a range, it is possible to improve the anti-reflection property.

Here, the filling rate of the structures 203 (average filling rate) is a value calculated in the following manner.

First, the surface of the anti-reflection optical element 201 is photographed in top view using a scanning electron microscope (SEM). Next, a unit lattice Uc is randomly picked out from the photographed SEM picture, and the arrangement pitch P1 and the track pitch Tp of the unit lattice Uc are measured (refer to FIG. 22B). Further, an area S of the bottom of any of the four structures 203 included in the unit lattice Uc is measured through image processing. Next, the filling rate is calculated from the following Expression (4) using the measured arrangement pitch P1, track pitch Tp, and area S of the bottom.

Filling Rate=(S(tetra)/S(unit))×100 (4)

Unit Lattice Area: S(unit)=2×((P1×Tp)×(1/2))=P1×Tp

Area of Bottom of Structures within Unit Lattice: S(tetra)=S

The process of the above-mentioned filling rate calculation is performed on 10 unit lattices which are randomly picked out from the photographed SEM picture. Then, an average rate of the filling rate is calculated by simply averaging (calculating an arithmetic mean of) the measured values, and the average rate is used as the filling rate of the structures 203 on the substrate surface.

A ratio of a diameter 2r to the arrangement pitch P1 ((2r/P1)×100) is equal to or greater than 64%, preferably equal to or greater than 69%, and more preferably equal to or greater than 73%. By setting the ratio in such a range, it is possible to improve the filling rate of the structures 203, and it is possible to improve the anti-reflection property. Here, the arrangement pitch P1 is an arrangement pitch between the structures 203 in the track direction, and the diameter 2r is a diameter of the structure bottom in the track direction. It should be noted that the diameter 2r is a diameter when the structure bottom is circular and the diameter 2r is a long diameter when the structure bottom is elliptical.

The tenth embodiment other than the above description is the same as the ninth embodiment.

### 11. Eleventh Embodiment

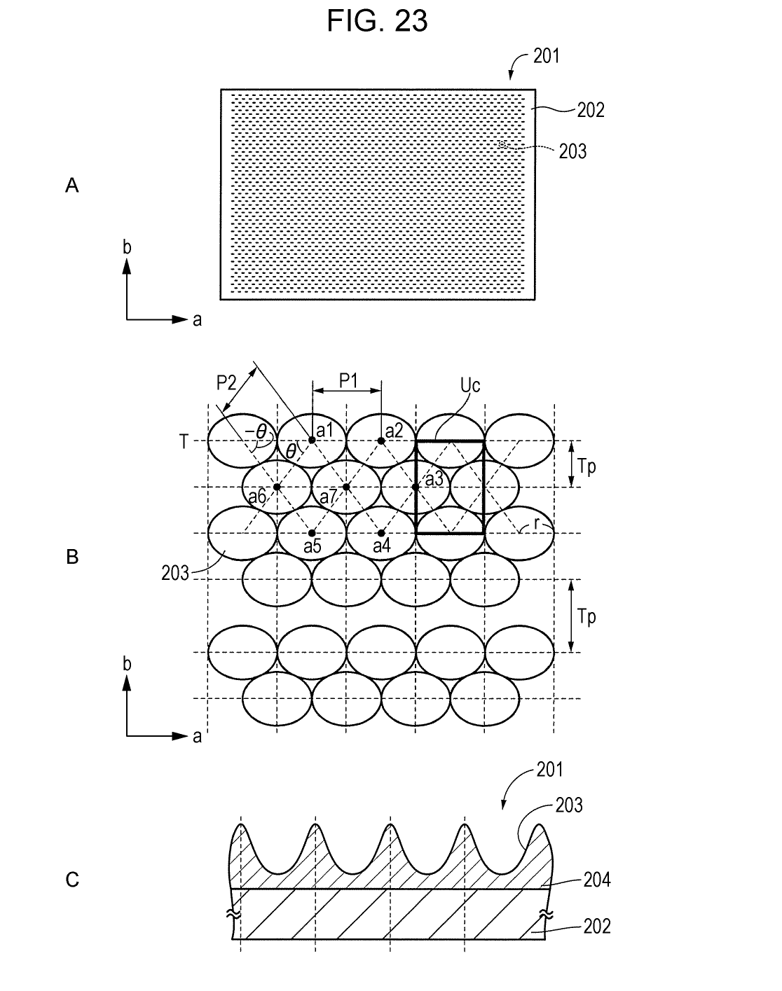

FIG. 23A is a top plan view illustrating an example of a configuration of an anti-reflection optical element according to an eleventh embodiment of the present technology. FIG. 23B is a top plan view illustrating a part of the anti-reflection optical element shown in FIG. 23A in an enlarged manner. FIG. 23C is a cross-sectional view of the track T of FIG. 23B.

The anti-reflection optical element 201 according to the eleventh embodiment is different from that of the ninth embodiment in that the multiple structures 203 as concave portions are arranged on the substrate surface. The shape of the structure 203 is a concave shape which is the reverse of the convex shape of the structure 203 in the ninth embodiment. In addition, when the structure 203 is formed in a concave shape as described above, an opening portion (an entrance part of the concave portion) of the structure 203 is defined as a lower portion, and the lowest portion (a deepest part of the concave portion) of the semitransparent mirror 202 in the depth direction is defined as an apex. That is, the structure 203 as a space, which is not solid, defines the apex and the lower portion. Further, in the twelfth embodiment, the structure 203 has a concave shape, and thus the height H of the structure 203 in Expression (1) and the like is changed into a depth H of the structure 203.

The eleventh embodiment other than the above description is the same as the ninth embodiment.

### 12. Twelfth Embodiment

### Overview of Twelfth Embodiment

The twelfth embodiment is contrived on the basis of a result of the following examination.

As described in the ninth embodiment, as a result of keen examination, the technicians of the present technology found the following fact: occurrence of the bright line noise in the captured image is caused by the variation in the arrangement pitch Tp between the sub-wavelength structures. Therefore, the technicians of the present technology have studied suppressing occurrence of the striped bright line noise through a technique different from that in the above-mentioned ninth embodiment. As a result, finding is as follows: arrangement positions of the sub-wavelength structures are shifted in a direction perpendicular to the line of the sub-wavelength structures, and the light from the light source such as a bright spot is two-dimensionally widened and diffused, whereby it is possible to suppress occurrence of the bright line noise.

### (Configuration of Imaging Apparatus)

The imaging apparatus according to the twelfth embodiment of the present technology is the same as that of the ninth embodiment except for the form of arrangement of the structures 203 formed on the anti-reflection optical element surface. Accordingly, the form of arrangement of the structures 203 will be described hereinafter.

### (Form of Arrangement of Structures)

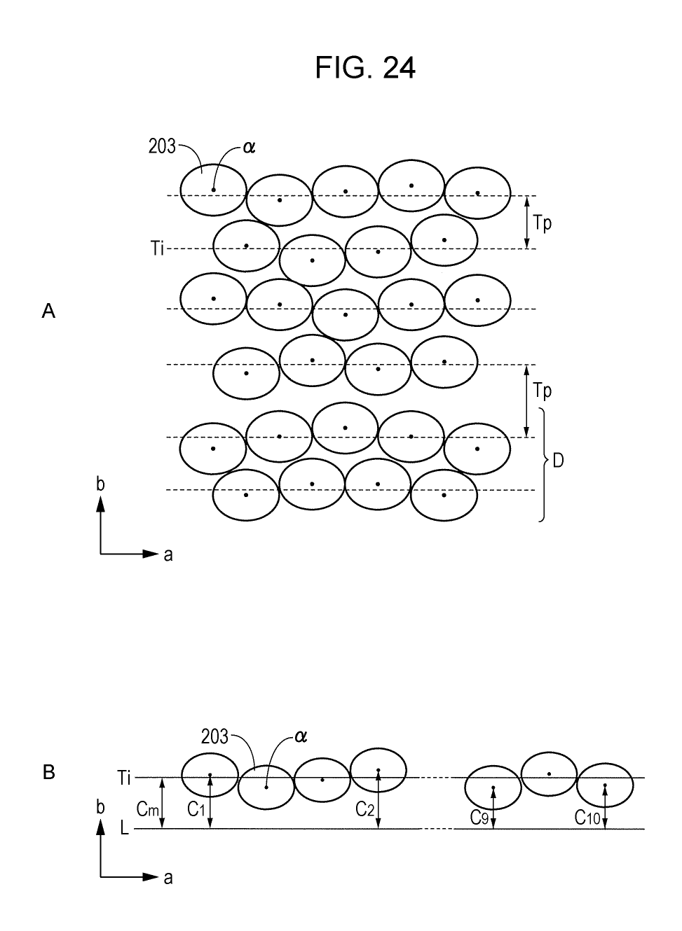

FIG. 24A is a top plan view illustrating a part of a surface of the anti-reflection optical element according to a twelfth embodiment of the present technology, in an enlarged manner. As shown in FIG. 24A, center positions α of the plurality of structures 203 vary in the track array direction (line array direction) b with respect to the virtual track Ti as a reference. By varying the center positions α of the structures 203 in such a manner, the light from the light source such as a bright spot can be two-dimensionally widened and diffused. Consequently, it is possible to suppress occurrence of the bright line noise in a captured image. The variation of the center positions α of the structures 203 is, for example, regular or irregular. From the perspective of reducing occurrence of the bright line noise in the captured image, it is preferable that the variation be irregular. Further, from the perspective of improving the filling rate of the structures 203, as in a section D shown in FIG. 24A, it is preferable to synchronize directions of variations between the virtual tracks Ti.

### (Virtual Track)

FIG. 24B is a schematic view illustrating definition of the virtual track Ti. The virtual track Ti is a virtual track that is calculated from the average position of the center positions α of the structures 203, and is specifically calculated in the following manner.

First, the surface of the anti-reflection optical element is photographed in top view using a scanning electron microscope (SEM). Next, from the photographed SEM picture, one line of the structures 203 for calculating the virtual track Ti is picked out. Then, 10 structures 203 are randomly picked out from the picked-out line. Subsequently, by setting a straight line L perpendicular to the direction b of variation of the structures 203, the center positions (C₁, C₂, . . . , C₁₀) of the respective structures 203 picked out on the basis of the straight line L are calculated. Thereafter, by simply averaging (calculating an arithmetic mean of) the calculated center positions of the 10 structures 203, an average center position Cm (=(C₁+C₂+ . . . +C₁₀)/10) of the structures 203 is calculated. Then, on the basis of the calculated average center position Cm, by calculating a straight line parallel to the straight line L, the straight line is set as the virtual track Ti. In addition, due to trouble at the exposure in the master creation process, the track pitch Tp of the virtual track Ti varies between the tracks as shown in FIG. 24A.

### (Variation Range)

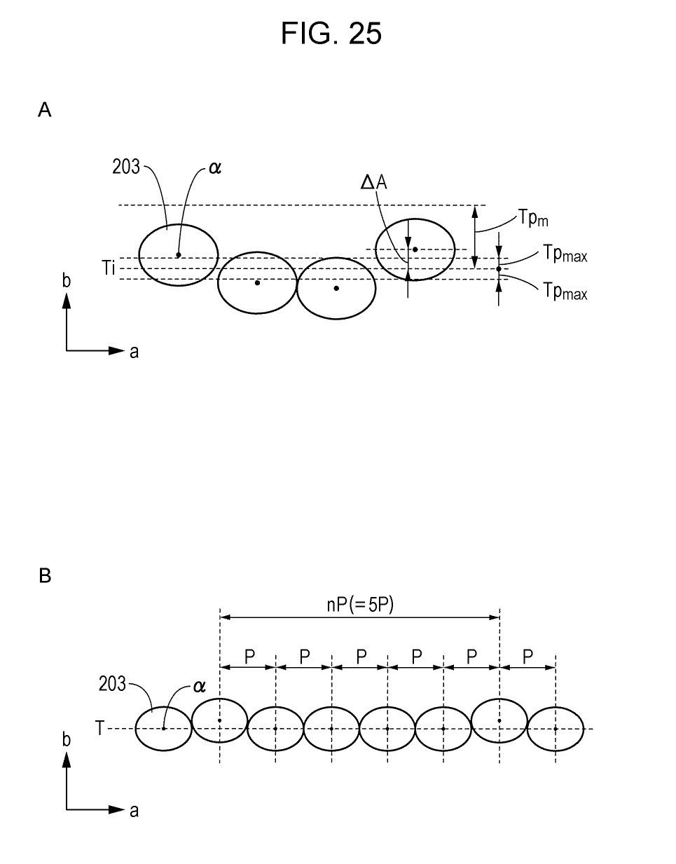

FIG. 25A is a schematic view illustrating a range of variation of center positions of structures. Assuming that a maximum value of the variation range ΔTp of the track pitch Tp is ΔTpₘₐₓ, it is preferable that a variation range ΔA of the center position α of the structure 203 be greater than ΔTpₘₐₓ. Thereby, it is possible to reduce occurrence of the striped bright line noise. Here, the variation range ΔA of the center position α of the structure 203 is a variation range based on the virtual track Ti.

### (Maximum Variation Range ΔTpₘₐₓ of Track Pitch Tp)

The maximum variation range ΔTpₘₐₓ of the track pitch Tp can be calculated in the following manner.

First, the surface of the anti-reflection optical element is photographed in top view using the SEM. Next, one group of the adjacent lines of the structures 203 is picked out from the photographed SEM picture. Then, the virtual track Ti is calculated for each of the lines of the structures 203 of the picked-out group. Subsequently, the track pitch Tp between the calculated virtual tracks Ti is calculated. A process of calculating the above-mentioned track pitch Tp is performed at 10 locations which are randomly picked out from the photographed SEM picture. Then, by simply averaging (calculating the arithmetic mean of) the track pitches Tp calculated at 10 locations, an average track pitch Tpm is calculated.

Next, an absolute value (|Tp−Tpm|) between the track pitch Tp and the average track pitch Tpm calculated in such a manner is calculated, and is set as the variation range ΔTp of the track pitch Tp. The variation ranges ΔTp of the multiple track pitches Tp calculated in such a manner is calculated, and the maximum value is picked out therefrom, and is set as the maximum variation range ΔTpₘₐₓ.

### (Variation Ratio)

FIG. 25B is a schematic view illustrating a rate of variation of the structures. Assuming that the arrangement pitch between the structures 203 in the track direction a is the arrangement pitch P, it is preferable that the center positions α of the structures 203 vary in the track array direction b at such a frequency as is capable of suppressing occurrence of the striped bright line noise. Specifically, it is preferable that the center positions α of the structures 203 vary in the track array direction b at a distance which is equal to or less than a predetermined distance (predetermined period) nP (n: natural number, for example, n=5) in the track direction a. More specifically, it is preferable that the center positions α of the structures 203 vary in the track array direction b at a rate which is equal to or greater than a ratio of one to a predetermined number n (n: natural number, for example, n=5) in the track direction a.

### (Example of Form of Arrangement of Structures)

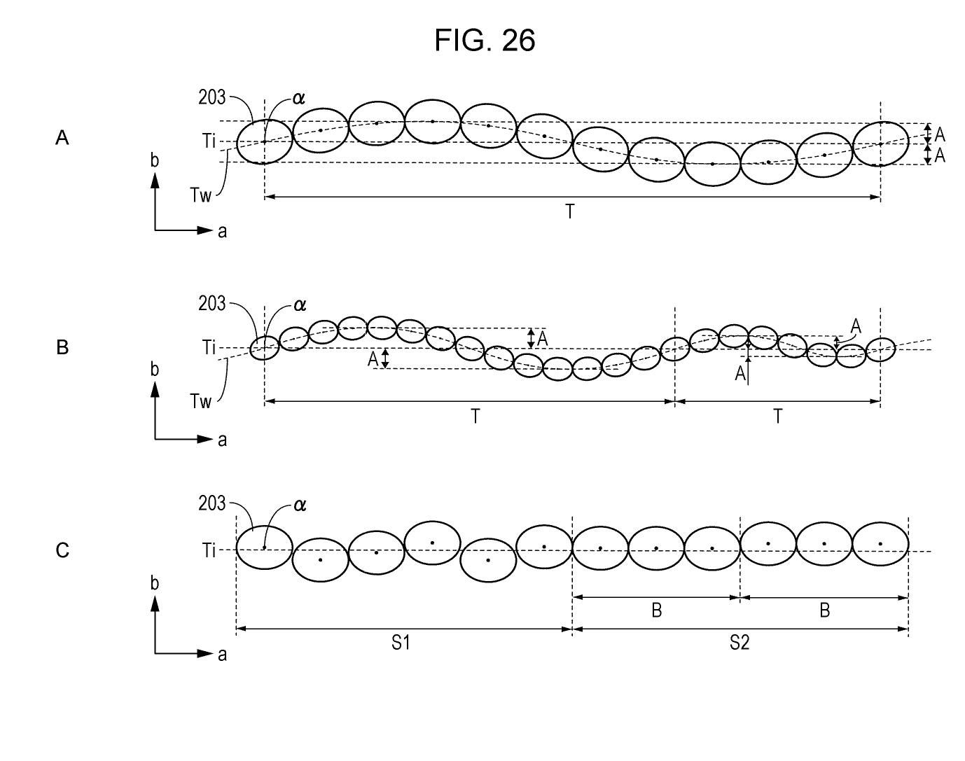

FIG. 26A is a schematic diagram illustrating a first example of the form of arrangement of the structures. As shown in FIG. 26A, in the first example, the center positions α of the structures 203 vary so as to be arranged in an S-shape. Specifically, the center positions α of the structures 203 are arranged on the track (hereinafter referred to as a meandering track) Tw in a meandering manner (an S-shape).

It is preferable that the meandering tracks Tw be synchronized. By synchronizing the meandering tracks Tw in such a manner, the unit lattice shape such as a (quasi) tetragonal lattice shape or a (quasi) hexagonal lattice shape is maintained, and thus it is possible to keep the filling rate high. Examples of the waveform of the meandering track Tw include a sinusoidal wave, a triangular wave, and the like.

The period T and amplitude A of the meandering track Tw can be set to be regular or irregular. Thus, from the perspective of reduction in occurrence of the striped bright line noise, as shown in FIG. 26B, it is preferable to make at least one of the period T and the amplitude A irregular, and it is more preferable to make both of them irregular. It should be noted that the variation in the amplitude A of the meandering track Tw is not limited to the period unit, and the amplitude A may vary in a single period.

FIG. 26C is a schematic diagram illustrating a second example of the form of arrangement of the structures. As shown in a section S1 of FIG. 26C, in the second example, the center positions α of the respective structures 203 are independently varied toward the track array direction b with respect to the virtual track Ti as a reference. Further, as shown in a section S2 of FIG. 26C, a predetermined number of structures adjacent in the track direction a constitute a block (structure group) B, and the center positions α of the structures 203 may be varied by setting the block B as a variation unit. Here, the variation in the center position α of the structure 203 can be set to be regular or irregular. Thus, from the perspective of reduction in occurrence of the striped bright line noise, it is preferable to make the variation irregular. In addition, FIG. 26C shows an example in which two forms of arrangement indicated by the sections S1 and S2 in a single line are mixed. However, it is not indispensable to use the forms of the arrangement in combination, and the surface of the anti-reflection optical element may be formed using either one of the forms of arrangement.

### (Ratio of Intensity Ib of Scattered Light to Intensity Ia of Incident Light)

A ratio (Ib/Ia) of the total intensity Ib of the scattered light Ls, which is scattered by the surface of the anti-reflection optical element, to the total intensity Ia of the incident light, which is incident on the surface of the anti-reflection optical element, is preferably in a range of less than 1/500, more preferably in a range of 1/5000 or less, and still more preferably in a range of 1/10⁵ or less. By setting the ratio (Ib/Ia) to less than 1/500, it is possible to suppress occurrence of the striped bright line noise.

### 13. Thirteenth Embodiment

### Form of Arrangement of Structures

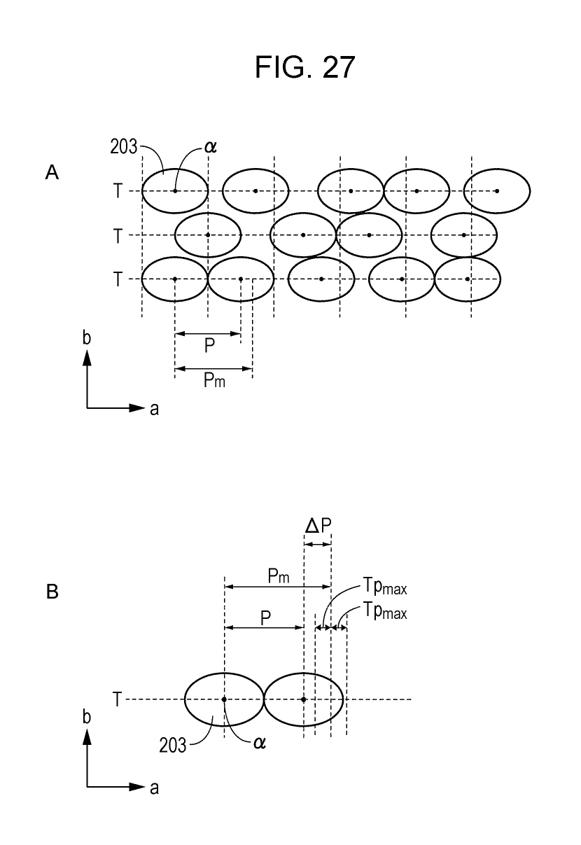

FIG. 27A is a top plan view illustrating a part of the surface of the anti-reflection optical element according to a thirteenth embodiment of the present technology. As shown in FIG. 27A, the thirteenth embodiment is different from the twelfth embodiment in that the arrangement pitch P between the structures 203 on the same track varies relative to the average arrangement pitch Pm.

### (Variation Range)

FIG. 27B is a schematic view illustrating a range of variation in the arrangement pitch P between the structures. Assuming that a maximum value of the variation range ΔTp of the track pitch Tp is ΔTpₘₐₓ, it is preferable that a variation range ΔP of the arrangement pitch P be greater than ΔTpₘₐₓ. Thereby, it is possible to reduce occurrence of the striped bright line noise. Here, the variation range ΔP of the arrangement pitch P is a variation range based on the average arrangement pitch Pm.

### (Average Arrangement Pitch Pm)

The average arrangement pitch Pm can be calculated in the following manner.

First, the surface of the anti-reflection optical element is photographed in top view using the SEM. Next, one track T is picked out from the photographed SEM picture. Then, two adjacent structures 203 are picked out as one group from the plurality of structures 203 arranged on the pick-out track T, and the arrangement pitch P in the track direction a is calculated. A process of calculating the above-mentioned arrangement pitch P is performed at 10 locations which are randomly picked out from the photographed SEM picture. Then, by simply averaging (calculating the arithmetic mean of) the arrangement pitches P calculated at 10 locations, an average arrangement pitch Pm is calculated.

### 14. Fourteenth Embodiment

The above-mentioned ninth embodiment describes the exemplary case where the present technology is applied to a digital camera (digital still camera) as the imaging apparatus. However, the application example of the present technology is not limited to this. A fourteenth embodiment of the present technology will describe an exemplary case where the present technology is applied to a digital video camera.

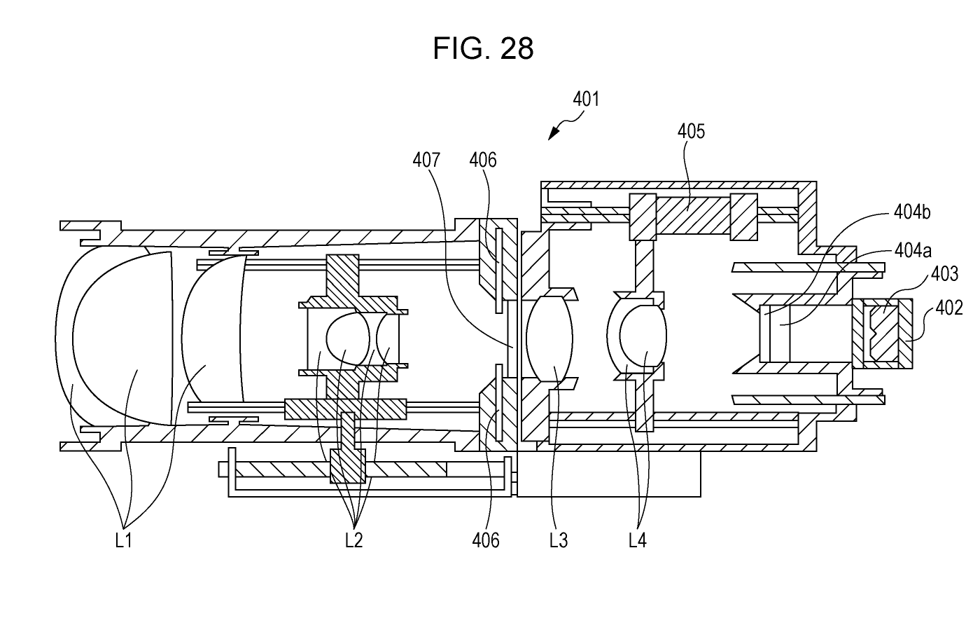

FIG. 28 is a schematic view illustrating an example of a configuration of an imaging apparatus according to the fourteenth embodiment of the present technology. As shown in FIG. 28, an imaging apparatus 401 according to the fourteenth embodiment is a so-called digital video camera, includes a first lens group L1, a second lens group L2, a third lens group L3, a fourth lens group L4, a solid-state imaging device 402, a low-pass filter 403, a filter 404, a motor 405, iris blades 406, and an electro-optical modulation element 407. In the imaging apparatus 401, an imaging optical system is constituted of the first lens group L1, the second lens group L2, the third lens group L3, the fourth lens group L4, the solid-state imaging device 402, the low-pass filter 403, the filter 404, the iris blades 406, and the electro-optical modulation element 407. The iris blades 406 and the electro-optical modulation element 407 constitute an optical adjustment device.

The first lens group L1 and third lens group L3 are stationary lenses. The second lens group L2 is a zoom lens. The fourth lens group is a focus lens.

The solid-state imaging device 402 converts the incident light into an electric signal, and supplies the signal to a signal process section which is not shown. The solid-state imaging device 402 is, for example, a charge coupled device (CCD) or the like.

The low-pass filter 403 is, for example, provided in front of the solid-state imaging device 402. The low-pass filter 403 is to suppress aliasing (moire) caused when an image having a fringe close to the pixel pitch is photographed, and, for example, is constituted of artificial crystal.

The filter 404 is, for example, to make uniform the light intensity with a visible region (400 nm to 700 nm) by cutting the infrared region of the light incident into the solid-state imaging device 402 and suppressing the floating of the spectrum in the near-infrared region of (630 nm to 700 nm). The filter 404 is constituted of, for example, an infrared-cut filter (hereinafter, an IR-cut filter) 404a and an IR-cut coat layer 404b that is formed by laminating an IR-cut coat on the IR-cut filter 404a. Here, the IR-cut coat layer 404b is, for example, formed on at least one of the surface of the IR-cut filter 404a on the subject side and the surface of the IR-cut filter 404a on the solid-state imaging device 402 side. FIG. 28 shows an example in which the IR-cut coat layer 404b is formed on the surface of the IR-cut filter 404a on the subject side.

The motor 405 moves the fourth lens group L4 on the basis of the control signal supplied from the control section which is not shown. The iris blades 406 are to adjust an amount of light incident into the solid-state imaging device 402, and are driven by a motor which is not shown.

The electro-optical modulation element 407 is to adjust an amount of light incident into the solid-state imaging device 402. The electro-optical modulation element 407 is an electro-optical modulation element made of liquid crystal including at least a dye-based coloring matter, and is an electro-optical modulation element made of, for example, dichroic GH liquid crystal.

A plurality of structures is formed on a surface of at least one optical element or optical element group (hereinafter referred to as an optical section) of the first lens group L1, the second lens group L2, the third lens group L3, the fourth lens group L4, the low-pass filter 403, the filter 404, and the electro-optical modulation element 407 constituting the imaging optical system. With such a configuration of the structures, the shape and the form of arrangement are the same as, for example, in any one of the above-mentioned first to thirteenth embodiments.

Specifically, when the plurality of structures is formed on a surface of the third lens group L3 or the filter 404 separately provided on the front side (subject side) of the solid-state imaging device 402 in the optical section constituting the imaging optical system, it is preferable that the configuration, the shapes, and the form of arrangement of the structures be the same as in any one of the above-mentioned first to thirteenth embodiments. When the plurality of structures is formed on a surface of the optical section other than the third lens group L3 and the filter 404 separately provided in front of the solid-state imaging device 402, it is preferable that the configuration, the shapes, and the form of arrangement of the structures be the same as in the above-mentioned fourth or thirteenth embodiment. Particularly, when the plurality of structures are formed on a surface of the low-pass filter 403 provided to be adjacent to the front of the solid-state imaging device 402, it is preferable that the configuration, the shapes, and the form of arrangement of the structures be the same as in the above-mentioned fourth or thirteenth embodiment.

### 15. Fifteenth Embodiment

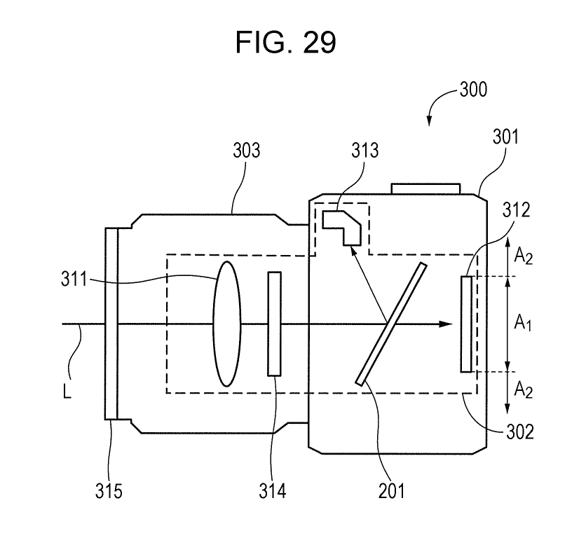

FIG. 29 is a schematic view illustrating an example of a configuration of an imaging apparatus according to a fifteenth embodiment of the present technology.

As shown in FIG. 29, the imaging apparatus 300 according to the fifteenth embodiment is different from that of the ninth embodiment in that there is further provided a light amount adjustment device 314. FIG. 29 shows an example in which the light amount adjustment device 314 is provided in the lens barrel 303. However, the position, at which the light amount adjustment device 314 is provided, is not limited to this example. The light amount adjustment device 314 may be provided in the casing 301 which is an imaging apparatus main body.

The light amount adjustment device 314 is a diaphragm device that adjusts the size of the aperture for a diaphragm centered on the optical axis of the imaging optical system 302. The light amount adjustment device 314 includes, for example, a pair of diaphragm blades and an ND filter that reduces a light amount of transmitted light. As a method of driving the light amount adjustment device 314, for example, it is possible to use a method of driving the pair of diaphragm blades and the ND filter by a single actuator and a method of respectively driving the pair of diaphragm blades and the ND filter by two actuators which are independent. The driving method is not particularly limited to such a method. As the ND filter, it is possible to use a filter, in which the transmittance or the concentration is constant, or a filter in which the transmittance or the concentration changes to have a gradation shape. Further, the number of the ND filter is not limited to one, and a plurality of ND filters may be used in a state where the filters are laminated.

### (ND Filter)

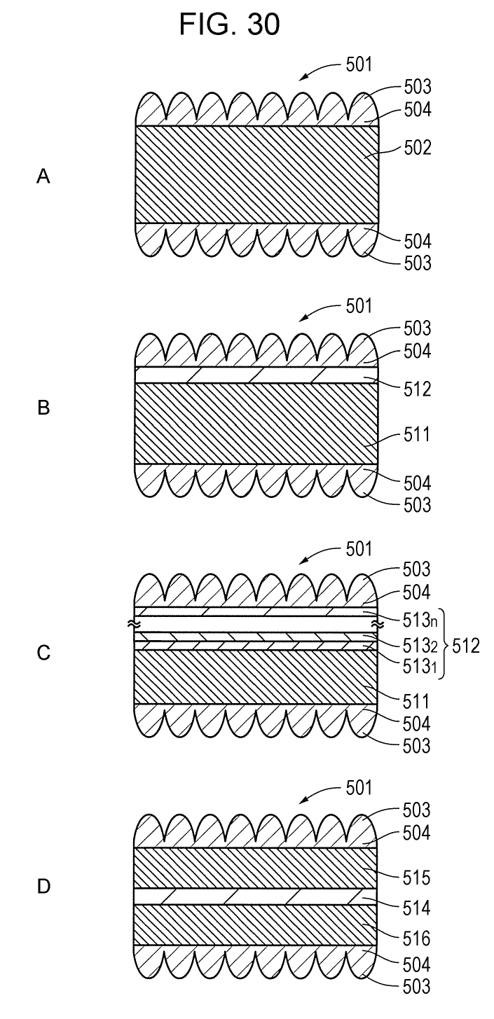

FIG. 30A is a cross-sectional view illustrating an example of a configuration of the ND filter. As shown in FIG. 30A, an ND filter 501 is an anti-reflection ND filter (anti-reflection optical element), and includes an ND filter main body (element main body) 502 that has an incident surface and an emission surface and a plurality of sub-wavelength structures 503 that is provided on the incident surface of the ND filter main body 502. From the perspective of improvement of the transmission property of the ND filter main body 502, it is preferable to provide the plurality of sub-wavelength structures 503 on both of the incident surface and the emission surface. The ND filter 501 has, for example, a film shape. The sub-wavelength structures 503 and the ND filter main body 502 are separately or integrally formed. When the sub-wavelength structures 503 and the ND filter main body 502 are separately formed, a bottom layer 504 may be further provided between the sub-wavelength structures 503 and the ND filter main body 502, as necessary. The bottom layer 504 is a layer that is formed integrally with the sub-wavelength structures 503 on the bottom sides of the sub-wavelength structures 503, and is formed by curing the energy-ray-curable resin composition in a similar manner to that of the sub-wavelength structures 503.

Hereinafter, the ND filter main body 502 and the sub-wavelength structures 503 provided in the ND filter 501 will be described in order of precedence.

### (ND Filter Main Body)

As the ND filter main body 502, it is possible to use a substrate such as a film containing coloring matter and/or a pigment. The ND filter main body 502 having such a configuration can be formed, for example, by mixing the coloring matter and/or the pigment in a resin material. The coloring matter is not particularly limited as long as it is a dye having absorptivity in the visible light region. For example, the coloring matter may be a phthalocyanine base, a thiol metallic complex base, an azo base, a polymethine base, a diphenyl methane base, a triphenyl methane base, a quinone base, an anthraquinone base, a diimmonium salt base, or the like. The pigment includes at least one kind of inorganic particles selected from carbon black, metallic oxide, metallic nitride, and metal oxynitride. Specifically, examples of such inorganic particles include black pigments such as carbon particles, black titanium oxide, ivory black, peach black, lamp black, Bichumu, and aniline black.

As shown in FIG. 30B, as a configuration of the ND filter main body 502, it may be possible to adopt a configuration in which the substrate 511 and the ND layer 512, which is provided on a surface of the substrate 511 and contains a dye and/or a pigment, are provided. The ND layer 512 may have not only a single layer structure but also a laminated layer structure in which a plurality of ND layers is laminated. As the substrate 511, it may be possible to use a transparent substrate, but the substrate is not limited to this, and a substrate containing a coloring matter and/or a pigment may be used.

As shown in FIG. 30C, it may be possible to use a laminated film in which a plurality of inorganic films 513₁, 513₂, . . . , and 513ₙ is laminated on the surface of the substrate 511 as the ND layer 512. As the laminated film, for example, it is possible to use a metallic film, a metallic oxide, a dielectric material film, and the like.

As shown in FIG. 30D, as a configuration of the ND filter main body 502, it may be possible to adopt a configuration in which a layer 514 containing a coloring matter and/or a pigment is interposed between multiple films 515 and 516.

### (Sub-Wavelength Structures)

The sub-wavelength structures 503 are the same as the structures 203 according to the above-mentioned ninth embodiment.

The fifteenth embodiment other than the above description is the same as the ninth embodiment. It should be noted that, as the light amount adjustment device of the imaging apparatus according to the fourteenth embodiment, it may be possible to use a light amount adjustment device described in the above-mentioned fifteenth embodiment.

### Modified Example

As shown in FIG. 29, a filter 315 may be provided on a surface on the light incidence side of the lens barrel 303, that is, a surface on the subject side thereof. The filter 315 is configured to be detachable from the lens barrel 303. The filter 315 includes a filter main body that has an incident surface and an emission surface, and a plurality of sub-wavelength structures that is provided on the incident surface of the filter main body. From the perspective of improvement of the transmission property of the filter main body, it is preferable to provide the plurality of sub-wavelength structures on both of the incident surface and the emission surface. The sub-wavelength structures are the same as the sub-wavelength structures 503 in the above-mentioned fifteenth embodiment. The filter 315 is not particularly limited as long as it is mounted on the surface on the light incidence side of the lens barrel 303. However, examples of the filter include a polarization (PL) filter, a sharp cut (SC) filter, a color emphasis and effect filter, a dimming (ND) filter, a color temperature conversion (LB) filter, a color correction (CC) filter, a white balance acquisition filter, a lens protection filter, and the like.

### EXAMPLES

Hereinafter, the present technology will be described in detail with reference to examples, but the present technology is not limited to such examples.

Examples, comparative examples and test examples will be described in the following order.

1. Optical Characteristics of ND Filter

2. Relationship between Track Pitch and Scattered Light

3. Relationship between Variation Amount of Track Pitch and Scattered Light

### 1. Optical Characteristics of ND Filter

### Example 1

First, a glass roll master with an outer diameter of 126 mm is provided, and a resist layer is formed on a surface of the glass roll master in the following manner. That is, the photoresist is diluted to 1/10 by a thinner, and a circular columnar surface of the glass roll master is coated with the diluted resist with a thickness of about 70 nm through the dipping method, thereby forming the resist layer. Next, the glass roll master as a recording medium is transported to the roll master exposure device shown in FIG. 7, and the resist layer is exposed. Thereby, a latent image is patterned on the resist layer. The latent image is connected as one helix, and is formed in a hexagonal lattice pattern among three adjacent tracks.

Specifically, a region, in which an exposure pattern having a hexagonal lattice shape will be formed, is irradiated with laser light with a power of 0.50 mW, to which the resist layer is exposed up to the glass roll master surface, thereby forming an exposure pattern having a hexagonal lattice shape. In addition, a thickness of the resist layer in the line direction of the track line is about 60 nm, and a resist thickness in the extending direction of the track is about 50 nm.

Next, a development process is performed on the resist layer on the glass roll master, and the resist layer in an exposed portion is dissolved, thereby forming development. Specifically, an undeveloped glass roll master is placed on a turntable of a developing unit which is not shown, and a developer is dropped on a surface of the glass roll master while the glass roll master is rotated together with the turntable, thereby developing the resist layer on the surface. Thereby, it is possible to obtain a resist glass master on which the resist layer is open in the hexagonal lattice pattern.

Next, using a roller etching device, plasma etching under a CHF₃ gas atmosphere is performed. Thereby, etching proceeds on only a part of the hexagonal lattice pattern, which is exposed from the resist layer, on the surface of the glass roll master, the resist layer serves as a mask in the other region, and is not etched, and concave portions having elliptical cone shapes are formed on the glass roll master. At this time, an etching amount (depth) is adjusted by an etching time period. Finally, by completely removing the resist layer through O₂ asking, it is possible to obtain a moth-eye glass roll master having a hexagonal lattice pattern of the concave shapes. The depth of the concave portion in the line direction is greater than the depth of the concave portion in the extending direction of the track.

Next, a plurality of UV light sources is disposed in a cavity section of the moth-eye glass roll master obtained in such a manner. Next, using the moth-eye glass roll master, the plurality of structures is produced on both sides of the film-like ND filter through UV imprint. Specifically, while the moth-eye glass roll master is rotated, a transfer surface thereof is brought into tight contact with the ND filter, which is coated with an ultraviolet curable resin, and the ultraviolet curable resin is irradiated with ultraviolet rays having a power of 100 mJ/cm² from the side of the transfer surface of the moth-eye glass roll master, and is cured and exfoliated. Thereby, it is possible to obtain the ND filter in which a plurality of the following structures is arranged on both surfaces thereof.

Array of Structures: Hexagonal Lattice

Shape of Structure: Bell Chamber Shape (Substantially Rotational Parabolic Shape)

Average Arrangement Pitch P of Structures: 250 nm

Average Height H of Structure: 200 nm

Aspect Ratio (H/P) of Structure: 0.8

With such a configuration, it is possible to obtain the ND filter having an anti-reflection function.

### Comparative Example 1

The plurality of structures is not formed on both surfaces of the ND filter, and the ND filter itself is sampled.

### (Evaluation)

The transmission and reflection properties of the ND filters of Example 1 and Comparative Example 1 obtained as described above are evaluated in the following manner.

### (Transmission Property)

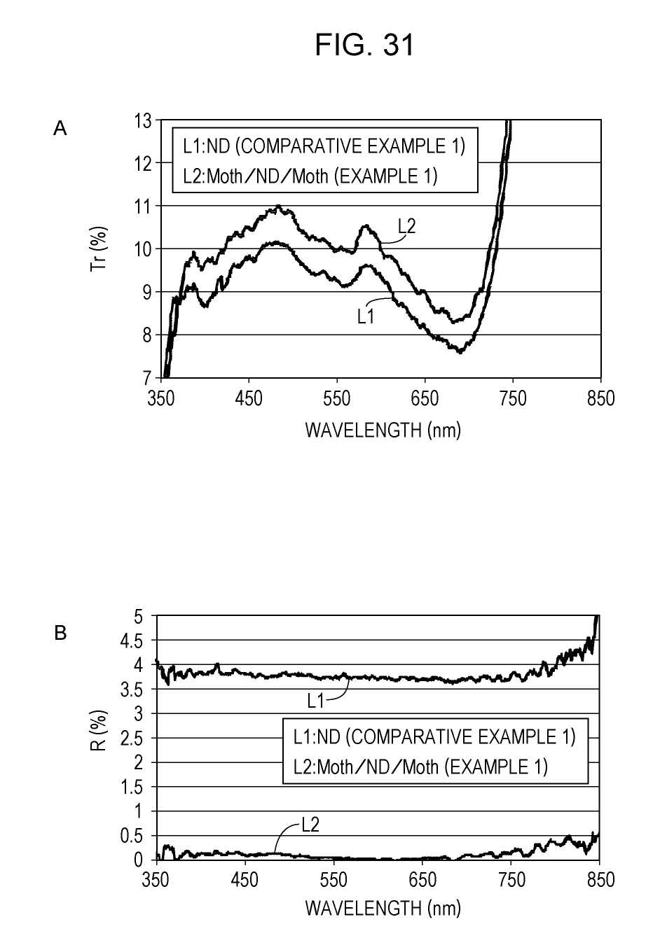

A transmission spectrum of the ND filter in a substantially visible wavelength region (350 nm to 750 nm) is measured by a spectrophotometer (made by JASCO Corporation, trade name: V-550). The result is shown in FIG. 31A.

### (Reflection Property)

A measurement sample is produced by bonding a black tape to one surface of the ND filter. Next, the reflection spectrum of the measurement sample in a substantially visible wavelength region (350 nm to 850 nm) is measured by a spectrophotometer (made by JASCO Corporation, trade name: V-550). The result is shown in FIG. 31B.

As can be seen from FIG. 31A, by providing the structures on both surfaces of an ND film, it is possible to improve the transmittance by about 1% throughout substantially the entire substantially visible wavelength region (350 nm to 700 nm).

As can be seen from FIG. 31B, by providing the structures on both surfaces of the ND film, it is possible to improve the reflectance by about 4% throughout substantially the entire substantially visible wavelength region (350 nm to 850 nm).

### 2. Relationship Between Track Pitch and Scattered Light

A relationship between the track pitch and the scattered light was studied through a rigorous coupled wave analysis (RCWA) simulation.

### Test Example 1-1

There is proposed an optical element of which a surface has the plurality of sub-wavelength structures formed thereon. When the optical element is irradiated with light from a point light source, the intensity distribution of the scattered light is calculated through a simulation.

Conditions of the simulation are as follows.

Array of Sub-Wavelength Structures: Tetragonal Lattice

Arrangement Pitch P1 in Track Direction: 250 nm

Track Pitch Tp: 200 nm

Bottom Shape of Sub-Wavelength Structure: Elliptical Shape

Height of Sub-Wavelength Structure: 200 nm

Shape of Structure: Parabolic Shape (Bell Chamber Shape)

Polarization: Non-Polarization

Refractive Index: 1.5

### Test Example 1-2

In a similar manner to the case of Test Example 1-1 except that the track pitch Tp is set to 250 nm, the intensity distribution of the scattered light is calculated through a simulation.

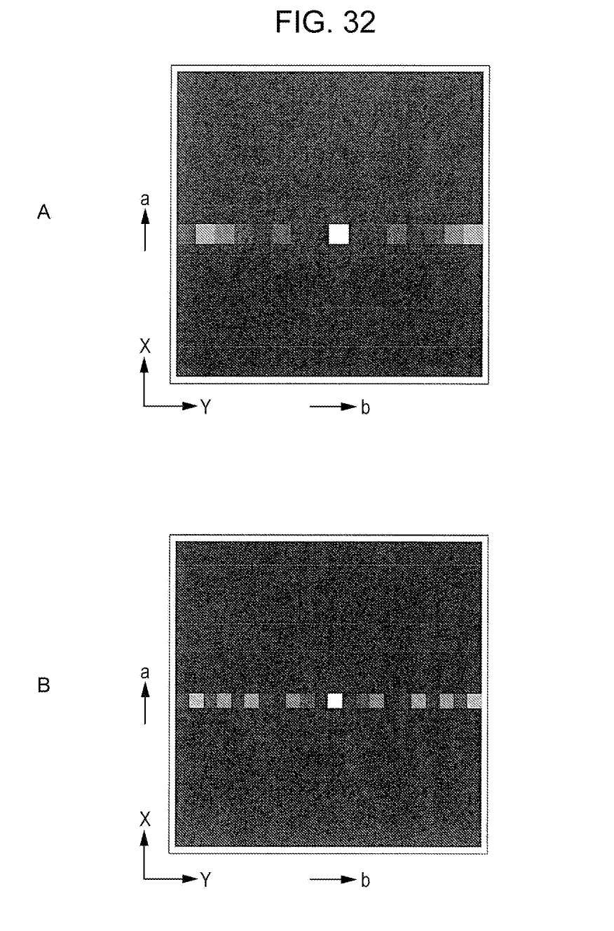

FIG. 32A is a diagram illustrating a simulation result of Test Example 1-1. FIG. 32B is a diagram illustrating a simulation result of Test Example 1-2. FIGS. 32A and 32B show the intensity distributions of the scattered light in a range of horizontal and vertical axes (XY axes): NA=±1.5, where the intensity is indicated by a brighter tone (tone closer to white) at a position with a higher intensity. It should be noted that parts with high intensities of the scattered light, which are respectively shown in the centers (optical axis parts) of FIGS. 32A and 32B, indicate the intensities of the incident light (0th-order light).

From the result of the above-mentioned simulation, the following facts can be found.

In Test Example 1-1, as the scattered light becomes far from the optical axis, in the optical element proposed in Test Example 1-1, compared with the optical element proposed in Test Example 1-2, the intensity of the scattered light tends to become smaller in a range of NA<0.8. Consequently, in the optical element of Test Example 1-1, it is possible to reduce image noise (bright line noise) in a captured image.

In Test Example 1-2, the scattered light is present near the optical axis, and the intensity of the scattered light tends to be high in a range of NA<0.8. Consequently, in the optical element of Test Example 1-2, image noise (bright line noise) occurs in a captured image.

As described above, from the perspective of reducing occurrence of the image noise, it is preferable to narrow the track pitch (the arrangement pitch in the track array direction) Tp.

### 3. Relationship between Amount of Variation in Track Pitch and Scattered Light

A relationship of the amount of variation in the track pitch, the form of the array of sub-wavelength structures, and the scattered light was studied through a rigorous coupled wave analysis (RCWA) simulation.

### Test Example 2-1

There is proposed an optical element of which a surface has the plurality of sub-wavelength structures formed thereon. When the optical element is irradiated with light from a point light source, the intensity distribution of the scattered light is calculated through a simulation.

Conditions of the simulation are as follows.

Array of Sub-Wavelength Structures: Tetragonal Lattice

Arrangement Pitch P1 in Track Direction: 250 nm

Center Value of Track Pitch Tp: 250 nm

Maximum Value of Amount of Variation in Track Pitch Tp: 32 nm

Bottom Shape of Sub-Wavelength Structure: Elliptical Shape

Height of Sub-Wavelength Structure: 200 nm

Shape of Structure: Parabolic Shape (Bell Chamber Shape)

Polarization: Non-Polarization

Refractive Index: 1.5

### Test Example 2-2

In a similar manner to the case of Test Example 2-1 except that the maximum value of the amount of variation in the track pitch Tp is set to ΔTp=8 nm, the intensity distribution of the scattered light is calculated through a simulation.

### Test Example 2-3

In a similar manner to the case of Test Example 2-1 except that the maximum value of the amount of variation in the track pitch Tp is set to ΔTp=8 nm and the tracks are arranged in a meandering manner, the intensity distribution of the scattered light is calculated through a simulation.

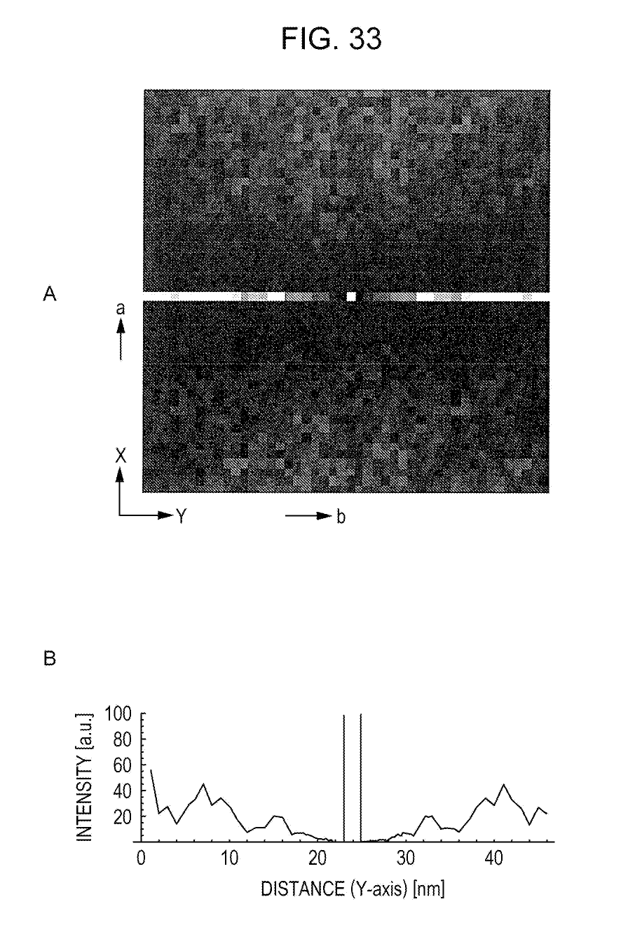

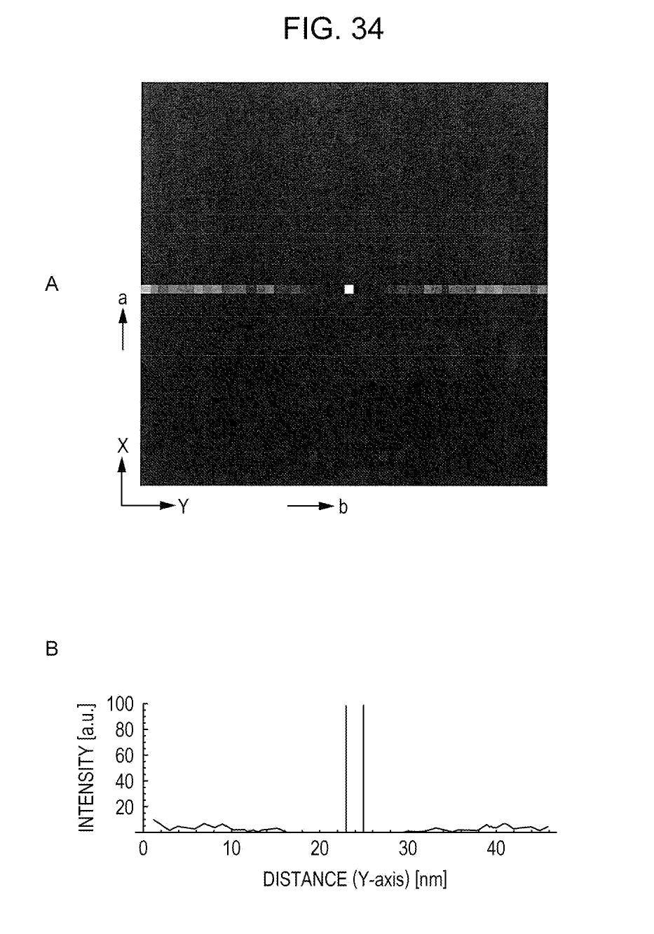

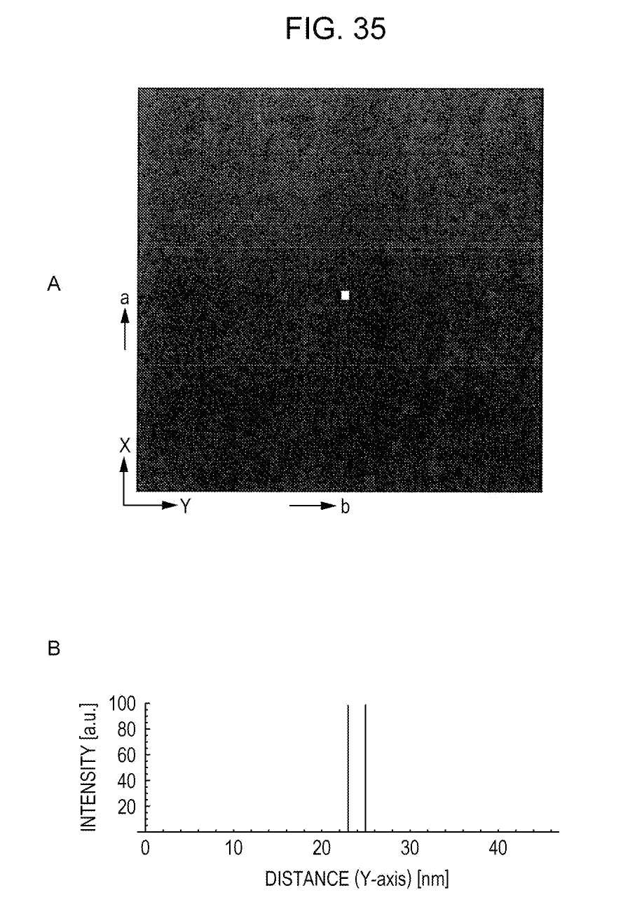

FIGS. 33A and 33B are diagrams illustrating a simulation result of Test Example 2-1. FIGS. 34A and 34B are diagrams illustrating a simulation result of Test Example 2-2. FIGS. 35A and 35B are diagrams illustrating a simulation result of Test Example 2-3. FIGS. 33A, 34A, and 35A show the intensity distributions of the scattered light in a range of horizontal and vertical axes (XY axes): NA=±1.5. It should be noted that parts with high intensities of the scattered light, which are respectively shown in the centers (optical axis parts) of FIGS. 33A, 34A, and 35A, indicate the intensities of the incident light (0th-order light). It should be noted that, since the haze value of Test Example 2-1 is approximate to a haze value (haze value of the moth-eye part) which is obtained through actual measurement, it can be determined that the models proposed in the simulations of Test Examples 2-1 to 2-3 are appropriate.

Regarding Test Examples 2-1 to 2-3, a ratio ((ILb/ILa)×100[%]) of a total light amount ILb of band-like scattered light to a total light amount ILa of the incident light is represented as follows.

Test Example 2-1: 0.2% (the ratio (Ib/Ia) of the total intensity Ib of the scattered light to the total intensity Ia of the incident light: 1/500)

Test Example 2-2: 0.02% (the ratio (Ib/Ia) of the total intensity Ib of the scattered light to the total intensity Ia of the incident light: 1/5000)

Test Example 2-3: 0.001% (the ratio (Ib/Ia) of the total intensity Ib of the scattered light to the total intensity Ia of the incident light: 1/10⁵)

From the result of the above-mentioned simulation, the following facts can be found.

From the simulation result of Test Example 2-1, it could be found that, when the maximum value of the amount of variation ΔTp in the track pitch Tp is large, bright line noise occurs.

From the simulation result of Test Example 2-2, it could be found that it is possible to suppress occurrence of the bright line noise by decreasing the maximum value of the amount of variation ΔTp in the track pitch Tp, and there is an effect of suppressing occurrence of the bright line noise by increasing an accuracy of the amount of variation in the track pitch.

From the simulation result of Test Example 2-3, it could be found that it is possible to further suppress occurrence of the bright line noise by decreasing the maximum value of the amount of variation ΔTp in the track pitch Tp and arranging the tracks in a meandering manner with a non-periodic frequency to cause variation in the tracks.

As described above, from the perspective of suppressing occurrence of the bright line noise, a ratio of the intensity of the scattered light to the intensity of the incident light is preferably in a range of less than 1/500, more preferably in a range of 1/5000 or less, and still more preferably in a range of 1/10⁵ or less.

The embodiments of the present technology have been hitherto described in detail, but the present technology is not limited to the above-mentioned embodiments, and may be modified into various forms based on the technical scope of the present technology.

For example, the optical elements according to the embodiments of the present technology can be applied to not only the imaging apparatus but also to microscopes, exposure devices, and the like.

Further, for example, in the above-mentioned embodiments, the exemplified configurations, methods, processes, shapes, materials, numerical values, and the like are just examples. As necessary, configurations, methods, processes, shapes, materials, numerical values, and the like other than those may be used.

Furthermore, in the above-mentioned embodiments, the configurations, methods, processes, shapes, materials, numerical values, and the like may be combined without departing from the scope of the present technology.

Moreover, in the above-mentioned embodiments, examples for applying the present technology to the imaging apparatus have been described, but the present technology is not limited to these examples. The present technology can be applied to an optical system having an optical element, of which a surface (at least one of the incident surface and the emission surface) has a plurality of sub-wavelength structures formed thereon, or an optical apparatus having the same. For example, the present technology can be applied to microscopes, exposure devices, and the like.

In addition, in the above-mentioned embodiment, a case of applying the present technology to a digital imaging apparatus has been described as an example, but the present technology can be applied to an analog imaging apparatus.

### (Configuration of Present Technology)

In addition, the present technology may have the following configurations.

(1-1)

An optical element including:

an element main body; and

a plurality of sub-wavelength structures that is provided on a surface of the element main body,

in which the sub-wavelength structures include an energy-ray-curable resin composition,

in which the element main body is opaque to energy rays for curing the energy-ray-curable resin composition,

in which the surface, on which the plurality of sub-wavelength structures is provided, has a section in which scattered light is generated by scattering incident light, and

in which intensity distribution of the scattered light is anisotropic.

(1-2)

The optical element according to (1-1), further including a shaped layer that is provided on the surface of the element main body and has a surface having a concave-convex shape,

in which the concave-convex shape includes the plurality of sub-wavelength structures, and

in which unit regions having predetermined sub-wavelength structure patterns are consecutively arranged on the surface of the shaped layer without causing inconsistency in the concave-convex shape.

(1-3)

The optical element according to (1-2),

in which the element main body has a band shape, and

in which the unit regions are consecutively arranged in a length direction of the element main body.

(1-4)

The optical element according to (1-2) or (1-3), in which the inconsistency in the concave-convex shape is disarray in periodicity of the predetermined sub-wavelength structure patterns.

(1-5)

The optical element according to (1-2) or (1-3), in which the inconsistency in the concave-convex shape is an overlap, a gap, or a non-transferred portion between the unit regions adjacent to each other.

(1-6)

The optical element according to (1-2) or (1-3), in which the unit regions are connected without causing inconsistency at the time of curing the energy-ray-curable resin composition.

(1-7)

The optical element according to (1-6), in which the inconsistency at the time of curing the energy-ray-curable resin composition is a difference in a degree of polymerization.

(1-8)

The optical element according to any one of (1-1) to (1-7), in which the sub-wavelength structures are formed by advancing the curing reaction of the energy-ray-curable resin composition, with which the surface of the element main body is coated, from a side opposite to the element main body.

(1-9)

The optical element according to any one of (1-2) to (1-7), in which the unit regions are transferred regions which are formed by one rotation of a rotation surface of a rotational master.

(1-10)

The optical element according to (1-1),

in which the sub-wavelength structures form a lattice pattern,

in which the sub-wavelength structures are arranged to form a plurality of tracks on the surface,

in which the lattice pattern includes at least one type of a hexagonal lattice pattern, a quasi-hexagonal lattice pattern, a tetragonal lattice pattern, and a quasi-tetragonal lattice pattern,

in which the surface scatters a part of the incident light, and

in which an intensity of the scattered light is less than 1/500 of an intensity of the incident light.

(1-11)

The optical element according to any one of (1-2) to (1-9), in which the sub-wavelength structure patterns are formed by one-dimensionally or two-dimensionally arranging the plurality of sub-wavelength structures having convex or concave shapes.

(1-12)

The optical element according to any one of (1-1) to (1-11), in which the plurality of sub-wavelength structures is regularly or irregularly arranged.

(1-13)

The optical element according to any one of (1-2) to (1-7),

in which the element main body has at least one planar surface or curved surface, and

in which the shaped layer is formed on the planar surface or curved surface.

(1-14)

The optical element according to any one of (1-1) to (1-13),

in which the sub-wavelength structures are arranged to form a plurality of tracks on the surface, and

in which a pitch Tp between the tracks varies in accordance with a gap between the tracks.

(1-15)

The optical element according to any one of (1-1) to (1-14),

in which the sub-wavelength structures form a lattice pattern,

in which the sub-wavelength structures are arranged to form a plurality of tracks on the surface, and

in which the lattice pattern includes at least one type of a hexagonal lattice pattern, a quasi-hexagonal lattice pattern, a tetragonal lattice pattern, and a quasi-tetragonal lattice pattern.

(1-16)

A manufacturing method of an optical element including:

coating a surface of an element main body with an energy-ray-curable resin composition; and

forming a plurality of sub-wavelength structures on the surface of the element main body by irradiating the energy-ray-curable resin composition, which is coated on the surface of the element main body, with energy rays radiated from an energy ray source, which is provided in a rotational master, through a rotation surface of the rotational master while rotating the rotation surface of the rotational master in tight contact therewith, so as to cure the energy-ray-curable resin composition,

in which the surface, on which the plurality of sub-wavelength structures is provided, has a section in which scattered light is generated by scattering incident light, and

in which intensity distribution of the scattered light is anisotropic.

(1-17)

The manufacturing method of the optical element according to (1-16), in which the element main body is opaque to the energy rays.

(1-18)

The manufacturing method of the optical element according to (1-16) or (1-17), in which the concave-convex shape of the rotation surface is formed by one-dimensionally or two-dimensionally arranging the plurality of sub-wavelength structures having convex or concave shapes.

(1-19)

The manufacturing method of the optical element according to (1-18), in which the plurality of sub-wavelength structures is regularly or irregularly arranged.

(1-20)

The manufacturing method of the optical element according to any one of (1-16) to (1-19), in which the rotational master is a roll master or a belt master.

(1-21)

The manufacturing method of the optical element according to any one of (1-16) to (1-20), in which the energy ray source is disposed in a width direction of the rotational master.

(1-22)

The manufacturing method of the optical element according to any one of (1-16) to (1-21),

in which the element main body has a band shape, and

in which at the time of forming the sub-wavelength structures, the concave-convex shape is transferred by setting a length direction of the element main body as a forward direction of rotation.

(1-23)

The manufacturing method of the optical element according to any one of (1-16) to (1-22), in which the element main body has at least one planar surface or curved surface, and

in which the shaped layer is formed on the planar surface or curved surface.

(1-24)

An optical system including:

an optical element; and

an imaging device that has an imaging region which receives light through the optical element,

in which the optical element includes
an element main body, and
a plurality of sub-wavelength structures that is provided on a surface of the element main body,

in which the sub-wavelength structures include an energy-ray-curable resin composition,

in which the element main body is opaque to energy rays for curing the energy-ray-curable resin composition,

in which the surface, on which the plurality of sub-wavelength structures is provided, has a section in which scattered light is generated by scattering incident light, and

in which intensity distribution of the scattered light is anisotropic.

(1-25)

The optical system according to (1-24), in which a sum of components of the scattered light reaching the imaging region is less than a sum of components reaching the outside of the imaging region.

(1-26)

The optical system according to (1-24) or (1-25), in which the intensity distribution of the scattered light is anisotropic.

(1-27)

The optical system according to any one of (1-24) to (1-26), in which the intensity distribution of the scattered light is different in accordance with a numerical aperture NA.

(1-28)

The optical system according to any one of (1-24) to (1-27), in which an intensity per unit solid angle in the intensity distribution of the scattered light at a numerical aperture NA≦0.8 is less than that at a numerical aperture NA>0.8.

(1-29)

The optical system according to any one of (1-24) to (1-28), in which a maximum value of intensity distribution of the scattered light in the imaging region is less than a maximum value of intensity distribution of the scattered light in a region outside the imaging region.

(1-30)

The optical system according to any one of (1-24) to (1-29),

in which the plurality of sub-wavelength structures are arranged to form a plurality of lines on a surface of the optical element, and

in which in the section, pitches P between the lines change compared with a reference pitch P.

(1-31)

The optical system according to (1-30), in which a shape of the line is a straight line shape or an arc shape.

(1-32)

The optical system according to any one of (1-24) to (1-31),

in which the plurality of sub-wavelength structures form a lattice pattern, and

in which the lattice pattern includes at least one type of a hexagonal lattice pattern, a quasi-hexagonal lattice pattern, a tetragonal lattice pattern, and a quasi-tetragonal lattice pattern.

(1-33)

The optical system according to (1-30),

in which the imaging region has a rectangular shape having two groups of sides facing each other, and

in which a direction of the lines is in parallel with an extending direction of the sides of one group among the sides of the two groups.

(1-34)

The optical system according to (1-33),

in which the two groups of the sides are formed of one group of short sides facing each other and one group of long sides facing each other, and

in which the direction of the lines is in parallel with an extending direction of the long sides.

(1-35)

An imaging apparatus including an optical system that includes an optical element and an imaging device having an imaging region which receives light through the optical element,

in which the optical element includes
an element main body, and
a plurality of sub-wavelength structures that is provided on a surface of the element main body,

in which the sub-wavelength structures include an energy-ray-curable resin composition,

in which the element main body is opaque to energy rays for curing the energy-ray-curable resin composition,

in which the surface, on which the plurality of sub-wavelength structures is provided, has a section in which scattered light is generated by scattering incident light, and

in which intensity distribution of the scattered light is anisotropic.

(1-36)

An optical apparatus including an optical system that includes an optical element and an imaging device having an imaging region which receives light through the optical element,

in which the optical element includes
an element main body, and
a plurality of sub-wavelength structures that is provided on a surface of the element main body,

in which the sub-wavelength structures include an energy-ray-curable resin composition,

in which the element main body is opaque to energy rays for curing the energy-ray-curable resin composition,

in which the surface, on which the plurality of sub-wavelength structures is provided, has a section in which scattered light is generated by scattering incident light, and

in which intensity distribution of the scattered light is anisotropic.

(1-37)

A master having a rotation surface for forming a plurality of sub-wavelength structures,

in which an optical element having a surface, on which the sub-wavelength structures are provided, is obtained by irradiating the energy-ray-curable resin composition, which is coated on the surface of the element main body, with energy rays radiated from an energy ray source, which is provided inside the rotation surface, through the rotation surface while rotating the rotation surface in tight contact therewith, so as to cure the energy-ray-curable resin composition,

in which the surface of the optical element, on which the plurality of sub-wavelength structures is provided, scatters incident light and has a section in which scattered light is generated, and

in which intensity distribution of the scattered light is anisotropic.

(1-38)

A master having a rotation surface on which a plurality of sub-wavelength structures are provided,

in which the rotation surface is configured to be capable of transmitting energy rays,

in which the rotation surface, on which the plurality of sub-wavelength structures is provided, has a section in which scattered light is generated by scattering incident light, and

in which intensity distribution of the scattered light is anisotropic.

Further, the present technology may have the following configurations.

(2-1)

A transfer device including:

a rotational master that has a rotation surface having a concave-convex shape and has an energy ray source provided inside the rotation surface,

in which the rotational master is transparent to energy rays radiated from the energy ray source, and

in which a shaped layer, onto which the concave-convex shape of the rotation surface is transferred, is formed on an element main body by irradiating the energy-ray-curable resin composition, which is coated on the element main body, with energy rays radiated from the energy ray source through the rotation surface while rotating the rotation surface of the rotational master in tight contact therewith, so as to cure the energy-ray-curable resin composition.

(2-2)

A master that has a rotation surface having a concave-convex shape and is transparent to energy rays radiated from an energy ray source,

in which an energy-ray-curable resin composition is curable by irradiating the energy-ray-curable resin composition with the energy rays radiated from the energy ray source through the rotation surface.

Furthermore, the present technology may also have the following configurations.

(3-1)

An optical element including:

an element main body that has a surface; and

a plurality of sub-wavelength structures that is provided on the surface of the element main body,

in which the sub-wavelength structures are formed by curing an energy-ray-curable resin composition,

in which the element main body is opaque to energy rays for curing the energy-ray-curable resin composition,

in which the plurality of sub-wavelength structures forms a plurality of lines on the surface, and

in which center positions of the sub-wavelength structures vary in a line array direction.

Here, the optical element is an optical element having an anti-reflection function. The element main body is an optical element main body that provides an anti-reflection function using the sub-wavelength structures. Examples of the optical element main body include a lens, a filter (for example, an ND filter, or the like), a semitransparent mirror, a light modulation element, a prism, a polarization element, and the like, but are not limited thereto.

(3-2)

The optical element according to (3-1), in which the variation is irregular variation.

(3-3)

The optical element according to (3-1) or (3-2), in which assuming that a maximum value of a variation range ΔTp of a pitch between the lines is ΔTpₘₐₓ, the center positions of the sub-wavelength structures vary in the line array direction by an amount greater than ΔTpₘₐₓ.

(3-4)

The optical element according to (3-1) or (3-2), in which the lines are arranged in an S-shape.

(3-5)

The optical element according to (3-4), in which at least one of a period and an amplitude of the S-shape of the lines is irregular.

(3-6)

The optical element according to (3-1) or (3-2), in which the respective center positions of the sub-wavelength structures independently vary in the line array direction.

(3-7)

The optical element according to (3-1) or (3-2), in which the sub-wavelength structures adjacent in the line direction form blocks, and the center positions of the sub-wavelength structures vary in the line array direction in units of the blocks.

(3-8)

An optical element including:

an element main body that has a surface; and

a plurality of sub-wavelength structures that is provided on the surface of the element main body,

in which the sub-wavelength structures are formed by curing an energy-ray-curable resin composition,

in which the element main body is opaque to energy rays for curing the energy-ray-curable resin composition,

in which the plurality of sub-wavelength structures forms a plurality of lines on the surface, and

in which an arrangement pitch P between the sub-wavelength structures in the same line varies relative to an average arrangement pitch Pm.

(3-9)

The optical element according to (3-8), in which the variation is irregular variation.

(3-10)

The optical element according to (3-8) or (3-9), in which assuming that a maximum value of a variation range of a pitch between the lines is ΔTpₘₐₓ, the variation range Δp of the arrangement pitch P relative to the average arrangement pitch Pm varies to be greater than ΔTpₘₐₓ.

(3-11)

The optical element according to (3-8) or (3-9), in which the respective arrangement pitches P between the sub-wavelength structures independently vary in a line direction.

(3-12)

The optical element according to (3-8) or (3-9), in which the sub-wavelength structures adjacent in a line direction form blocks, and the arrangement pitch P between the sub-wavelength structures vary in the line direction in units of the blocks.

(3-13)

An optical system including one or more optical elements that have surfaces on which a plurality of sub-wavelength structures is formed,

in which the optical element includes:
an element main body that has a surface; and
a plurality of sub-wavelength structures that is provided on the surface of the element main body,

in which the sub-wavelength structures are formed by curing an energy-ray-curable resin composition,

in which the element main body is opaque to energy rays for curing the energy-ray-curable resin composition,

in which the plurality of sub-wavelength structures forms a plurality of lines on the surface, and

in which center positions of the sub-wavelength structures vary in a line array direction.

(3-14)

The optical system according to (3-13), in which the variation is irregular variation.

(3-15)

The optical system according to (3-13) or (3-14), in which assuming that a maximum value of a variation range ΔTp of a pitch between the lines is ΔTpₘₐₓ, the center positions of the sub-wavelength structures vary in the line array direction by an amount greater than ΔTpₘₐₓ.

(3-16)

The optical system according to (3-13) or (3-14), in which the lines are arranged in an S-shape.

(3-17)

The optical system according to (3-16), in which at least one of a period and an amplitude of the S-shape of the lines is irregular.

(3-18)

The optical system according to (3-13) or (3-14), in which the respective center positions of the sub-wavelength structures independently vary in the line array direction.

(3-19)

The optical system according to (3-13) or (3-14), in which the sub-wavelength structures adjacent in a line direction form blocks, and the center positions of the sub-wavelength structures vary in the line array direction in units of the blocks.

(3-20)

The optical system according to any one of (3-13) to (3-19), further including an imaging device that receives light through the optical element.

(3-21)

An optical system including one or more optical elements that have surfaces on which a plurality of sub-wavelength structures is formed,

in which the optical element includes:
an element main body that has a surface; and
the plurality of sub-wavelength structures that is provided on the surface of the element main body,

in which the sub-wavelength structures are formed by curing an energy-ray-curable resin composition,

in which the element main body is opaque to energy rays for curing the energy-ray-curable resin composition, and

in which an arrangement pitch P between the sub-wavelength structures in the same line varies relative to an average arrangement pitch Pm.

(3-22)

The optical element according to (3-21), in which the variation is irregular variation.

(3-23)

The optical system according to (3-21) or (3-22), in which assuming that a maximum value of a variation range of a pitch between the lines is ΔTpₘₐₓ, the variation range Δp of the arrangement pitch P relative to the average arrangement pitch Pm varies to be greater than ΔTpₘₐₓ.

(3-24)

The optical system according to (3-21) or (3-22), in which the respective arrangement pitches P between the sub-wavelength structures independently vary in a line direction.

(3-25)

The optical system according to (3-21) or (3-22), in which the sub-wavelength structures adjacent in a line direction form blocks, and the arrangement pitch P between the sub-wavelength structures vary in the line direction in units of the blocks.

(3-26)

The optical system according to any one of (3-21) to (3-25), further including an imaging device that receives light through the optical element.

(3-27)

An imaging apparatus including the optical system according to any one of (3-13) to (3-26).

(3-28)

An optical instrument including the optical system according to any one of (3-13) to (3-26).

(3-29)

A master having a surface on which a plurality of sub-wavelength structures is formed,

in which the plurality of sub-wavelength structures is formed in a plurality of lines on the surface, and

in which the center positions of the sub-wavelength structures vary in a line array direction.

(3-30)

The master according to (3-29), in which the variation is irregular variation.

(3-31)

The master according to (3-29) or (3-30), in which assuming that a maximum value of a variation range ΔTp of a pitch between the lines is ΔTpₘₐₓ, the center positions of the sub-wavelength structures vary in the line array direction by an amount greater than ΔTpₘₐₓ.

(3-32)

The master according to (3-29) or (3-30), in which the lines are arranged in an S-shape.

(3-33)

The master according to (3-32), in which at least one of a period and an amplitude of the S-shape of the lines is irregular.

(3-34)

The master according to (3-29) or (3-30), in which the respective center positions of the sub-wavelength structures independently vary in the line array direction.

(3-35)

The master according to (3-29) or (3-30), in which the sub-wavelength structures adjacent in a line direction form blocks, and the center positions of the sub-wavelength structures vary in the line array direction in units of the blocks.

(3-36)

A master having a surface on which a plurality of sub-wavelength structures is formed,

in which the plurality of sub-wavelength structures is formed in a plurality of lines on the surface, and

in which an arrangement pitch P between the sub-wavelength structures in the same line varies relative to an average arrangement pitch Pm.

(3-37)

The master according to (3-36), in which the variation is irregular variation.

(3-38)

The master according to (3-36) or (3-37), in which assuming that a maximum value of a variation range of a pitch between the lines is ΔTpₘₐₓ, the variation range Δp of the arrangement pitch P relative to the average arrangement pitch Pm varies to be greater than ΔTpₘₐₓ.

(3-39)

The master according to (3-36) or (3-37), in which the respective arrangement pitches P between the sub-wavelength structures independently vary in a line direction.

(3-40)

The master according to (3-36) or (3-37), in which the sub-wavelength structures adjacent in a line direction form blocks, and the arrangement pitch P between the sub-wavelength structures vary in the line direction in units of the blocks.

### REFERENCE SIGNS LIST

1 SUBSTRATE
2 STRUCTURE
11a OPAQUE LAYER
11b TRANSPARENT LAYER
21 STRUCTURE
22 BOTTOM LAYER
101 ROLL MASTER
102 STRUCTURE
110 ENERGY RAY SOURCE
118 ENERGY-RAY-CURABLE RESIN COMPOSITION
133 EMBOSSED BELT
136 PLANAR BELT
201 ANTI-REFLECTION OPTICAL ELEMENT
202 SEMITRANSPARENT MIRROR
203, 212 STRUCTURE
204 BOTTOM LAYER
211 ROLL MASTER
213 RESIST LAYER
214 LASER LIGHT
216 LATENT IMAGE
300 IMAGING APPARATUS
301 CASING
302 IMAGING OPTICAL SYSTEM
311 LENS
312 IMAGING DEVICE
Sp SHAPING SURFACE
Si REAR SURFACE
A₁ IMAGING REGION

1. An optical element comprising:
an element main body; and
a plurality of sub-wavelength structures that is provided on a surface of the element main body,
wherein the sub-wavelength structures include an energy-ray-curable resin composition,
wherein the element main body is opaque to energy rays for curing the energy-ray-curable resin composition,
wherein the surface, on which the plurality of sub-wavelength structures is provided, has a section in which scattered light is generated by scattering incident light, and
wherein intensity distribution of the scattered light is anisotropic.

2. The optical element according to claim 1, further comprising a shaped layer that is provided on the surface of the element main body and has a surface having a concave-convex shape,
wherein the concave-convex shape includes the plurality of sub-wavelength structures, and
wherein unit regions having predetermined sub-wavelength structure patterns are consecutively arranged on the surface of the shaped layer without causing inconsistency in the concave-convex shape.

3. The optical element according to claim 2,
wherein the element main body has a band shape, and
wherein the unit regions are consecutively arranged in a length direction of the element main body.

4. The optical element according to claim 2, wherein the inconsistency in the concave-convex shape is disarray in periodicity of the predetermined sub-wavelength structure patterns.

5. The optical element according to claim 2, wherein the inconsistency in the concave-convex shape is an overlap, a gap, or a non-transferred portion between the unit regions adjacent to each other.

6. The optical element according to claim 2,
wherein the unit regions are connected without causing inconsistency at the time of curing the energy-ray-curable resin composition, and
wherein the inconsistency at the time of curing the energy-ray-curable resin composition is a difference in a degree of polymerization.

7. The optical element according to claim 1, wherein the sub-wavelength structures are formed by advancing a curing reaction of the energy-ray-curable resin composition, with which the surface of the element main body is coated, from a side opposite to the element main body.

8. The optical element according to claim 1,
wherein the sub-wavelength structures are arranged to form a plurality of tracks on the surface, and
wherein a pitch Tp between the tracks varies in accordance with a gap between the tracks.

9. The optical element according to claim 1,
wherein the sub-wavelength structures form a lattice pattern,
wherein the sub-wavelength structures are arranged to form a plurality of tracks on the surface,
wherein the lattice pattern includes at least one type of a hexagonal lattice pattern, a quasi-hexagonal lattice pattern, a tetragonal lattice pattern, and a quasi-tetragonal lattice pattern,
wherein the surface scatters a part of the incident light, and
wherein an intensity of the scattered light is less than 1/500 of an intensity of the incident light.

10. A manufacturing method of an optical element comprising:
coating a surface of an element main body with an energy-ray-curable resin composition; and
forming a plurality of sub-wavelength structures on the surface of the element main body by irradiating the energy-ray-curable resin composition, which is coated on the surface of the element main body, with energy rays radiated from an energy ray source, which is provided in a rotational master, through a rotation surface of the rotational master while rotating the rotation surface of the rotational master in tight contact therewith, so as to cure the energy-ray-curable resin composition,
wherein the surface, on which the plurality of sub-wavelength structures is provided, has a section in which scattered light is generated by scattering incident light, and
wherein intensity distribution of the scattered light is anisotropic.

11. An optical system comprising:
an optical element; and
an imaging device that has an imaging region which receives light through the optical element,
wherein the optical element includes
an element main body, and
a plurality of sub-wavelength structures that is provided on a surface of the element main body,
wherein the sub-wavelength structures include an energy-ray-curable resin composition,
wherein the element main body is opaque to energy rays for curing the energy-ray-curable resin composition,
wherein the surface, on which the plurality of sub-wavelength structures is provided, has a section in which scattered light is generated by scattering incident light, and
wherein intensity distribution of the scattered light is anisotropic.

12. The optical system according to claim 11, wherein a sum of components of the scattered light reaching the imaging region is less than a sum of components reaching the outside of the imaging region.

13. The optical system according to claim 11, wherein the intensity distribution of the scattered light is different in accordance with a numerical aperture NA.

14. The optical system according to claim 13, wherein an intensity per unit solid angle in the intensity distribution of the scattered light at a numerical aperture NA≦0.8 is less than that at a numerical aperture NA>0.8.

15. The optical system according to claim 11, wherein a maximum value of intensity distribution of the scattered light in the imaging region is less than a maximum value of intensity distribution of the scattered light in a region outside the imaging region.

16. The optical system according to claim 11,
wherein the plurality of sub-wavelength structures are arranged to form a plurality of lines on a surface of the optical element, and
wherein in the section, a pitch P between the lines changes compared with a reference pitch P.

17. The optical system according to claim 16,
wherein the imaging region has a rectangular shape having two groups of sides facing each other, and
wherein a direction of the lines is in parallel with an extending direction of the sides of one group among the sides of the two groups.

18. The optical system according to claim 17,
wherein the two groups of the sides are formed of one group of short sides facing each other and one group of long sides facing each other, and
wherein the direction of the lines is in parallel with an extending direction of the long sides.

19. An imaging apparatus comprising an optical system that includes an optical element and an imaging device having an imaging region which receives light through the optical element,
wherein the optical element includes
an element main body, and
a plurality of sub-wavelength structures that is provided on a surface of the element main body,
wherein the sub-wavelength structures include an energy-ray-curable resin composition,
wherein the element main body is opaque to energy rays for curing the energy-ray-curable resin composition,
wherein the surface, on which the plurality of sub-wavelength structures is provided, has a section in which scattered light is generated by scattering incident light, and
wherein intensity distribution of the scattered light is anisotropic.

20. An optical apparatus comprising an optical system that includes an optical element and an imaging device having an imaging region which receives light through the optical element,
wherein the optical element includes
an element main body, and
a plurality of sub-wavelength structures that is provided on a surface of the element main body,
wherein the sub-wavelength structures include an energy-ray-curable resin composition,
wherein the element main body is opaque to energy rays for curing the energy-ray-curable resin composition,
wherein the surface, on which the plurality of sub-wavelength structures is provided, has a section in which scattered light is generated by scattering incident light, and
wherein intensity distribution of the scattered light is anisotropic.

21. A master having a rotation surface on which a plurality of sub-wavelength structures are provided,
wherein the rotation surface is configured to be capable of transmitting energy rays,
wherein the rotation surface, on which the plurality of sub-wavelength structures is provided, has a section in which scattered light is generated by scattering incident light, and
wherein intensity distribution of the scattered light is anisotropic.
